(19) United States
(12) Patent Application Publication
(10) Pub. No.: US 2002/0100836 A1
(43) Pub. Date: Aug. 1, 2002

(54) Hydrogen and oxygen battery, or hudrogen and oxygen to fire a combustion engine and/or for commerce.

(76) Inventor: Robert Daniel Hunt, Pass Christian, MS (US)

Correspondence Address: ROBERT DANIEL HUNT, 23707 REDFISH LANE, PASS CHRISTIAN, MS, 39571, US

(21) Appl. No.: 09/774,110

(22) Filed: Jan. 31, 2001

(51) Int. Cl. B64C 25/50

(52) U.S. Cl. 244/50

(57) ABSTRACT

The present invention is directed to a method of and an apparatus for the disassociation of water into hydrogen and oxygen via a thermolysis, heat/ignition process. The hydrogen and oxygen produced may be burned as fuel in a hydrogen thermolysis reactor to provide propellant for a turbine or to provide heat to generate steam for a steam engine or may be combusted in a combustion engine. The present invention can produce heat for space heat for buildings and for manufacturing, etc. or can produce mechanical drive that can generate electricity, power hydraulic systems, or provide thrust to propel airplanes, spaceships, rockets or submarines (which have their own oxygen supply for combustion in outer space or underwater from the oxygen contained in the water converted into hydrogen and oxygen) and can provide the energy needed to power automobiles, trucks, buses, trains, boats, etc. A heat/ignition process is utilized to accomplish complete thermolysis and burning of water: A thermolysis coil located at the core of the hydrogen thermolysis reactor preheats the water under pressure until it reaches a temperature of approximately 2500 deg. F., without intense pressure the water would become gaseous; and, the water is heated by a resistance electrical current or by masers and/or by lasers before it is ejected from the coil and becomes heated to approximately 5000 deg. F. Most of the water will dissociate into hydrogen and oxygen within the liquid state due to extreme temperature and pressure, according to the Second Law of Thermodynamics; and, in the final step the water is ejected from the high-pressure, high-temperature thermolysis coil into a vacuum zone of negative-pressure and high-temperature created by a hydraulically operated vacuum turbine within the thermolysis nozzle and is transformed into fuel plasma containing atomic hydrogen and atomic oxygen. The plasma passes through an electric arc capable of temperatures up to 90,000 deg. F. or passes through laser beams capable of temperatures of up to one million deg. F. within the vacuum inside the thermolysis nozzle and the hydrogen and oxygen is further heated and is ignited by the electric arc or laser beams. The burning hydrogen and oxygen is diffused into the hydrogen thermolysis reactor's core by the vacuum turbine. A self-sustained cycle is created because the hydrogen and oxygen (disassociated water) that burns provides the heat/energy to perform work, including the generation of electricity for the resistance electrical current or masers and/or lasers and electric arc or lasers, and to heat additional water in the thermolysis coil and enormous quantities of excess energy for any other useful purpose.

### CROSS REFERENCE TO RELATED APPLICATIONS

U.S. Pat. No. 5,899,072 (GODE), May 4, 1999, “Steam generator and steam turbine driving unit using gaseous hydrogen as fuel”; and, U.S. Pat. No. 4,573,435 (SHELTON), Mar. 4, 1986, “Apparatus and method for generating hydrogen gas for use as a fuel additive in diesel engines”; and, U.S. Pat. No. 4,030,453 (SUGIMOTO), Method of water admixing to fuel oil for an internal combustion engine and apparatus therefor”; and, U.S. Pat. No. 6,152,995 (EDLUND), “Hydrogen-permeable metal membrane and method for producing the same”; and, U.S. Pat. No. 4,380,970 (DAVIS), “Combustion engines”; and, U.S. Pat. No. 6,103,411 (MATSUBAYASHI), “Hydrogen production apparatus and method operable without supply of steam and suitable for fuel cell systems” Other Information Sources: Scientific Papers, Magazine Articles, Encyclopedias, and University Text: “A Realizable Renewable Energy Future”, Dr. John Turner, Senior Scientist, U.S. Department of Energy's National Renewable Energy Laboratory. Science Magazine, Jul. 30, 1999); and (McGraw Hill Science and Technology Encyclopedia); and, (PYLE, et. al.) 1994 “Direct-Thermal Solar Hydrogen Production from Water Using Nozzles/Skimmers and Glow Discharge in the Gas Phase at Low Pressure and High Temperature”, H-lon Solar Company, NREL Task No. HY413801; and, (Dr. Abraham Kogan, Weizmann Institute) November 1996, “Weizmann Institute Scientists Zero in on Direct High-Temperature Solar Water Splitting”, Hydrogen and Fuel Cell Letter; and, Test Lecture, Norwegian University of Science and Technology, Faculty of Mechanical Engineering, Department of Thermal Energy and Hydropower (Faculty Professor), “An overview of hydrogen production technologies for energy use”

### COPYRIGHT STATEMENT

The author of this patent application is Robert Daniel Hunt, 23707 Redfish Lane, Pass Christian, Mississippi , Telephone: (228) 452-7917, e-mail: Huntband@aol.com

### BACKGROUND OF THE INVENTION

The production of energy to supply the world's growing consumption is the field of the invention. Energy needed to produce electricity, to manufacture goods, to propel airplanes, rockets, automobiles, trucks, buses, trains, boats, submarines, golf carts, jet skis, etc.

The world's supplies of fossil fuels are rapidly being depleted as population and the resulting demand for energy increases and as pollution mounts, including the specter of global warming caused by the burning of fossil fuels. Predictions are that supplies of fossil fuels will expire during the mid of this century. During the year 2000, California faced the greatest energy crisis in the history of the state. People of the world are spending a far greater portion of their income on energy than ever before. In this new millennia the world absolutely must find new energy sources that are inexpensive, renewable and do not harm the environment.

Estimates of electrical power plant repowering during the next ten years are from 15% to 65% of the installed capacity in the U.S. and new generating capacity of approximately 130 gigawatts will be needed. Worldwide 550 gigawatts will be installed by 2010. Source U.S. Department of Energy.

Hydrogen (Greek for “water former”), the most abundant element in the Universe, symbol H, atomic number 1, atomic weight 1.00797, configuration of one proton and one electron, reactive, colorless, odorless, and tasteless gaseous element is such an energy source. Hydrogen is diatomic (its molecules contain two atoms), but at high temperatures it dissociates into free atoms. Hydrogen has a lower boiling point and melting point than any other substance except helium. Hydrogen melts at −259.2 deg. C. and boils at −252.77 deg. C. At 0 deg. C. and 1 atmosphere pressure, hydrogen is a gas with a density of 0.089 g/liter. Free hydrogen is found in only very small traces in the atmosphere, but it is abundant in the sun and stars.

Hydrogen has been proposed as an ideal fuel almost ever since its discovery by Henry Cavendish in 1776. The British chemist Joseph Priestly dubbed the gas “flammable air”. Water, covering two-thirds of the Earth's surface and being made-up of a combination of hydrogen and oxygen is a readily available source of hydrogen. However, the direct division of water molecules into separate oxygen and hydrogen atoms has eluded physicist and chemists for over two hundred years. Disassociation of water into hydrogen and oxygen has been called the “Holy Grail” of science. All major scientists of the Twentieth Century, including Einstein, have believed that hydrogen was the answer to the world's energy needs because of hydrogen's ability to provide clean burning, superior quality heat. Hydrogen burns hotter and cleaner than natural gas and only produces heat and water vapor when it is combusted. Hydrogen is the cleanest burning fuel known to man. Hydrogen even has the capability to produce the tremendous amounts of energy required to power rockets into outer space.

U.S. Pat. No. 5,899,072 (GODE) cites, “Hydrogen is available in unlimited quantities, and returns to its former state after firing. Hydrogen is the cleanest fuel, can be produced and used without losses, in a cycle, without emitting any substances that could be harmful to the environment. Hydrogen as a fuel has very good characteristics: its combustion temperature and heating value are high, it is able to burn at a low concentration, without producing any smoke. These features allow it to be burned in an internal space (oxidation), as the thermal energy can be used with a high efficiency. The burning of hydrogen in a combustion chamber is advantageous compared with natural gas. In its combustion product (containing exclusively water vapor, having a higher radiation than that of carbon dioxide), the hydrogen gas has a higher quantity of triatomic gases, therefore its radiation ability is higher than that of natural gas. The radiation of a hydrogen flame is higher than that of natural gas and its outer parts are hotter, therefore its radiation is good.”

“With respect to heat transfer characteristics, the adiabatic temperature (2100 deg. C.) of hydrogen is higher than that of natural gas (1950 deg. C.). The combustion of hydrogen requires less air (0.80 m.sup.3/n/k Wh) than natural gas (0.96 m.sup.3/n/k Wh). For a given power and torque, the heat transfer of hydrogen gas is 10% better than that of natural gas. The hydrogen/air mixture is ignited at a mixture of 4 as well as 75% and has a high inflammation speed. The flame supplied by hydrogen during tests is extremely stable, being calm without artificial stabilization, at any pressure level.”

“All of this shows that the burning of hydrogen does not represent any difficulty either in an open or a closed combustion space. Its good radiation, heat transfer and stability facilitate energy transformation with high efficiency. Its efficiency can be considerably higher than that of hydrogen burned in a combustion engine (gas fired turbine), because the high temperature and energy of the chemical reaction accompanying the explosion can only be used with a considerable loss, due to friction.” U.S. Pat. No. 5,899,072 (GODE), May 4, 1999, “Steam generator and steam turbine driving unit using gaseous hydrogen as fuel.”

Excerpts from a test lecture, “Why Hydrogen? The answer can be found by looking at the combustion reaction. Using O2 the only product is H2O (as in fuel cells). Hence, hydrogen as an energy source will have a positive influence on the greenhouse gas effect, acid rain and local and regional pollution problems. Why not? Production costs is the main obstacle. The price of hydrogen per energy unit is very high compared with today's energy carriers. Safety, transport and storage and development of enduse technologies are all areas that need further research. An overview of the primary energy use in the sectors of electricity generation, heat production and transportation is shown in this figure. The total emission of CO2 from commercial energy carriers is highest in the heat sector (49%), electricity production contributes with 30% and transportation with another 21%. A large amount of hydrogen is produced annually, mainly for production of ammonia and for processing of refinery products. However, 97% of the hydrogen is produced from fossil primary energy. The only hydrogen production process free of CO2 emissions is water electrolysis, if the electricity is produced from nuclear or renewable fuels.”

“In this figure, properties of hydrogen, methane and propane are shown, Compared with methane (natural gas) hydrogen: has much lower density, which is to some extent compensated by a higher heating value; has very low ignition energy in air; has very wide ignition limits in air (4% to 94% in O2); has very wide detonation limits in air; has a higher diffusion coefficient in air. Hence, using hydrogen as a fuel demands special safety precautions!”

“Water Thermolysis is direct thermal cleavage of water at temperatures above 2000 K. Equilibrium composition depends on pressure and temperature. Products: H2O, OH, H, O, H2, O2. Problems: Materials, separation of H2, conservation of high temperature energy. Test Lecture, Norwegian University of Science and Technology, (Faculty Professor), An overview of hydrogen production technologies for energy use”

The oil embargo of 1974 set-off an energy crisis that sparked a great deal of research during the late 1970's and 1980's into technologies to inexpensively produce hydrogen from water on a large scale, but generally were unsuccessful as only small percentages of the water has been converted to hydrogen and oxygen and the technologies employed have proven to be expensive to operate.

Recent advances in hydrogen fuel cell technology has increased awareness of how great the future demand for hydrogen is likely to be and has fueled great renewed interest in the dissociation of water into hydrogen and oxygen. Many major automobile manufactures are gearing up to release versions of hydrogen fuel cell cars, trucks and buses and public utility companies are funding research of hydrogen fuel cells for commercial electricity production. However, the process of deriving hydrogen from hydrocarbons as used by many of the leading fuel cell companies still results in the emissions of toxic substances into the air. However, Millennium Cell has patented a proprietary process called Hydrogen On Demand (Trademark) which uses sodium borohydride, a derivative of borax found in substantial natural reserves globally, and water to form hydrogen without harmful emissions when combusted.

Virtually all (97%) of the hydrogen commercially produced is by steam reforming or thermal cracking of natural gas, which requires the consumption of hydrocarbon fossil fuels. Partial oxidation of heavy hydrocarbons can produce hydrogen, but the gas will contain more CO than from steam reforming of natural gas. Coal gasification and coke oven gas are mainly used to produce syngas and hydrogen for use in industrial processes such as ammonia synthesis. Obviously, all of these hydrocarbon technologies have the drawback of further depleting the fossil fuel reserves and often carbon resides are found in hydrogen produced from hydrocarbons, causing harmful emissions when burned. The process will become progressively more expensive as fuel reserves expire which is anticipated to dramatically increase the cost of fossil fuels. Therefore, this source of low-cost hydrogen production cannot be depended on in the future.

Solar powered photovoltaic devices are presently considered by most scientists as the most promising way to produce hydrogen by separating water into hydrogen and oxygen via an electrical current (electrolysis). However, efficiencies have been as low as 4% and solar arrays are extremely expensive. New research in this area has created higher efficiencies by creating direct photo electrolysis devices, which are comprised of multijunction, multi-layer semiconductor materials directly in water or directly connected to an electrode and anode in the water. The most recent technology demonstrates a substantial improvement over older photolysis technology, but suffers from being extremely expensive with efficiencies in the range of 18% and possibly being able to achieve near 30% in the future using concentrator solar cell technology with sun tracking mechanisms, but this still remains a complex and expensive approach to hydrogen production that only works when the sun provides solar radiation energy, which is less than 50% of the time.

The plasma arc process of heating water by an electric field to 5000 deg. C. produces up to 50% hydrogen but is energy inefficient in that very rapid cooling to obtain the produced hydrogen is required.

Thermo chemical cycles based on chemical cleavage of water at temperatures lower than needed for thermolysis of near 1200 K requires a number of cycles with decreasing efficiencies with each cycle. Total real efficiencies are near 40% to 50%. The chemicals used cannot be recycled and produce toxic substances and special materials are needed to handle the corrosive chemicals needed in the process.

Bio-mass hydrogen production from garbage, waste organic materials or agriculture feedstock uses technology similar to the well-studied steps of methanol and hydrogen production from fossil fuels and require very large volumes of materials. Thus far this method remains more expensive than hydrogen production from fossil fuels.

Photobiological hydrogen production is achieved by two biochemical processes carried out by the activity of chlorophyll found in a variety of algae. This could be of importance in the future.

Hydrogen production from complex chemical reactions such as hydrogen production from bromide has not proven to be efficient or cost effective and requires large quantities of chemicals. Nor has hydrogen production from the steam/iron process, one of the oldest ways of producing hydrogen by the interaction of steam with iron oxide. Many other methods to produce hydrogen have been attempted which have proven to be too costly and achieve very poor results in terms of efficiencies.

All of these methods as used in the prior art are faced with the difficult tasks of overcoming such complex issues as: storage, transportation, redesign of equipment to use hydrogen as a fuel, and infrastructure. Hydrogen once produced must be stored and suitable methods to transport the hydrogen must be developed, and a complex network of hydrogen filling stations much be implemented before the hydrogen developed can achieve the objective of replacing fossil fuels for cars, trucks, buses, etc. Additionally, hydrogen when combined with water vapor is extremely corrosive at combustion temperatures. Some of these issues are not as negative for purposes of power generation in a large fixed facility that could potentially generate and store hydrogen onsite.

It is known that water can be heated until the thermal energy ultimately breaks the co-valent bonds of the water molecules into separate hydrogen atoms and oxygen atoms. A small amount of hydrogen will be produced beginning at 700 degrees F. and 4% or more will be produced by temperatures of 800 deg. to 900 deg. F., as referenced in U.S. Pat. No. 4,573,435 (SHELTON), which leads to the assumption that greater heat will produce greater quantities of Hydrogen.

Further it is calculated that water will dissociate into hydrogen and oxygen within a liquid under conditions of extreme heat and pressure. According to the Second Rule of Thermodynamics, pressure affects the outermost electronic shells and the delocalization of electrons—so that they are not as firmly fixed to particular atoms. At 600,000 atmospheres atoms break down and lose their electrons. (McGraw Hill Science and Technology Encyclopedia)

At high temperatures, above about 1800 K water vapor (steam) begins to dissociate into a mixture of H2, O2, H2O, O, H, and OH. “The extent of dissociation increases with increasing temperature and decreasing pressure”. The water and the diatomic hydrogen and oxygen species completely dissociate into H (atomic hydrogen) and O (atomic oxygen) above about 3500 K under equilibrium conditions at 1 mm Hg pressure. (PYLE, et. al.) 1994 “Direct-Thermal Solar Hydrogen Production from Water Using Nozzles/Skimmers and Glow Discharge in the Gas Phase at Low Pressure and High Temperature”, H-lon Solar Company, NREL Task No. HY413801.

Previous methods of thermolysis, the production of hydrogen and oxygen by directly splitting water at high temperatures, has resulted in efficiencies as low as 3% of the reaction water being converted into hydrogen and oxygen atoms. The main effort of the prior art was focused on hydrogen enrichment of fossil fuels to make them more efficient and to produce less pollution. U.S. Pat. No. 4,573,435 (SHELTON) specifically considered hydrogen in excess of 4% as being harmful in its process because of pre-mature ignition in the diesel combustion engine. Likewise U.S. Pat. No. 4,030,453 (SUGIMOTO) observed disadvantages wear or abrasion in the interior of the combustion chamber of an engine attributable to an extra-high energy of combustion as needed and occurs in the combustion chamber to get cold water content fully decomposed during combustion. This prior art patent further cautions against the use of pure hydrogen in a combustion engine due to risk of an explosion and, therefore, did not attempt to produce large quantities of hydrogen in its processes. The prior art exclusively concentrated on hydrogen production as a fuel enrichment primarily for combustion engines by directing the exhaust heat of the engine to a heat exchanger and jetting water onto the heat exchanger or by circulating the water around the manifold of the engine exhaust. The small quantity of hydrogen produced was then mixed, along with steam, with the fuel to improve engine performance. In conclusion the technology of the prior art yields too small of percentage of hydrogen to be commercially viable and is therefore ineffective at meeting the need for the of large quantities of hydrogen.

Dr. Kogan of the Weizmann Institute expects high enough yields to make direct solar water splitting economically feasible, splitting up to 30% of steam in a solar reactor at 2,300 deg. C. is achievable, and perhaps even 55% at 2,500 DEGREE C. (Dr. Abraham Kogan, Weizmann Institute) November 1996, “Weizmann Institute Scientists Zero in on Direct High-Temperature Solar Water Splitting”, Hydrogen and Fuel Cell Letter.

Thermolysis presently is not considered a viable approach to producing hydrogen and oxygen due to the “rapid back reaction of hydrogen and oxygen” (“A Realizable Renewable Energy Future”, Dr. John Turner, Senior Scientist, U.S. Department of Energy's National Renewable Energy Laboratory. Science Magazine, Jul. 30, 1999). The re-combining of hydrogen and oxygen atoms into steam before the hydrogen and oxygen can be separated and stored as practiced in the prior art has caused most scientists to consider thermolysis as a potentially un-achievable goal.

Of crucial importance is the separation of the two hot gases. In the past, “much work has been devoted to the method of rapid quenching of the hot gas effluents from the reactor,” Kogan explained, to keep them from re-reacting with each other, making steam again. “In my view, this makes no economic sense (because) rapid quenching is a highly irreversible process,” Kogan added. To split out the 10% of water that undergoes thermal dissociation, the total amount of water has to be raised to these extreme temperatures, only to be cooled down again rapidly to about one quarter of that temperature, “a most wasteful process,” he believes. Instead, Kogan concluded early on, “The only chance to develop hydrogen production by solar thermal water splitting into a thermodynamically efficient process is by separating hydrogen from the mixture of water-splitting product in place while the gas mixture is still hot, and by recovering heat from the effluent gas as well as we can. Taking a cue from nuclear fuel processing technology, Kogan decided on a gas diffusion process through a porous ceramic membrane where the difference in molecular weights of hydrogen and oxygen and the different speeds with which they diffuse through such a membrane makes gas diffusion “very effective in our case.” (Dr. Abraham Kogan, Weizmann Institute) November 1996, “Weizmann Institute Scientists Zero in on Direct High-Temperature Solar Water Splitting”, Hydrogen and Fuel Cell Letter.

However, upon close review of prior art patents and scientific papers relating to hydrogen production, there exists substantial evidence for the large-scale production of hydrogen and oxygen via thermolysis. In U.S. Pat. No. 4,573,435 (SHELTON) it is noted that a small amount of hydrogen will be produced beginning at 700 deg. F. and 4% or more will be produced by temperatures of 800 deg. F. to 900 deg. F.

Splitting up to 30% of steam in a solar reactor at 2300 deg. C. is achievable and perhaps even 55% at 2500 deg. C. is believe by Dr. Kogan. (Dr. Abraham Kogan, Weizmann Institute) November 1996, “Weizmann Institute Scientists Zero in on Direct High-Temperature Solar Water Splitting”, Hydrogen and Fuel Cell Letter.

U.S. Pat. No. 4,030,453 (SUGIMOTO) cites that in the combustion of dissociated water in association with pure hydrogen that it is practicably possible that all of the dissociated water may be fully combusted under optimally controlled combustion conditions.

The extent of dissociation increases with increasing temperature and decreasing pressure. The water and the diatomic hydrogen and oxygen species completely dissociate into H (atomic hydrogen) and O (atomic oxygen) above about 3500 K (5840 deg. F.) under equilibrium conditions at 1 mm Hg absolute pressure. (PYLE, et. al.) 1994.

The Problem:

In prior art technology there is no efficient and cost effective manner in which to produce large volumes of hydrogen in a process that does not deplete vital fossil fuel stocks. Further, systems have not been fully developed to store, transport and dispense hydrogen on a large scale. An entirely new energy infrastructure needs to be created based on hydrogen power that is non-polluting and inexpensive to operate. energy sufficient to power the world for the rest of this new millennia. Designing and implementing a new hydrogen infrastructure is the technological challenge of today.

### SUMMARY OF INVENTION

The invention herein contemplated of the hydrogen thermolysis reactor (1) accomplishes the direct splitting of water molecules into atoms of hydrogen and oxygen in a heat/ignition process that is self-sustained and is accomplished onboard the unit itself, eliminating the need for storage, transport and dispensing of hydrogen. The hydrogen and oxygen are burned in the hydrogen thermolysis reactor (1) that produces power sufficient to operate a hydrogen gas-fired turbine (2) or steam turbine (3) capable of producing mechanical drive for the production of electricity, to drive a steam engine, or to provide power to drive hydraulic systems. The apparatus can also produce sufficient thrust to propel jet airplanes, rockets, or a spaceship and can provide the energy needed to power automobiles, trucks, buses, trains, boats, submarines, etc. The apparatus also produces oxygen and hydrogen which can power a hydrogen fuel cell (5), be burned in a combustion engine (4), used in chemical and manufacturing processes, etc. or be sold for profit. The present invention can power rockets engines (7) in outer space, which cannot be powered by convention gas fired turbines (2) that must obtain oxygen from Earth's atmosphere. The apparatus has its own supply of oxygen, which is contained in the water that is turned into hydrogen and oxygen fuel plasma. Likewise, the hydrogen thermolysis reactor can power a submarine (52) underwater with its own oxygen supply.

Thermolysis is the disassociation of water into hydrogen and oxygen by hightemperature and low-pressure. To begin the process the water must be held under high-pressure so that it may gain thermal energy (heat up) until it is disassociated, otherwise, it would dissipate as steam. Temperatures of above 5,800 deg. F. are required for complete thermolysis of water into atomic hydrogen and oxygen. In order to heat water to such extreme temperature, substantial pressure is necessary. The extreme temperature and pressure requires specialized materials and methods, including mechanisms to cool the critical components to prevent heat damage to the apparatus and/or its metallurgy. After the water is hot enough to thermally crack into hydrogen and oxygen, it still will not do so until the pressure becomes very low, below that of atmospheric pressure of one atmosphere which is 14.7 p.s.i. Therefore, the water held under extreme pressure and allowed to super-heat must make a radical pressure change from extremely high-pressure in the thousands of p.s.i. to near zero for best results. This is what the operating principal of the present invention, which accomplishes, super heating of water under extreme pressure and then sudden diffusion into a vacuum in which the hydrogen and oxygen is further heated and ignited, achieving complete thermolysis of the water into hydrogen and oxygen. The burning hydrogen and oxygen provides heat which is converted into mechanical drive.

Within the present invention two different components accomplish thermolysis of water into hydrogen and oxygen. The hydrogen thermolysis diffuser nozzle (15) accomplishes thermolysis and then immediately ignites the hydrogen and oxygen to provide instant heat energy. The hydrogen and oxygen production nozzle (18) accomplishes thermolysis and along with the hydrogen and oxygen production cylinder (20) separates the hydrogen and oxygen, without igniting the hydrogen and oxygen, for the production of hydrogen and oxygen so that it may be used later or used by a fuel cell (5) or a hydrogen and oxygen storage battery (58) to produce electricity.

The invention incorporates different embodiments of the hydrogen thermolysis diffuser nozzle (15) and hydrogen and oxygen production nozzle (18) that may be used for different purposes. These embodiments pertain primarily to the methods in which the water is heated and heated/ignited and in which it is diffused into the zone of low pressure. Different embodiments of the methods of creating low-pressure are also shown in the invention. The patent is intended to cover all embodiments that accomplish thermolysis by heating water until it is disassociated and diffusing the water into a zone of low-pressure no matter how the embodiment to accomplish the method of the invention is carried out.

The invention of the hydrogen thermolysis reactor (1) adds an additional aspect to the method of thermolysis as invented by the hydrogen thermolysis diffuser nozzle (15) and the hydrogen and oxygen production nozzle (18), which allows the thermolysis process to become self-sustaining. The hydrogen thermolysis reactor (1) uses the heat of the burning hydrogen and oxygen within its core to provide thermal energy to heat additional water until it becomes disassociated and provides heat energy at the same time that is converted to mechanical drive which provides the electricity and hydraulic force needed to keep the process going and produces hydrogen and oxygen for storage in the process. In fact, the hydrogen thermolysis reactor (1) is classified as a reactor because it creates a self-sustained reaction once began. Either the hydrogen thermolysis diffuser nozzle (15) producing a source of direct heat or the hydrogen and oxygen production nozzle (18) producing hydrogen and oxygen for storage may be beneficially used as a stand alone apparatus without being incorporated into the hydrogen thermolysis reactor to create a self-sustaining reaction.

The scope of the invention is very broad in the sense that it attempts to invent or re-create an entirely new energy system based on hydrogen power that operates within the concepts and embodiments of the principal invention, a method and apparatus that accomplishes thermolysis of water into hydrogen and oxygen and uses the energy derived from the hydrogen and oxygen by direct combustion or by use of a fuel cell to produce electricity or a hydrogen battery to produce electricity. The primary invention of a practical method of thermolysis of water into hydrogen and oxygen once created, opens the doorway to invent many new apparatus that are created using the primary invention, such as cars, airplanes, boats, power plants, heating systems, cooling systems, spaceships, trains, hydrogen batteries, rockets, etc. The list is endless and encompasses all forms of work (energy) that is known. Heat, work and energy are interchangeable and the invention produces abundant heat/energy and in theory is capable of performing all types of work that require energy.

In its simplest terms the invention is capable of burning water, turning water into a direct fuel. The earth is two-thirds covered with water and the earth's atmosphere is filled with water. The availability of water is endless, which means that an endless source of fuel is made available by the present invention; and, therefore, an endless source of energy is made available. Even better, the fuel is recyclable. The water burned as hydrogen and oxygen becomes water vapor that condenses back into The invention incorporates several embodiments that can run forever on the same supply of water by recycling the water in a sealed system. In addition the invention has an apparatus to obtain pure water from the water vapor in the air. This apparatus may be very important in the future as natural water supplies of pure, potable water diminish.

The present invention provides a renewable, perpetual source of energy that is clean and dependable and provides numerous embodiments of the apparatus that beneficially use the hydrogen and oxygen produced by the present invention to provide the conveniences of life, such as transportation, inexpensive electricity, the power needed for manufacturing and agriculture/aquaculture and even space travel. All of societies' energy needs can be met by the present invention for many years to come and “best of all” is that it will be a clean non-polluting energy future.

In the preferred embodiment of the present invention a hybrid gas-fired turbine/steam turbine is created, having a ceramic heat-shield lined, water-cooled hydrogen thermolysis reactor, pressurized thermolysis coil, electric resistance heating unit or masers and/or laser heating unit, electric arc heating/ignition system or a heating/ignition system, a hydraulically operated needle valve or electrically operated solenoid valve, and a hybrid gas-fired turbine/steam turbine. The hybrid turbine receives the hot exhaust propellant gases with the addition of steam produced by the hydrogen thermolysis reactor that is fueled by water cracked into hydrogen and oxygen. A variable exhaust nozzle controls the volume of exhaust gases that enter the turbine to aid in the performance of the turbine and to assist in reducing such volume of hot gases entering the turbine that would damage its metallurgy. The design of the hybrid gas- fired/steam turbine of the present invention accomplishes an enormous improvement over prior art turbine engines. The present invention does not require a compressor. In prior art patents two-thirds of the energy produced by the power turbine is consumed in providing the energy required to generate compressed air. In these prior art turbines, the compressor turbine is connected to the power turbine by a shaft and energy from the power turbine is transferred along the shaft to the compressor turbine to supply compressed air containing oxygen needed for combustion. The compressed air once ignited becomes the hot gases that provide propellant to drive the power turbine.

In the preferred embodiment of the present invention, water is cracked and burned in the form of a hydrogen and oxygen fuel plasma and water is heated into steam and added to the hot hydrogen and oxygen exhaust gases to cool the exhaust gases to such extent that the heat of the gases does not harm the turbine's metallurgy. The cooling of the hot exhaust gases by mixing cooler steam with the gases of the present invention is the second substantial improvement to the hydrogen thermolysis reactor's design over that of the prior art. This process allows more fuel to be burned in the hydrogen thermolysis reactor. The quantity of fuel that can be burned is the most limiting factor in the performance of gas-fired turbines in the prior art. The perfect embodiment of the present invention allows the burning of almost unlimited hydrogen and oxygen fuel plasma within its hydrogen thermolysis reactor. In addition, adding steam to the hot gases results in a substantial increase in the amount of propellant created and therefore the amount of energy the apparatus can generate. Steam is cooler, more dense and generates more force than is produced by thin hot gases.

In the preferred embodiment of the present invention thermolysis is accomplished as a heat and ignition process. In the first step water is pressurized to sufficient pressure as not to allow the water to turn into steam and is passed through a spiral coil (thermolysis coil) that is located at the center of the hydrogen thermolysis reactor. The water receives thermal energy (heat) from the high temperature of the hydrogen thermolysis reactor's core. This is a pre-heat process that allows substantial thermal energy to be gained by the water and in accordance with the Second Law of Thermodynamics, may result in complete or partial thermolysis of water within the liquid state due to extreme temperature, +(−) 2,500 deg. F., and pressure up to 10,000 p.s.i. The second step is to further heat the liquid contained in the thermolysis coil via an electric resistance current passed through the fluid to raise the temperature to near 5,000 deg F. or to heat the water using masers and/or lasers just prior to injection from the thermolysis coil. The final step to assure full thermolysis of the water is the injection of the superheated fluid into a vacuum zone having negative-pressure created by a vacuum turbine. The disassociated water becomes a hydrogen and oxygen plasma that is passed through an electric arc capable of reaching temperatures up to 90,000 deg. F. or a series of laser beams capable of temperatures up to one million degrees F. The temperature of the arc is up to 15 times the temperature that is thought to be required to fully thermolize water of approximately 3500 K (5,840.6 deg. F.). The result of diffusion into the low-pressure hydrogen thermolysis diffuser nozzle's area of negative-pressure is that the fluid, previously held in the liquid state due to pressurization, will immediately transform into separate atoms of hydrogen and oxygen in the gaseous state, which will become ignited by the electric arc or laser beams. The water via this heat/ignition process as herein described in the present invention is transformed into a hydrogen and oxygen fuel plasma and is ignited to perform work via a turbine or steam engine, etc. The efficiency of the apparatus shall be very great because the temperature difference between the lower ambient temperature of the water, +(−) 70 deg. F. as the lower temperature and the hydrogen and oxygen fuel plasma, +(−) 10,000 deg. F. as the upper temperature is enormous.

The present invention eliminates the need for having large-scale hydrogen production facilities, hydrogen transport trucks, filling stations and large storage tanks because the hydrogen is produced and used simultaneously aboard the power unit.

The apparatus shall be equipped with adequate safety equipment such as automatic shutdown if the water supply is low or lost or if excess heat is generated, or if the pressure of the thermolysis coil drops, etc. The greatest risk of the present invention would be the rupture of the thermolysis coil. In such an event an explosion could occur as a large amount of hydrogen and oxygen (cracked water contained in the coil) would immediately occur within the hydrogen thermolysis reactor and would become ignited. This consideration should receive the attention it deserves in the final design of the present invention. It is extremely important that the present invention be a safe device. Special re-enforcement of the hydrogen thermolysis reactor and turbine housing and careful direction of blast gases should be incorporated into the design as to prevent injury in case of rupture of the thermolysis coil. Further, special attention to the construction of the thermolysis coil must be maintained to prevent the rupture of the coil. Excess strength beyond the operating pressures and temperatures must be incorporated into the materials of the thermolysis coil to provide a significant margin of safety.

In summary, the configuration of the preferred embodiment of the present invention creates a hydrogen thermolysis reactor, that is lined with ceramic heat-shield tiles and is water-jacket cooled, that burns cracked-water in the form of hydrogen and oxygen fuel plasma that drives a hybrid gas-fired/steam turbine whose output propellant is enhanced with steam generated by the water-jacket that aids in the cooling of the hydrogen thermolysis reactor. The hybrid gas-fired/steam turbine operates at near complete efficiency because the turbine does not have to expend two-thirds of its energy running a compressor. Further, the product of burning hydrogen and oxygen is water vapor, which cools and condenses into water.

In a closed-cycle configuration of the preferred embodiment of the present invention the water is then cycled into fuel and propellant again. Except for some minor evaporative loss, if any, the system can run perpetually off the same supply of system water, i. e. a car could be equipped with a small hydrogen thermolysis reactor and hybrid gas fired turbine/steam turbine of the design of the present invention that produces sufficient steam to operate a small steam engine. The steam expands and cools in the process of driving the pistons of the engine and could then be circulated to a radiator to further cool the steam to water. The water could then be recycled to power the hydrogen thermolysis reactor in this closed cycle and the car could keep running indefinitely on its one water supply, less minor loss to evaporation if any. A large steam engine of this design would work well on heavy ships, trains and for electric power generation.

Within the scope of the present invention lighter-than-air airplanes and/or spaceships, boats, and personal transport vehicles are created using hot air lift and downward thruster lift which are powered by hydrogen thermolysis reactors, the primary invention. These transportation devices use water as a fuel, which helps to prevent pollution from hydrocarbon emissions and helps to conserve the remaining supplies of fossil fuels for future uses, other than as an energy carrier, such as the production of plastic, etc.

A substantial advantage of the present invention is that cars, buses, trucks, boats, or airplanes would be much lighter because they would have no heavy fuels to carry and they would therefore be much more efficient.

Another substantial advantage of the perfect embodiment of the present invention is that the apparatus is non-polluting. The effluent, except as used in a closed cycle which produces no effluent, is merely water vapor. With mounting environmental concerns including global warming and habitat destruction, there is a great need for cleaner energy sources. The present invention that creates a hydrogen based energy society constitutes an important improvement to prior art energy systems.

### BRIEF DESCRIPTION OF DRAWINGS

FIG. 1. is the preferred embodiment of the invention, and is a cross sectional view of the hydrogen thermolysis reactor (1) and hybrid gas-fired turbine/steam engine (17) driving an electric generator (26) and hydraulic pump (10A). Water (14) is pumped by a hydraulic system (10) with multiplication of hydraulic force (Detailed in FIG. 7.) that uses a hydraulic pump (10A) to pump water (14) into a long, small diameter cylinder and piston (10C) which uses hydraulic force multiplication to drive a short, large diameter cylinder and piston (10D) having greater pressure. The large diameter cylinder and piston (10D) pump hydraulic fluid which is pressurized water (14D) into the thermolysis coil (13) under great pressure (The hydraulic system is detailed in FIG. 7.). The thermolysis coil (13) is located at the center of the thermolysis reactor (1) where it gains heat from the fuel (hydrogen and oxygen) burning within the hydrogen thermolysis reactor (1). The reactor (1) has an outer metal housing (1B) surrounded by a water-jacket cooling system (16) supplied with coolant water by a hydraulic water pump (10A). The reactor (1) has an inner lining of ceramic heat-shield tiles (1A). The pressurized water (14D) in the thermolysis coil (13) moves through the coil until it reaches the thermolysis diffuser nozzle (15). The thermolysis diffuser nozzle (15) consists of an electrical resistance (current) heating coil (15A), a hydraulically operated needle valve (15B), an electric arc (15C), and a hydraulically operated vacuum turbine (15D). The thermolysis diffuser nozzle (15) is detailed in FIG. 2. and an alternate embodiment of the thermolysis diffuser nozzle (15) is detailed in FIG. 3. The pressurized water (14D) is further heated by the thermolysis diffuser nozzle (15) and is disassociated into atomic hydrogen and atomic oxygen and is ignited by the arc (15C) and is burned in the hydrogen thermolysis reactor (1).

A portion of the pressurized water (14D) in the thermolysis coil (13) is diverted to the hydrogen/oxygen production nozzle (18) consisting of an electrical resistance (current) heating coil (18A), a hydraulically operated needle valve (18B). Heat within the hydrogen/oxygen production nozzle (18) breaks the pressurized water (14D) into disassociated water (13A) being atomic hydrogen and atomic oxygen. The hydrogen and oxygen is injected into a hydrogen/oxygen production cylinder (20) having a hydrogen permeable membrane (19) as its center with an outer casing (20A). An annular area (20B) is formed between the outside of the membrane (19) and the outer casing (20A). A vacuum is formed in the annular area (20B) by a hydrogen vacuum pump (21) which draws hydrogen through the hydrogen permeable membrane (19) with high-negative-pressure and compresses the hydrogen which flows through hydrogen lines (11A) to a hydrogen and oxygen battery (58) to charge the battery with hot hydrogen gas and to a hydrogen storage tank (11) for storage with high-positive-pressure. Oxygen which cannot pass through the membrane is drawn through the open center of the membrane (19) by an oxygen vacuum pump (21A) that operates at low-negative pressure and passes through oxygen lines (12A) and is compressed into the hydrogen and oxygen battery (58) and into an oxygen storage vessel (12) with low-positive pressure. The differential pressure created between the outside and inside of the hydrogen permeable membrane (19) with lower pressure on the outside of the membrane (19) draws the hydrogen through the membrane (19). The hydrogen/oxygen production nozzle (18) is detailed in FIG. 6. and the alternative hydrogen/oxygen production nozzle (18) is detailed in FIG. 6A. The hydrogen/oxygen production cylinder (20) is detailed in FIG. 5.

Water (14) is pumped into a water-jacket coolant system (16) by a hydraulic water pump (10A). The water-jacket (16) surrounds and cools the hydrogen thermolysis reactor (1) and drives and cools the thermolysis nozzle vacuum turbine (15D). The water (14) removes heat from the reactor (1) and becomes heated. The water (14) becomes steam (41) that is added to the hot hydrogen/oxygen exhaust gases (36) of the reactor (1). The combined steam (41) and hot exhaust gases (36) exit the hydrogen thermolysis reactor as propellant (1C).

The propellant (1C) passes through a variable turbine intake nozzle (22) and drives a hybrid gas-fired turbine/steam turbine (17) consisting of a power turbine (24) and an output shaft (25). An electric generator (26) is connected to the output shaft (25) that produces electricity (9). A hydraulic pump (10A) is also connected to the output shaft (25). The hydraulic pump (10A) produces pressurized water (14D) for use in the thermolysis coil (13) and for use in the water-jacket cooling system (16).

Additional electricity (9) is produced by a hydrogen fuel cell (5) that receives a supply of hydrogen and oxygen from the hydrogen/oxygen production cylinder (20). The flow of hydrogen to the fuel cell (5) is controlled by an electrically controlled hydrogen supply solenoid valve (5B) and the flow of oxygen to the fuel cell (5) is controlled by an electrically controlled oxygen supply solenoid valve (5A). The fuel cell (5) produces heat, electricity (9), and water (14) which may be recycled and used in the hydrogen thermolysis reactor (1) or water-jacket cooling system (16).

The hydrogen thermolysis reactor (1) is started by burning hydrogen and oxygen supplied by a hydrogen supply line (11A) from a hydrogen supply tank (11) through an electrically controlled hydrogen storage tank supply valve (11B) and by an oxygen supply line (12A) from an oxygen supply tank (12) through an electrically controlled oxygen storage tank supply valve (12B), which flows into the hydrogen thermolysis reactor (1) to be burned to produce the critical operating temperature for thermolysis to begin.

Hot exhaust gases discharged from the hydrogen thermolysis reactor (1) are controlled by a hydraulically operated exhaust output control flap (23). The flow of hydraulic fluid to the exhaust output control flap (23) is regulated by electrically operated on/off solenoid valves (10H). The hydraulic fluid is supplied from a hydraulic pump (10A) by hydraulic supply lines (10E) and hydraulic return lines (10F) bring the fluid back to the hydraulic fluid (water) reservoir (14C).

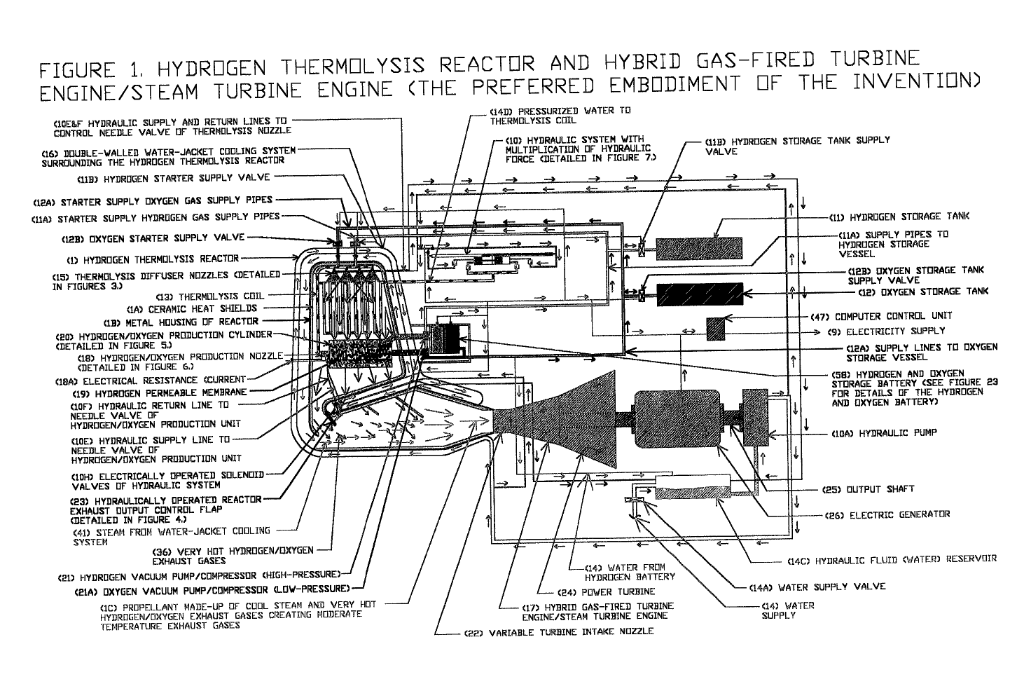

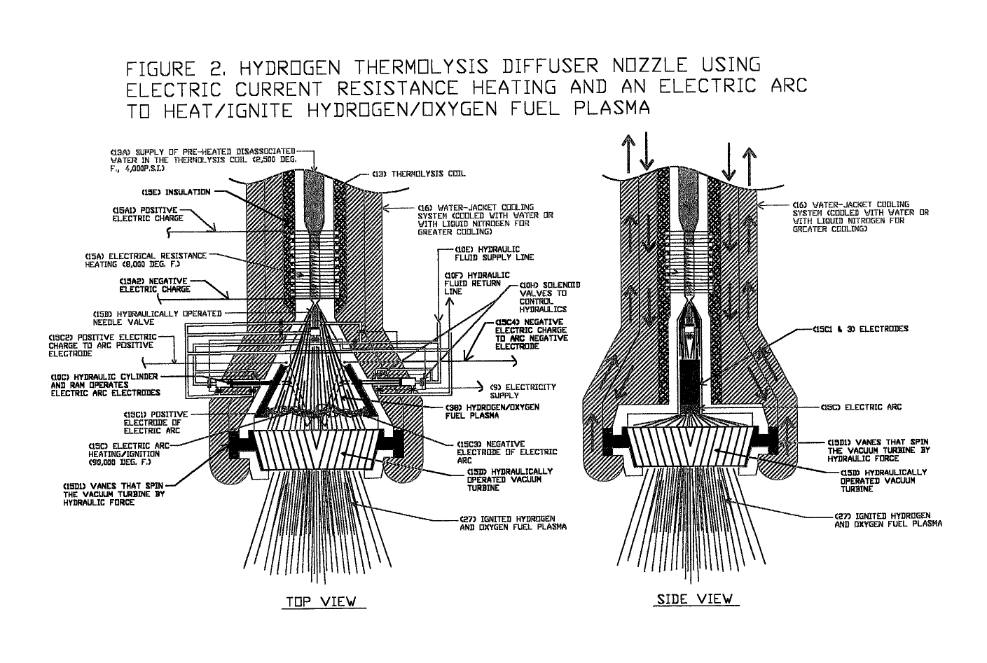

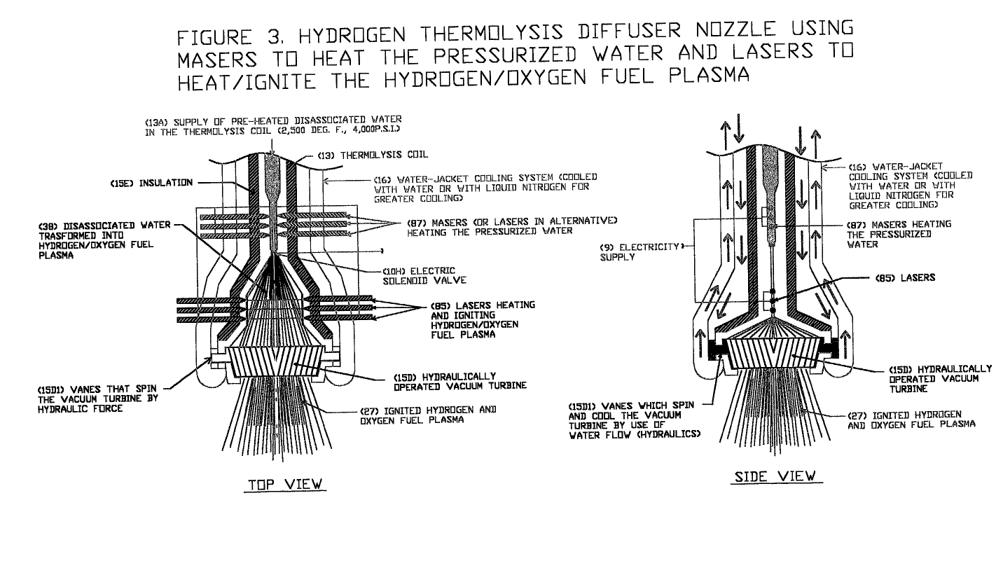

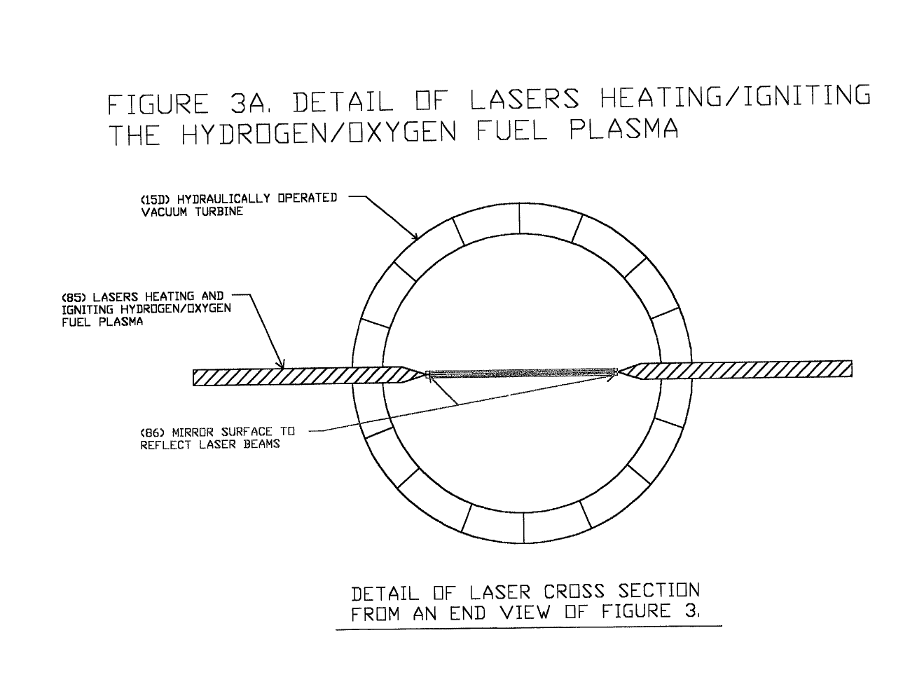

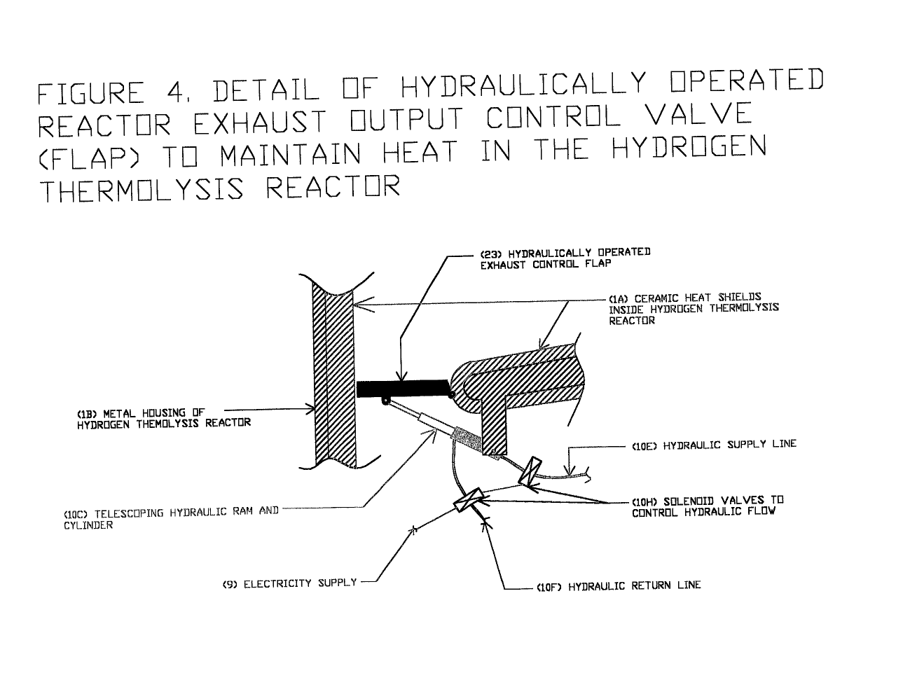

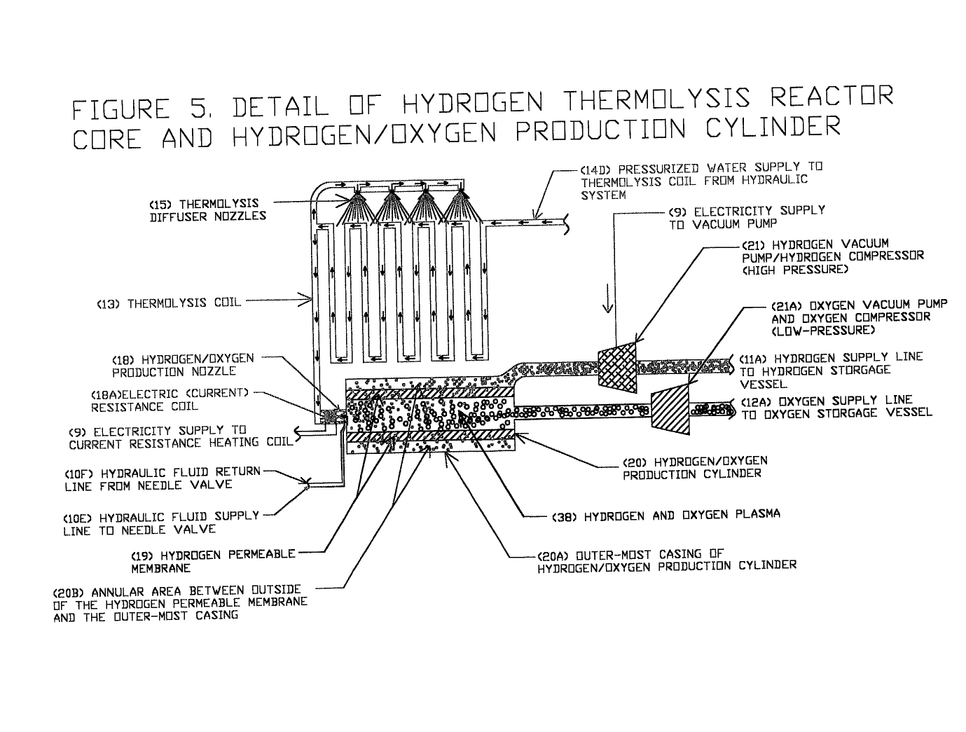

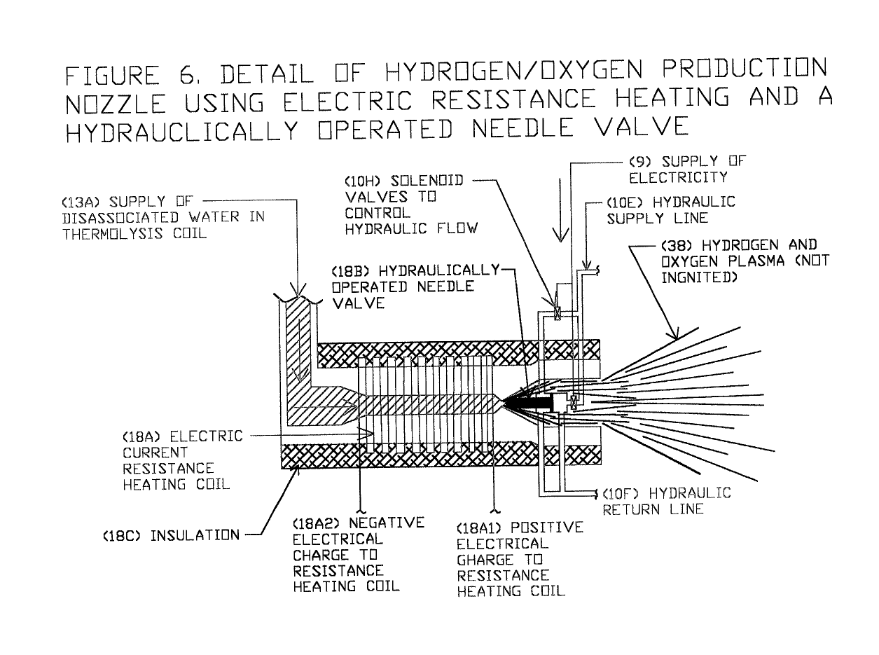

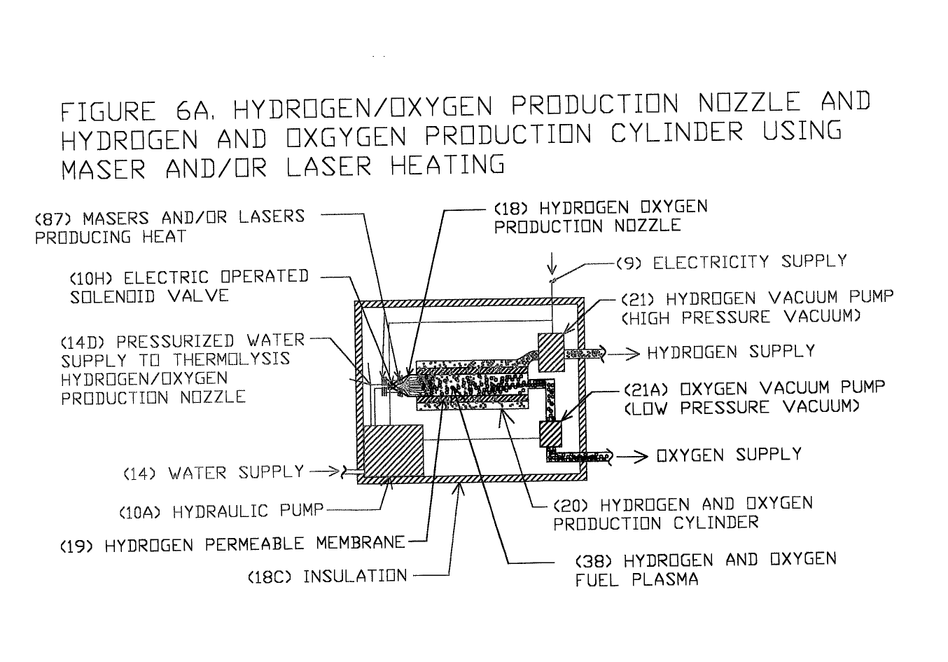

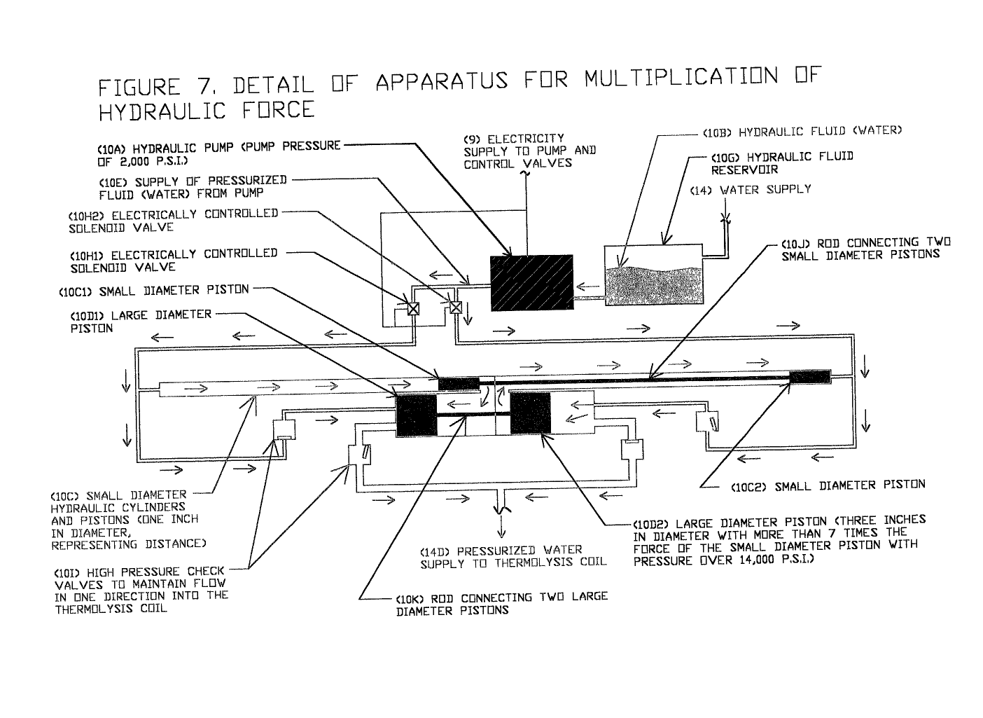

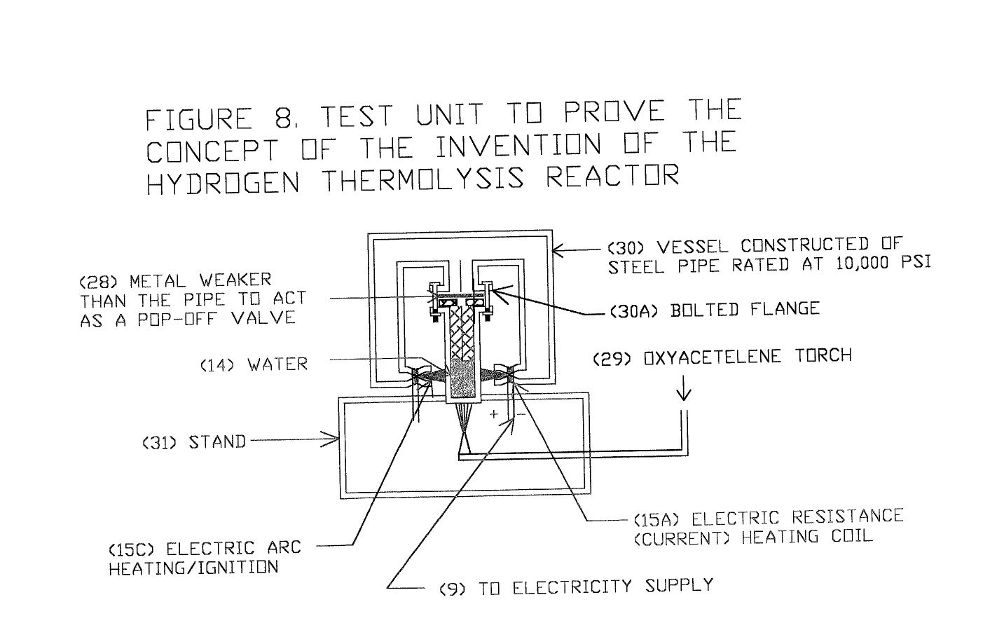

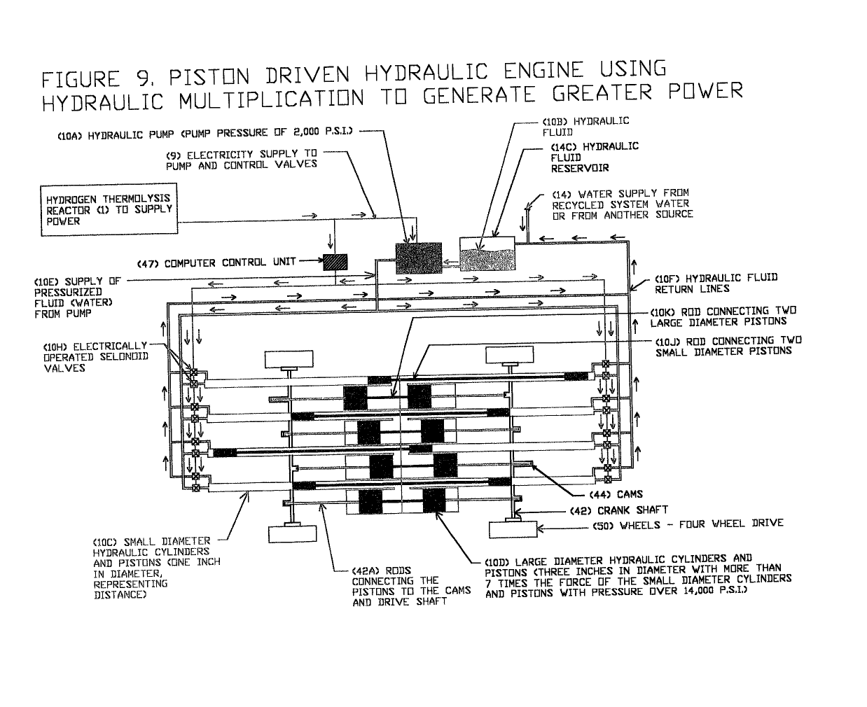

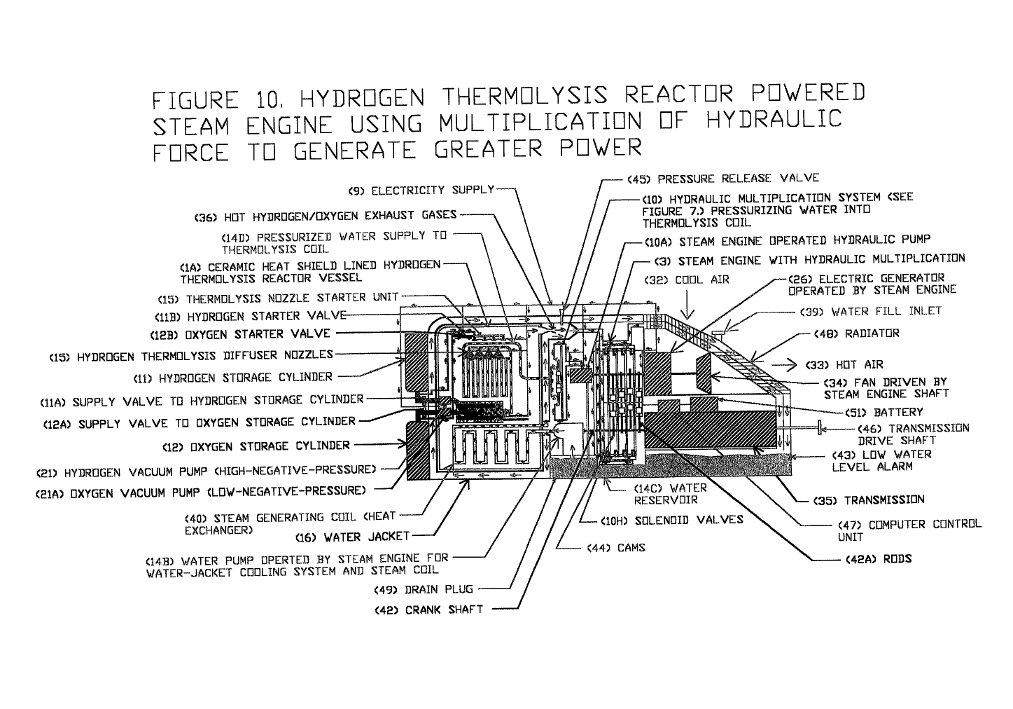

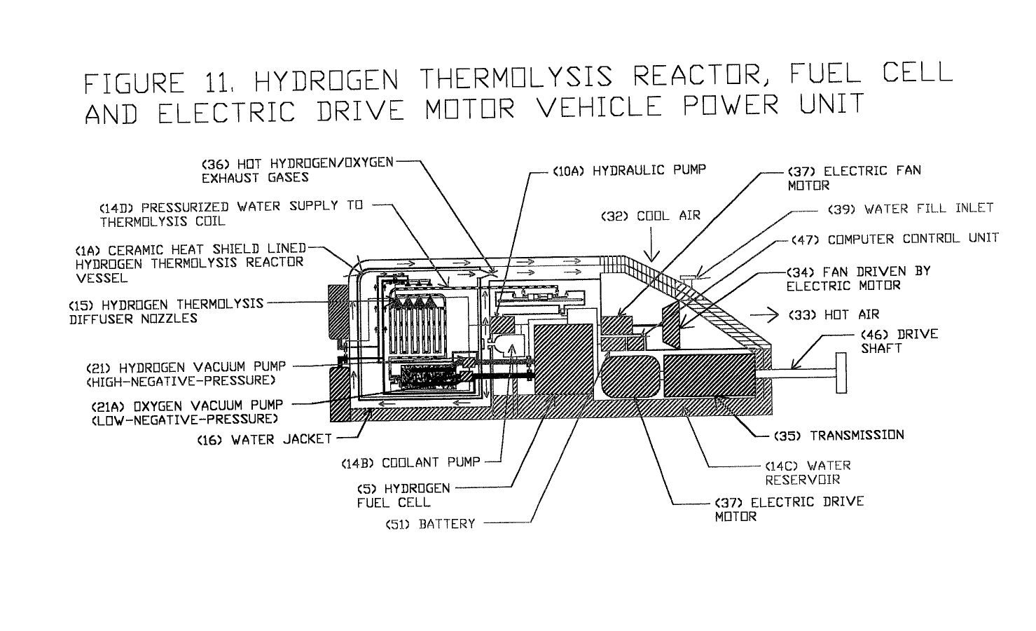

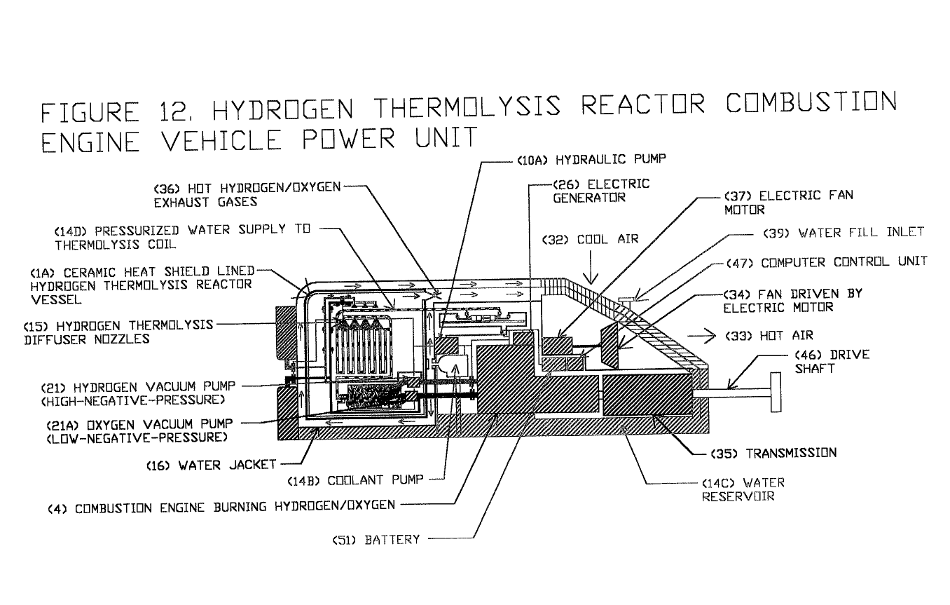

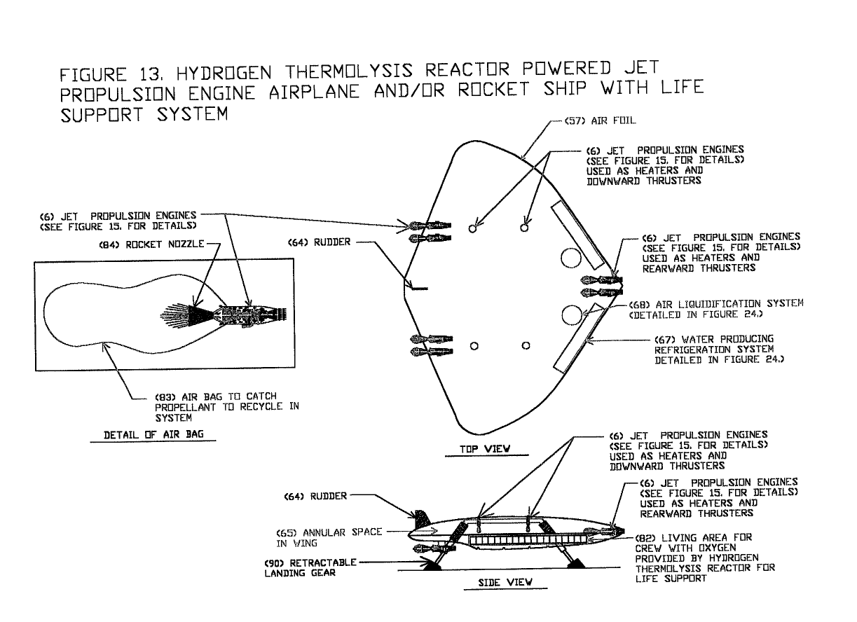

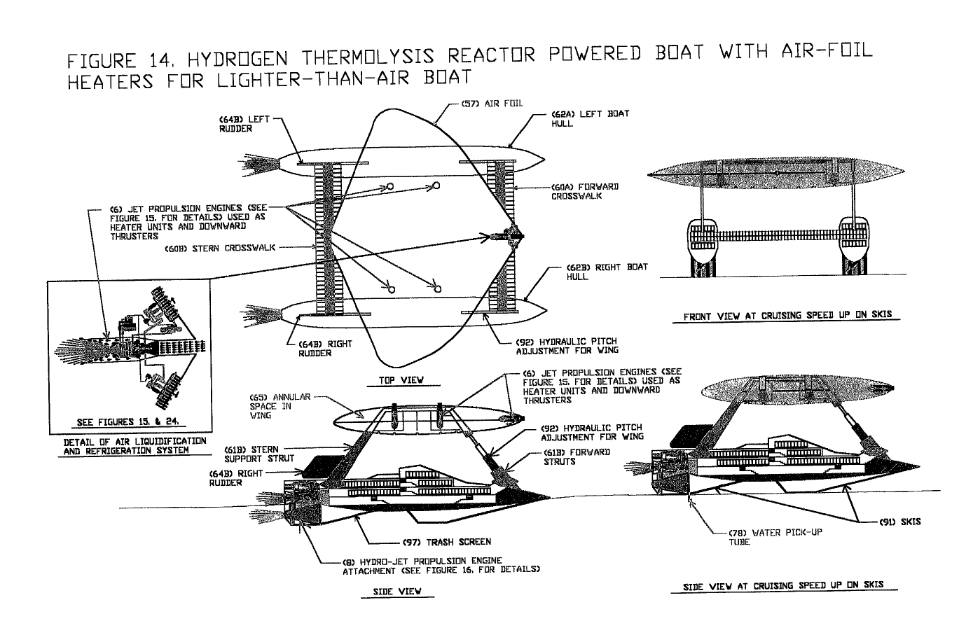

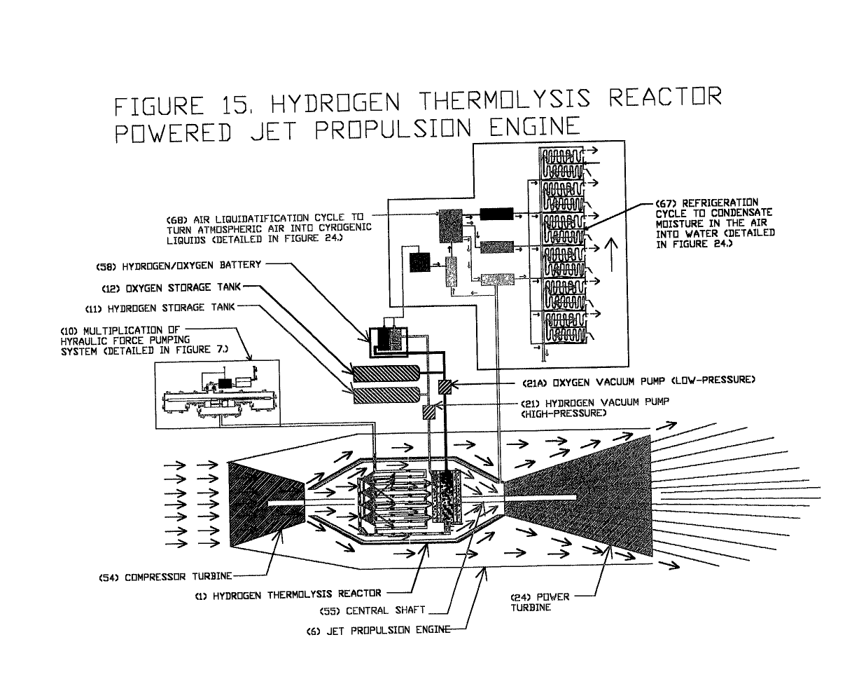

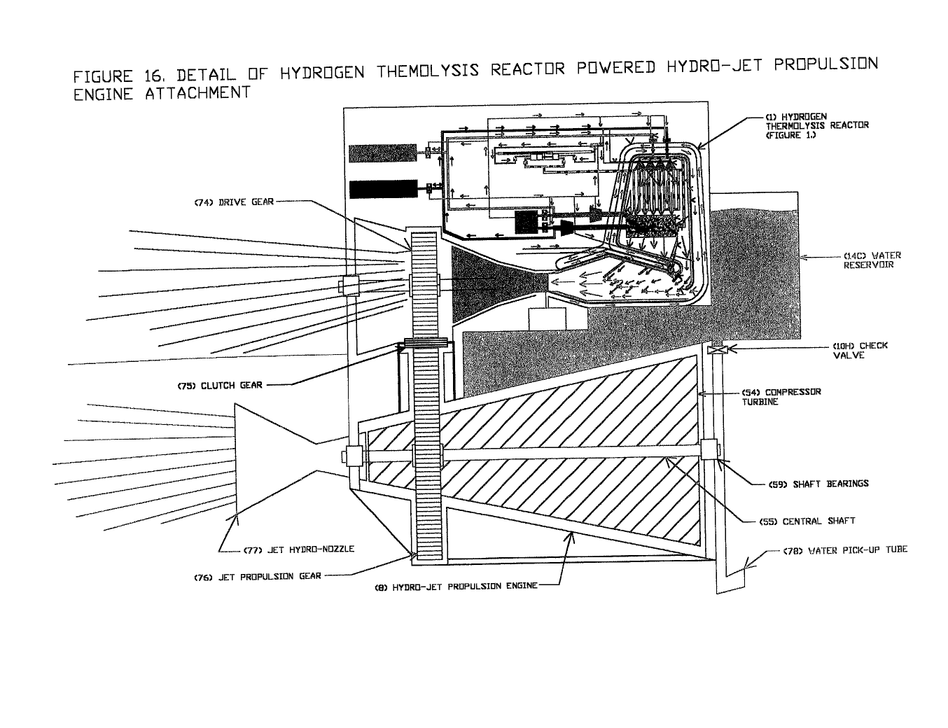

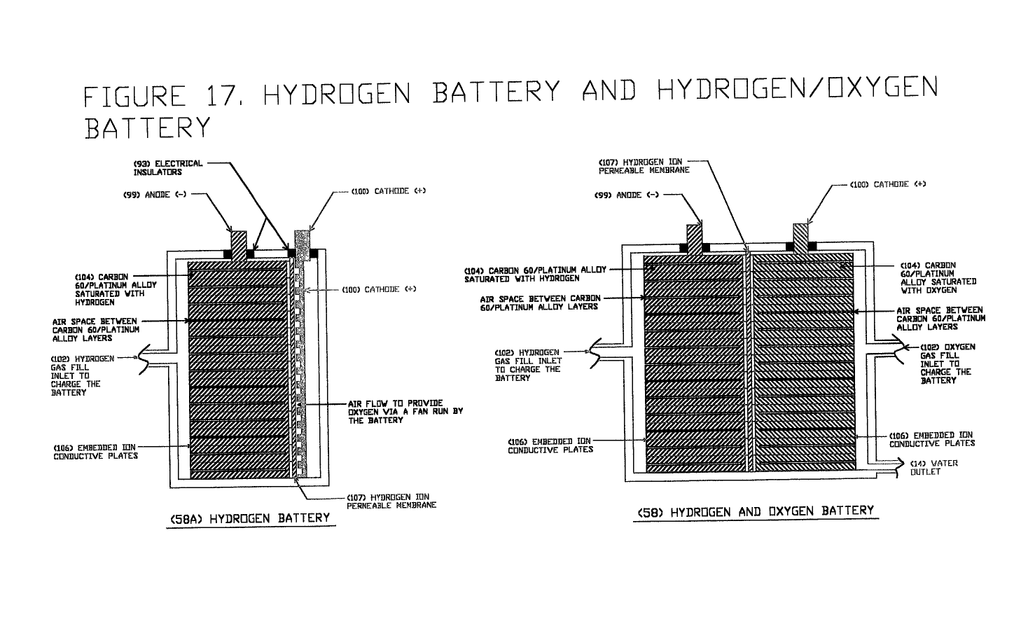

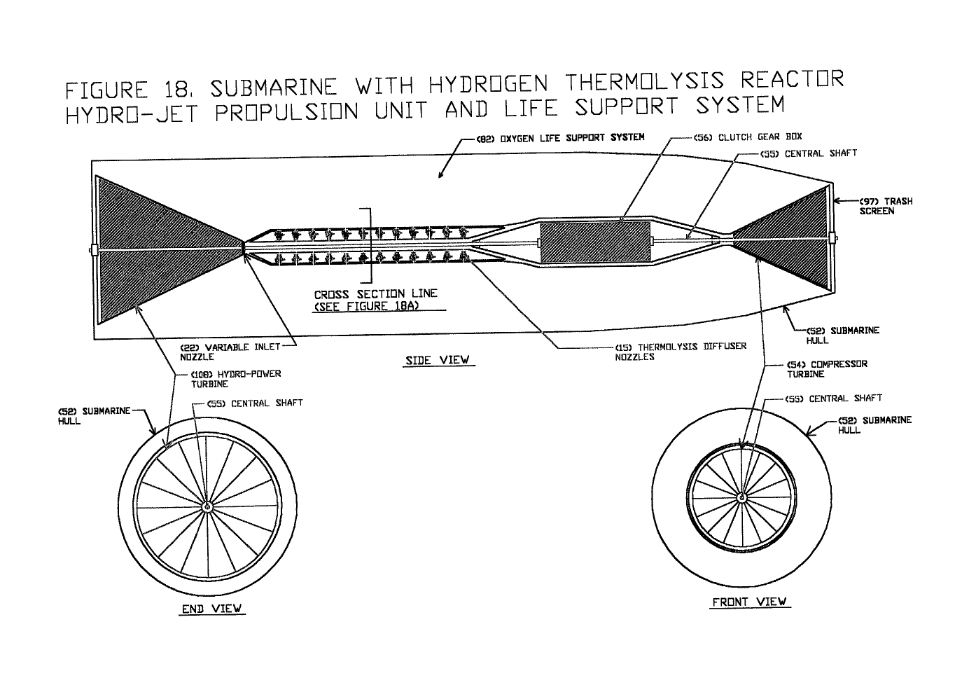

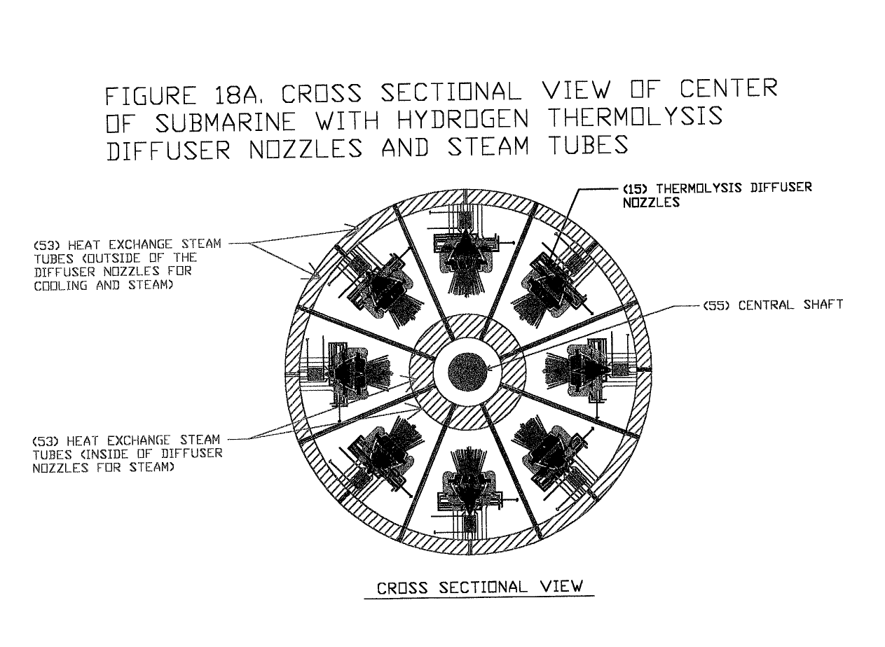

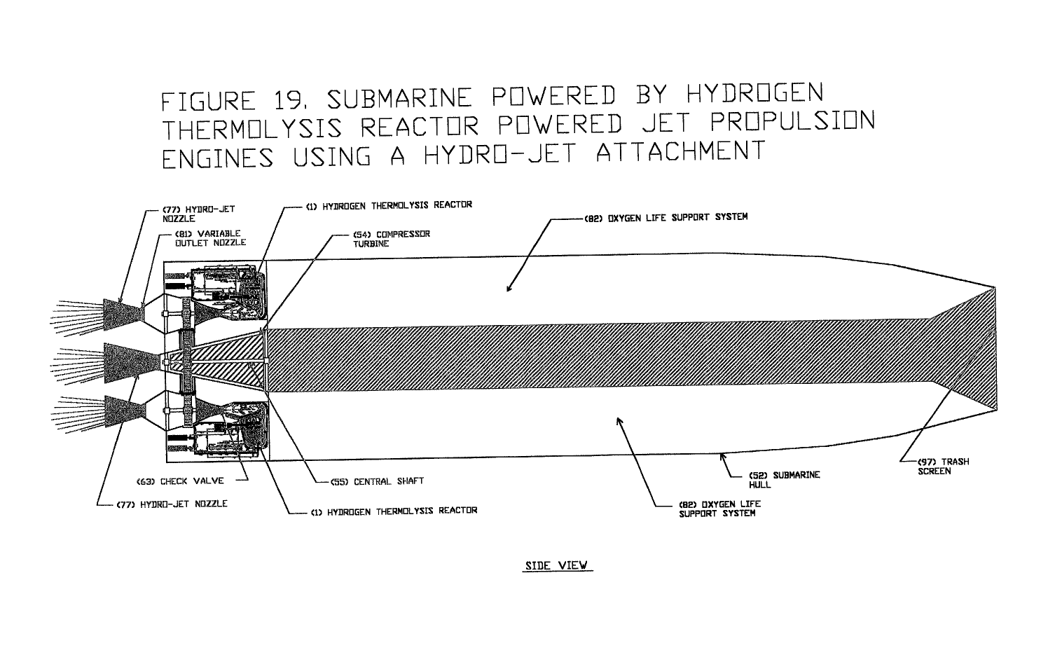

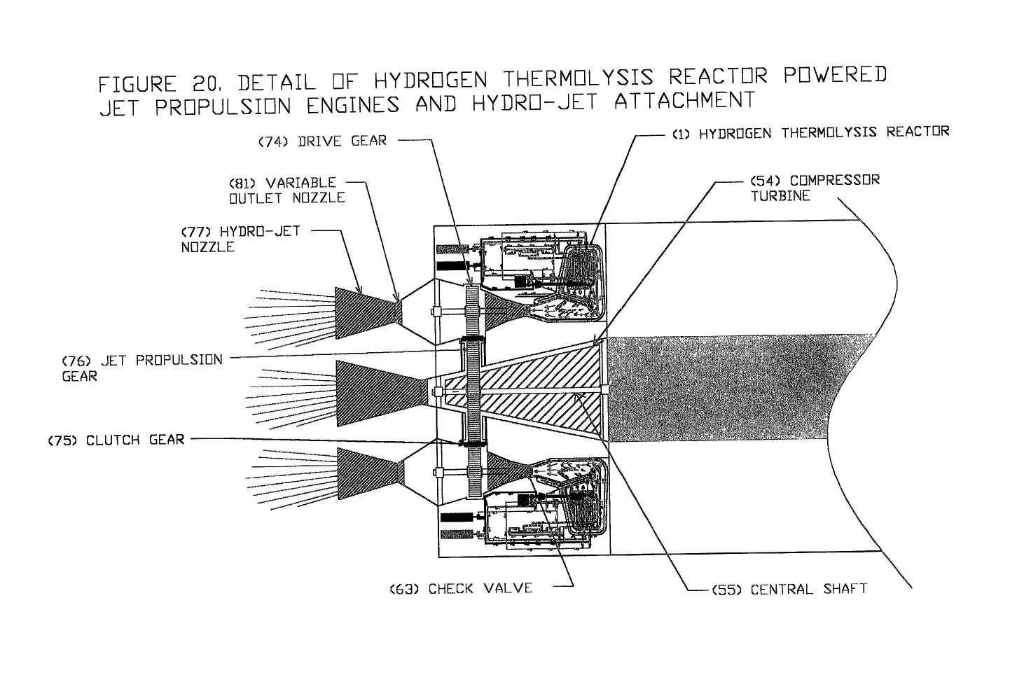

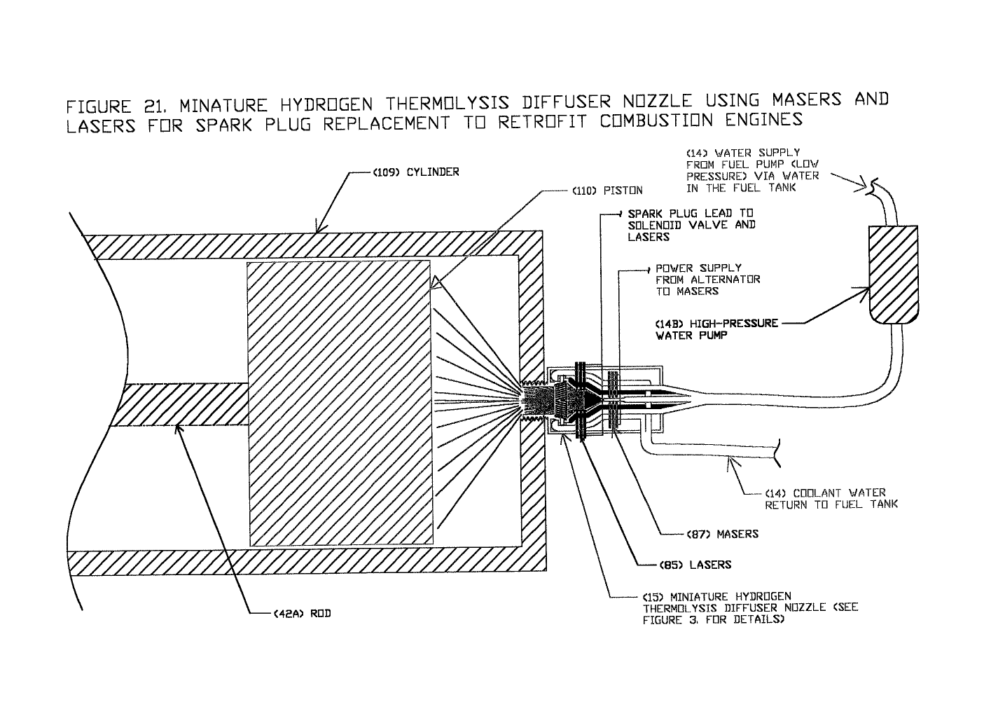

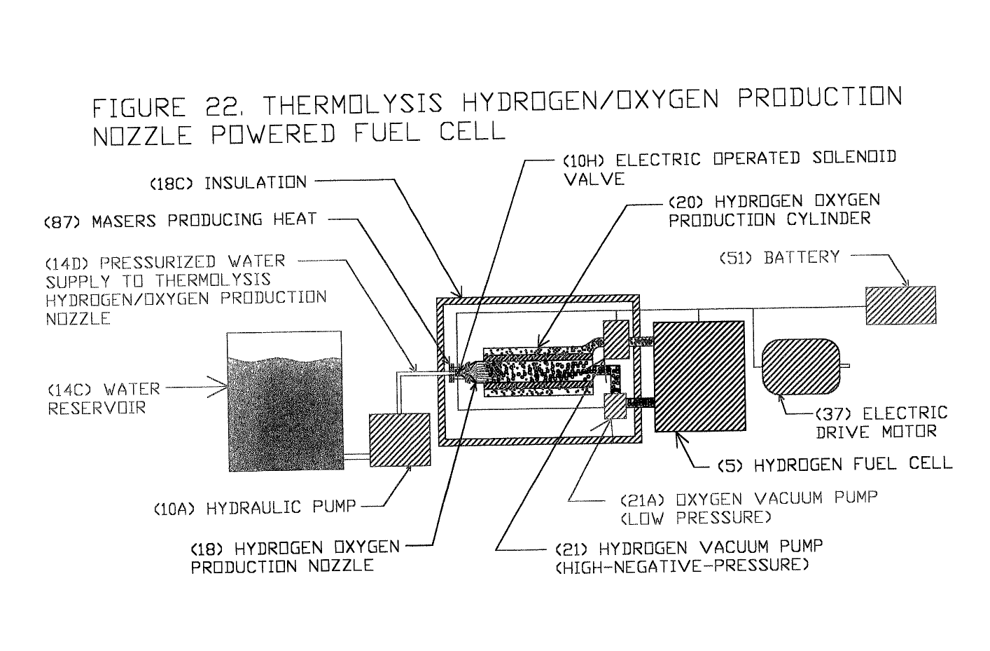

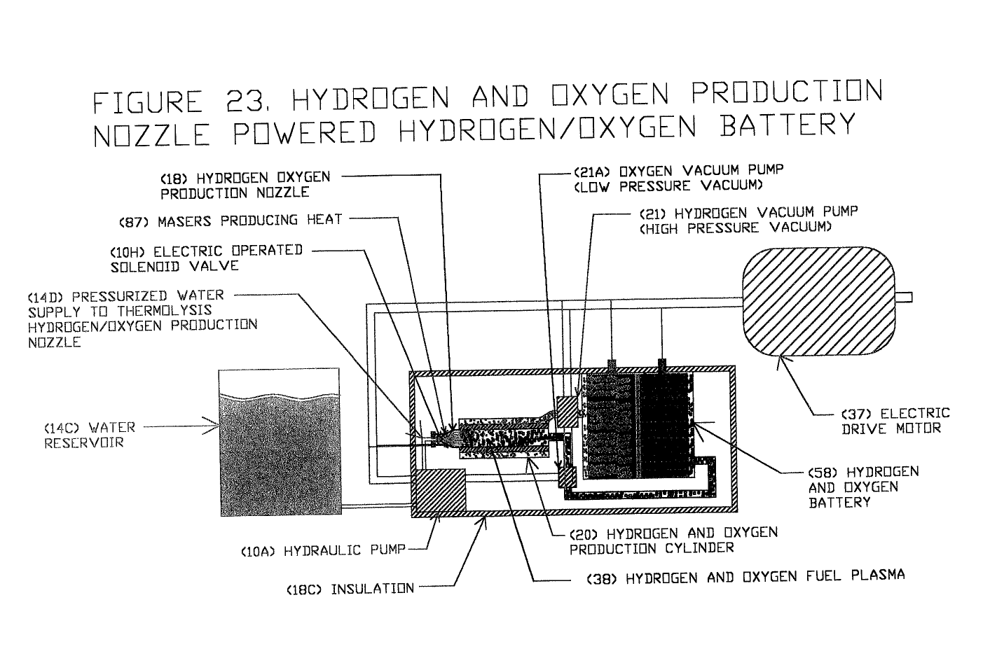

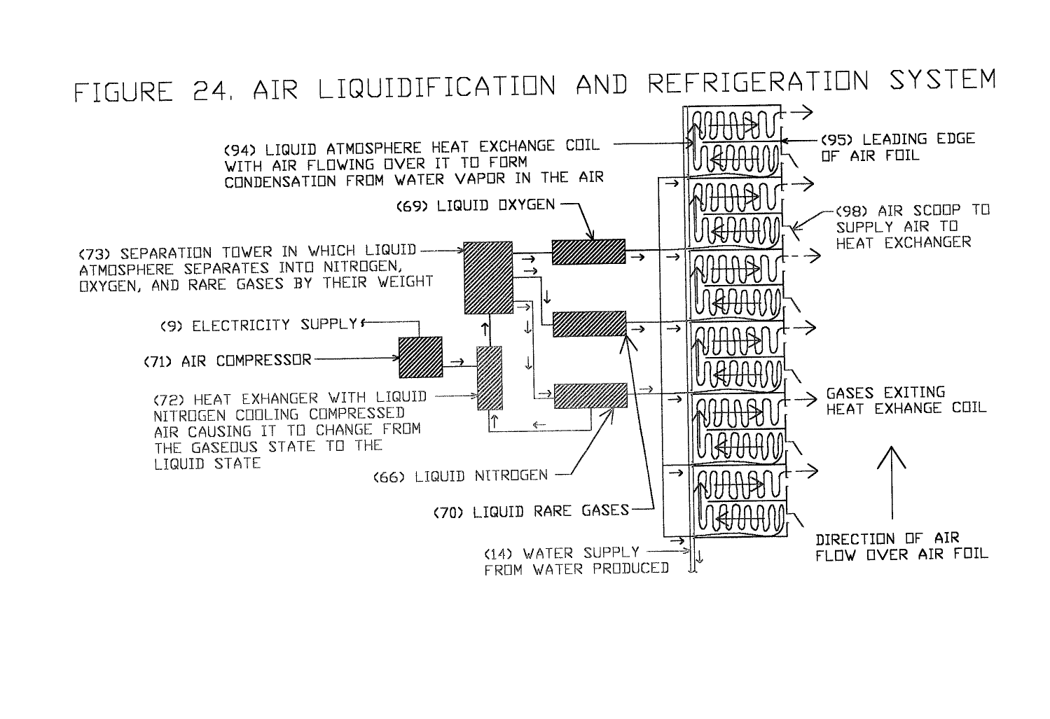

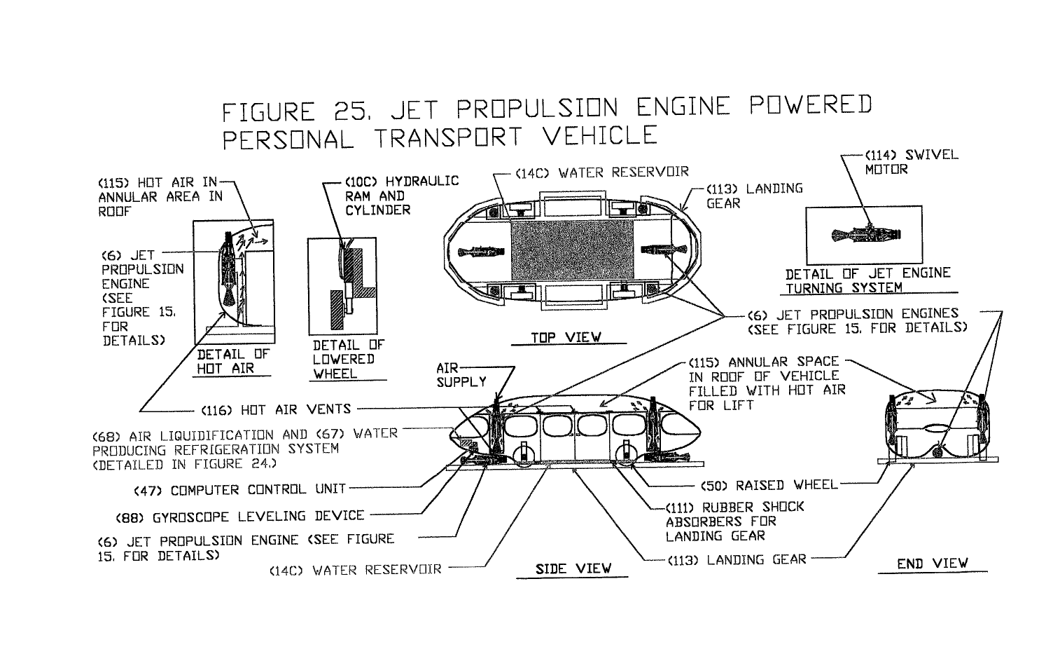

FIG. 1. is further equipped with a hydrogen and oxygen battery (58) to store hydrogen and oxygen for the production of electricity and for use during start-up and a computer control unit (47) to operate the entire system. (The hydrogen and oxygen battery is detailed in FIG. 17.)

FIG. 2. is a top view cross sectional detail and a side view cross sectional detail of the thermolysis diffuser nozzle (15) in FIG. 1. Pre-heated, high-pressure disassociated water (13A) within the thermolysis coil (13) flows into the thermolysis nozzle (15) and is heated by an electrical resistance (current) heating coil (15A) wrapped around the metal housing of the thermolysis coil (13) further heating the disassociated water (13A). An electrical current (9) is supplied to the electrical resistance heating coil (15A) having a negative electrical charge (15A2) and a positive electrical charge (15A1). Insulation (15E) surrounds the heating coil (15A) to prevent the water-jacket cooling system (16) from cooling the electrical resistance heating coil (15A). A hydraulically operated needle valve (15B) is operated by a flow of hydraulic fluid from a hydraulic supply line (10E) which is controlled by a electrically operated solenoid valve (10H). The needle valve (15B) determines the volume of disassociated water (13A) that can flow through the thermolysis diffuser nozzle (15) into a vacuum created by a hydraulically operated vacuum turbine (15D). Inside the area of negative pressure (vacuum) the disassociated water (13A) undergoes change from the liquid state to gaseous state due to the pressure reduction and transforms into a hydrogen/oxygen plasma (38), which becomes further heated and is ignited by an electric arc (15C). The electric arc (15C) has a positive electrode (15C1) which has a positive electric charge (15C2) and a negative electrode (15C3) which has a negative electric charge (15C4). The front end of the positive electrode (15C1) touches the front end of the negative electrode (15C3) and an electrical current (9) is passed through them to begin the electric arc. Once the arc (15C) begins, the positive electrode (15C1) and negative electrode (15C3) are separated by hydraulic control (10C) and the electric arc (15C) continues to jump (arc) between the electrodes so as the electrical current (9) continues. The hydraulic system (10C) is controlled by electrical solenoid valves (10H) that control the flow of hydraulic fluid (10B), which is water, through the hydraulic supply lines (10E) and hydraulic fluid return lines (10F). The thermolysis nozzle (15) is the apparatus of the present invention that actually accomplishes thermolysis of water into hydrogen and oxygen. This is the first of two embodiments of the diffuser nozzle ( 5). The second embodiment is detailed in FIGS. 3. and 3A.

The side view detail of the thermolysis diffuser nozzle (15) in FIG. 1. demonstrates the shape of the thermolysis diffuser nozzle (15) from the side view, which is more narrow at the point of the electric arc (15C) so that the hydrogen/oxygen fuel plasma (38) must pass directly through the center of the electric arc (15C) so that it is further heated and ignited. Additionally, the side view detail more clearly demonstrates the flow of coolant water through the water-jacket (16) that cools the hydrogen thermolysis nozzle (15) and cools and drives (spins) the vacuum turbine (15D) as it passes over the vanes (15D1) at the outer edge of the turbine (15D) on either side of the turbine (15D), which functions much like a high-speed water wheel.

FIG. 3. is a top view and side view cross sectional detail of an alternative thermolysis diffuser nozzle embodiment using masers (87), which use sound waves (as used in a microwave oven) to heat the pressurized water (14D) by sending sound waves through the pressurized water (14D), causing the molecules of the water to gain thermal energy by excitement of the atoms, until it becomes disassociated water (13A) that is diffused into a low-pressure, high temperature zone by electrically controlled solenoid valves (10H). Lasers (85) could also be used in this application by directing a laser (85) beam on the metal housing of the diffuser nozzle (15) to heat the water (14) within the metal tubing by conduction of heat through the metal. The disassociated water (13A) transforms from the liquid state to the gaseous state and becomes hydrogen/oxygen plasma (38) that is further heated by lasers (85) and is ignited by the lasers (85). The low-pressure, high temperature zone is created by a vacuum pump turbine (15D) that is operated by hydraulic flow over vanes (15D1) that are located on either side of the vacuum turbine (15D). The hydraulic fluid (10B) cools the diffuser nozzle (15) and vacuum turbine (15D) and spins the vacuum turbine (15D). The thermolysis nozzle (15) is the apparatus of the present invention that actually accomplishes thermolysis of water into hydrogen and oxygen.

The advantage of this embodiment of the diffuser nozzle (15) is that it can be timed instantaneously to diffuse and ignite a specific portion of hydrogen and oxygen by the instantaneous opening of the solenoid valve (10H) allowing a portion of disassociated water (13A) to enter the chamber at the same time the lasers (85) discharge, which can be accomplished by a single electrical charge (9) activating both the solenoid valve (10H) and the lasers (85). A laser (85) is also capable of producing greater heat, (up to a million deg. F) than may be produced by an electric arc (15C) that is capable of reaching temperatures of 90,000 deg. F.

FIG. 3A. is an end view detail of lasers (85) of the thermolysis diffuser nozzle (15) embodiment of FIG. 3. This detailed view demonstrates that the hydrogen/oxygen fuel plasma (38) must pass through a long, narrow opening in the diffuser nozzle (15). The laser (85) beam passes longitudinally through the opening and the walls of the opening have a mirrored surface (86) which reflects laser (85) light back. The reflection of the laser (85) beam allows the laser (85) to more effectively strike the molecules of hydrogen and oxygen of the fuel plasma (38). A series of lasers (85) are arranged along the narrow opening and lasers (85) are on both sides of the opening to assure that the fuel plasma (38) is sufficiently heated and ignited by the lasers (85) with the aid of the reflective mirrors (86).

FIG. 4. is a detail of the hydraulically operated reactor exhaust output control valve (23) to maintain heat in the hydrogen thermolysis reactor's (1) core during start-up of FIG. 1. An exhaust valve (23) is hydraulically controlled by a telescoping ram and cylinder (10C) which opens and closes the exhaust flap (23). An electrically operated solenoid valve (10H) controls the flow of hydraulic fluid (10B) through a supply line (10E) and a return line (10F). During start-up the exhaust flap (23) is closed to build up heat more quickly in the reactor's (1) core to reach critical operating temperature. Also the metallurgy of the turbine (17) is prevented from being harmed by very hot exhaust gases (36) as the steam (41) mixing with the hot exhaust gases (36) will not have begun yet. The flap (23) is opened when critical temperature has been reached and steam mixing begins.

FIG. 5 is a detail of the hydrogen thermolysis reactor's (1) core and hydrogen production cylinder (20) of FIG. 1. Pressurized water (14D) flows through the thermolysis coil (13) to the thermolysis diffuser nozzles (15) to be burned as hydrogen/oxygen fuel plasma (38) in the reactor (1) to produce propellant (1C) to perform work and heat to disassociate additional water into hydrogen and oxygen.

A portion of the disassociated water (13A) in the hydrogen thermolysis coil (13) is directed to the hydrogen production nozzle (18) and hydrogen/oxygen production cylinder (20). (The hydrogen/oxygen production nozzle is detailed in FIG. 6.) After passing through the hydrogen production nozzle (18) consisting of an electrical resistance (current) heating coil (18A) that further heats the pressurized disassociated water (13A) and a hydraulically operated needle valve (18B) which diffuses the pressurized disassociated water (13A) into the hydrogen production cylinder (20), the disassociated water (13A) become gaseous in the low-pressure hydrogen/oxygen production cylinder (20). The gases are atomic hydrogen and atomic oxygen which form a hydrogen/oxygen plasma (38). The center of the hydrogen production cylinder (20) consists of a hydrogen permeable membrane (19) that allows small hydrogen atoms to pass through it but will not allow much larger oxygen atoms to pass through the hydrogen permeable membrane (19). The passage of hydrogen atoms through the membrane (19) is aided by electrically operated vacuum pumps, a high-pressure hydrogen vacuum pump (21) and a low-pressure oxygen vacuum pump (21A) that creates negative pressure (vacuum). The high-negative-pressure hydrogen vacuum pump vacuums an annular area (20B) between the outside of the hydrogen permeable membrane (19) and the outer-most casing (20A) of the hydrogen/oxygen production cylinder (20). The hydrogen vacuum pump (21) draws hydrogen atoms through the membrane (19) and compresses the hydrogen through a hydrogen line (11A) and into the hydrogen storage cylinder (11). The lower-negative-pressure oxygen vacuum pump (21A) draws the oxygen that cannot pass through the hydrogen permeable membrane (19) through the center of the membrane (19) and through an oxygen line (15A) and compresses the oxygen into an oxygen storage tank (12) at lower pressure. The differential in pressures between the vacuum pumps creates a greater negative pressure (vacuum) outside of the hydrogen permeable membrane (19) and aids the passage of hydrogen through the membrane (19) to the lower pressure. This process is also aided by the fact that hydrogen diffuses faster than oxygen diffuses.

FIG. 6. is a detail of the hydrogen/oxygen production nozzle (18) of FIG. 1. The hydrogen production nozzle (18) consists of an electric (current) resistance heating coil (18A) which has a positive electrical charge (18A1) and a negative electrical charge (18A2) from an electricity (9) supply; and, a hydraulically operated needle valve (18B) that allows the flow of disassociated water (13A) into the hydrogen/oxygen production cylinder (20). The electric resistance heating coil (18A) is wrapped by insulation (18C) to preserve the heat generated by the coil (18A). The needle valve (18B) is operated by a hydraulic mechanism (10C) that is controlled by electrically operated solenoid valves (10H) that control the flow of hydraulic fluid (10B) through a hydraulic supply line (10E) and a hydraulic return line (10F). Electricity (9) is supplied to the solenoid valves (10H).

FIG. 6A. is a detail an alternative embodiment of the hydrogen and oxygen production nozzle (18) and hydrogen production cylinder (20) using masers (87) and/or lasers (85) to heat water that is capable of producing thermolysis of water into hydrogen and oxygen for beneficial use. The hydrogen and oxygen production nozzle (18) uses masers (87), which produce sound waves to heat the pressurized water (14D) by sending sound waves through the pressurized water (14D), causing the molecules of the water to gain thermal energy by excitement of the atoms, until it becomes disassociated water (13A) that is diffused into a low-pressure, high temperature zone inside the hydrogen and oxygen production cylinder (20) by an electrically controlled solenoid valve (10H). Lasers (85) could also be used in this application by directing a laser (85) beam onto the metal housing of the nozzle (18) to heat the water (14) within the metal tubing by conduction of heat through the metal. The disassociated water (13A) transforms from the liquid state to the gaseous state and becomes hydrogen/oxygen plasma (38).

The hydrogen and oxygen plasma (38) is diffused into the center of the hydrogen and oxygen production cylinder (20) having a hydrogen permeable membrane (19) inside the cylinder (20) and having an outer-most casing (20A), creating an annular area (20B) between the casing and the outside of hydrogen permeable membrane (19). A hydrogen vacuum pump (21) creates a vacuum in the annular area (20B) outside the membrane that sucks or draws hydrogen through the hydrogen permeable membrane (19) to the outside of the membrane and compresses the hydrogen into a hydrogen storage tank (11), a hydrogen fuel cell (5) or a hydrogen battery (58). A hydrogen vacuum pump (21) operates at high-negative-pressure and creates a substantial vacuum to aid the hydrogen to pass through the hydrogen permeable membrane (19) and the hydrogen vacuum pump (21) compresses hydrogen into a hydrogen storage tank (11) a hydrogen fuel cell (5) or a hydrogen and oxygen battery (58) with high-positive-pressure. An oxygen vacuum pump (21A) creates a vacuum (low-negative-pressure) in the center of the hydrogen permeable membrane (19) to help thermolysis to take place by lowering the pressure within the center of the membrane (19). Oxygen, which cannot pass through the hydrogen permeable membrane (19), is drawn through the center of the membrane (19) by the oxygen vacuum pump (21A) and is compressed at low-positive-pressure into a oxygen storage tank (12), a hydrogen fuel cell (5) to operate the fuel cell (5) or is compressed into a hydrogen and oxygen battery (58) to charge the battery with hot oxygen gas. The oxygen vacuum pump (21A) operates at lower vacuum pressure than the vacuum pressure of the hydrogen vacuum pump (21); and, the differential pressure, with lower pressure being outside of the hydrogen permeable membrane (19) than inside the membrane (19), aids in the passage of hydrogen through the membrane (19).

FIG. 7. is a detail of the apparatus for multiplication of hydraulic force (10) of FIG. 1. Multiplication of hydraulic force is accomplished by exchanging distance for force according to Pascal's Law which states that a force exerts an equal pressure in all directions. The force is transferred from a long, small diameter cylinder and piston (10C) of one-inch diameter by hydraulic fluid (10B), in this case water, to a short, large diameter cylinder and piston (10D) that is three inches in diameter. The multiplication of force is measured by the difference in the area of the two cylinders. The area of the short, large diameter cylinder and piston (10D) is over seven times as great as the area of the long, small diameter cylinder and piston (10C). The hydraulic pump (10A) is capable of developing 2,000 p.s.i. pressure, which is exerted on the long, one-inch diameter piston (10C) and results in pressure of over seven times (14,000 p.s.i.) being exerted by the short, three-inch diameter piston (10D). The extreme pressure thus generated by multiplication of hydraulic force is used to force (pump) pressurized water (14D) into the thermolysis coil (13).

In the embodiment two sets of cylinders and pistons are arranged in such a manner that one piston is pumping water during the period of time that the opposite cylinder is being refilled with water. The arrangement of the two pairs of cylinders and pistons forms an end-to-end mirror image of the other pair of cylinders and pistons. The two pairs of pistons are connected by rods to each other such that the two small diameter pistons (10C1 and 10C2) are connected by a rod (10J) and the two large diameter pistons (10D1 and 10D2) are connected by a rod (10K). Electrically controlled solenoid valves (10H1 and 10H2)) accomplish the switching of hydraulic flows back and forth between the cylinders. Water (14) is forced into one of the long, one-inch diameter cylinders (10C1) forcing its piston forward which forces the three-inch piston (10D1) forward with multiplied hydraulic force to pump pressurized water (14D) into the thermolysis coil. A rod (10J) connects piston (10C1) to the other long, one-inch diameter piston (10C2) and as piston (10C1) moves forward, it pushes piston (10C2) backwards. The hydraulic fluid (10B), which is water (14), in the cylinder of (10C2) is forced out by piston (10C2) through the hydraulic supply line (10E) and through a high pressure check valve (101), that only allows the water to flow in the forward direction; and, the hydraulic fluid (10B) flows into cylinder (10D2). As piston (10C1) moves forward it forces piston (10D1) to also move forward with greater hydraulic force. Piston (10D1) is connected to piston (10D2) by a rod (10K) which forces (pulls) piston (10D2) backwards as piston (10D1) moves forward. The hydraulic fluid (10B), which is water (14), being displaced by piston (10C2) as piston (10C2) moves back is allowed to fill cylinder (10D2) as piston (10D2) moves back making space available in cylinder (10D2) for the hydraulic fluid (10B)/water (14).

Solenoid valve (10H1) closes off the supply of hydraulic fluid to cylinder (10C1) and solenoid valve (10H2) opens the supply of hydraulic fluid to cylinder (10C2) and the process is reversed. Piston (10C2) moves forward and the rod (10J) pushes piston (10C1) back and the hydraulic fluid (10B)/water (14) in cylinder (10C1) is forced back and flows through the check valve (1011) and refills cylinder (10D1). As piston (10C2) moves forward, it forces piston (10D2) forward with multiplied hydraulic force and water (14D) is pumped under high pressure into the thermolysis coil (13). The high-pressure water (14D) cannot return back past the check valve (101) because the valve only allows the water to go in one direction. The flow of hydraulic fluid (10B)/water (14) continues to be switched back and forth between solenoid valve (10H1) and solenoid valve (10H2) and continuous pumping of water (14D) under the high-pressure of hydraulic multiplication into the thermolysis coil (13) occurs.

FIG. 8. is a cross sectional view of a test unit that can be constructed to help prove the concept of the invention of the hydrogen thermolysis reactor (1). A vessel is formed with a steel pipe casing (30) rated at 10,000 p.s.i. pressure. A bolted flange (30 A) is made of steel of the same rating that opens to insert a sheet of weaker metal (28) inside the flange (30A). The vessel is filled half-full of water (14) and is heated by an oxygen/acetylene blowtorch (29) from the bottom of the vessel. Pressure builds from steam (41) that forms over the water (14). As the water (14) becomes hotter (gains thermal energy), the weaker material (28) will eventually rupture from the pressure of the steam (41). The time of rupture should be after the water (14) within the vessel has begun to disassociate into hydrogen and oxygen in the liquid state. A stronger pop-off metal (28) can be used if necessary to allow for greater heating of the water (14) within the vessel (30). The rupture of the weaker material (28) will allow the steam (41) pressure to be released and allow the disassociated water (13A) to become atomic hydrogen and oxygen. The disassociated water (13A) is directed through pipes that are aimed back at the pipe vessel (30) to a hydrogen thermolysis diffuser nozzle (15) consisting of an electric resistance (current) heating coil (15A) and an electric arc (15C). The disassociated water (13A) becomes hydrogen and oxygen fuel plasma (38) after passing through the electric heating coil (15A) and is further heated and ignited by the electric arc with the burning hydrogen and oxygen (27) flame being focused on the pipe vessel (30). The oxygen/acetylene blowtorch can be turned off and the unit will continue to be heated and disassociate the water (13A) inside the vessel (30) and will continue to burn the resulting hydrogen and oxygen plasma (38) as fuel (a self-sustained reaction is maintained) until the disassociated water (13A) is all consumed. In the embodiment of the present invention the water (14) is continuously supplied by hydraulic pumping (10A) to complete the process. However, the test unit will demonstrate that under the embodiment of the present invention, water (14) will burn as hydrogen and oxygen fuel plasma (38) and will create a self-sustained reaction.

FIG. 9. is a cross sectional view of a piston driven hydraulic engine (10) using hydraulic multiplication to generate greater power. The description is the same as in FIG. 7. except that more pairs of pistons are involved and crank shafts (42) are driven with the aid of cams (44) on the crankshafts to create rotation of the crank shafts (42). The small diameter cylinders and pistons (10C) and large diameter cylinders and pistons (10D) are arranged in mirror image pairs and small diameter pistons (10C) work together to drive the large diameter pistons (10D) forward with multiplied hydraulic force, except that the large diameter pistons (10D) rotate crank shafts (42) with the aid of cams (44) instead of pumping water (14) as in FIG. 7.

Any number of pairs of cylinders and pistons may be used. FIG. 9. uses four pair, each pair consisting on two small diameter cylinders and pistons (10C) and two large diameter cylinders and pistons (10D). In each pair the two small diameter pistons (10C) are connected to each other by a rod (10J) and the two large diameter cylinders and pistons (10D) are connected by a rod (10K). The two small diameter cylinders (10C) of each pair are supplied hydraulic fluid (10B) by electrically controlled solenoid valves (10H) that drive the small diameter pistons (10C) forward creating a multiplied force being exerted by the large diameter pistons (10D) as explained in FIG. 7. When a piston (10C) is pulled back by supplying hydraulic fluid to the opposite piston (10C), a solenoid valve (10H) must open to allow the hydraulic fluid in cylinder (10C) to return through the hydraulic return lines (10F) back to the hydraulic fluid (10B) reservoir/water reservoir (14C). The large diameter pistons (10D) are connected to rods (10L) that are connected to cams (44) on the crank shafts (42) that create rotary motion of the crank shafts (42).

The supply of hydraulic fluid (10B) to pistons (10C) via the electrically operated solenoid valves (10H) must be timed by a computer control system (47), much like an electronic ignition system on a conventional automobile, so that the pistons (10C) are in the appropriate positions to push the cams (44) downward and to rotate the crank shafts (42); and, likewise, the solenoid valves (10H) must open at the proper time to allow the hydraulic fluid (10B) to return to the hydraulic reservoir (14C) when the pistons (10C) are returning to the start position.

In FIG. 9. two crank shafts (42) are driven by the hydraulic engine (10) and operate (power) all four wheels (50) of a four wheel (50) drive vehicle for greater traction and power. The multiplication of hydraulic force of FIG. 9. allows for the construction of a very powerful hydraulic engine (10), as any needed power can be obtained via the multiplication of hydraulic force.

The hydraulic engine (10) of FIG. 9. is powered by a hydrogen thermolysis reactor (1) of the design of FIG. 1. and any or all associated components and hardware as used in FIG. 1. are assumed to be used in the hydraulic engine (10) of FIG. 9. if needed.

FIG. 10. is a cross sectional view of a hydrogen thermolysis powered, hybrid hydraulic engine/steam engine using hydraulic multiplication to generate greater power. In FIG. 10. a hydrogen thermolysis reactor (1) is configured to operate by producing steam (41) to drive a piston within a cylinder (10C) that is hydraulically connected to a larger piston within a larger cylinder (10D) capable of multiplying the force of the steam (41) applied to the smaller piston (10C) by hydraulic multiplication of force. Steam (41) is capable of traveling at faster speeds than hydraulic fluid (10B), but generally is not capable of delivering as much power as hydraulic systems. Using the combination of high speed steam (41) under pressure and hydraulic force multiplication (10), an engine generating greater power and quickness of response is possible.

Water (14) is pumped by a water pump (140) that withdraws water from a reservoir (14C) into a steam generating coil (40), which is a heat exchanger that runs through the burning core of the hydrogen thermolysis reactor (1) that receives heat (thermal energy) from the reactor (1) . Steam (41) is generated within the coil (40) and is delivered to a steam engine using multiplication of hydraulic force of the design as herein described in FIG. 10. The hot exhaust gases (36) of the thermolysis reactor (1) are added to the steam and the exhaust gases (36) are cooled in the process and the steam (41) is further heated, gaining additional thermal energy.

Steam (41) force is applied to a long, small diameter cylinder with a small diameter piston (10C) and the force of the steam (41) is transferred to a large diameter piston (10D) through hydraulic fluid (10B) that fills the cylinder space between the two pistons. The force exerted by the large diameter piston (10D) is multiplied by the difference in area between the two cylinders and is much greater than the force exerted by the steam (41). The piston (10D) is connected by a rod (42A) to a cam (44) on a crank shaft (42) creating rotary motion of the crank shaft (42). The flow of steam (41) to the small diameter cylinders (10C) is controlled by electrically operated solenoid valves (10H). The solenoid valves (10H) also open to allow the spent steam (41) to exit the cylinder as the piston (10C) returns to its start position. The timing of the opening and closing of the solenoid valves is controlled by a computer control unit (47) and a battery (51) is needed to supply electricity (9) for start-up.

The hybrid steam/hydraulic engine has two crank shafts (42) that have output shafts (25) on each end. An electric generator (26) that is capable of producing electricity (9) is connected to the right end of the upper crank shaft (42); and, a hydraulic pump (10A) is connected to the left end of the upper crank shaft (42). The hydraulic pump (10A) pumps hydraulic fluid (10B), which is water (14), into a long, small diameter cylinder and piston (10C) that exerts force through hydraulic fluid (10B) to a short, large diameter cylinder and piston (10D) that pumps pressurized water (14D) into the thermolysis coil (13) under intense pressure by the use of hydraulic multiplication. The pressurized water (14D) in the thermolysis coil (13) flows into the core of the reactor (1) and becomes disassociated water (13A) that is diffused into the reactor (1) through the thermolysis diffuser nozzles (15) and is burned as fuel in the reactor (1).

A water pump (14B) to supply water to the steam generating coil (40) is connected to the lower left hand side of the crank shaft (42); and, the right side of the lower crank shaft (42) drives the transmission (35) that powers the vehicle, etc. The water pump (14B) provides water for the steam coil (40) and the water-jacket cooling system (16) that flows around and cools the thermolysis reactor (1) and cools and drives the thermolysis diffuser nozzle vacuum turbine (15D). The spent water from the water-jacket passes through a radiator (48) that is cooled by cool air (32) drawn in by a fan (34) that blows out hot air (33). The spent steam (41) and thermolysis reactor (1) exhaust gases (36) also pass through the radiator (48) and are cooled. Condensation from the radiator (48) goes to the water reservoir (14C) to be recycled in the system.

Water (14) can be added to the reservoir (14C) through a water fill inlet cap (39). A low-water alarm (43) warns of the need to add water (14) and a pressure release valve (45) releases excess pressure that accumulates in the system. A drain plug (49) allows the reservoir (14C) to be drained for clean-out.

A portion of the disassociated water (13A) goes to the hydrogen/oxygen production nozzle (18) and cylinder (20) to be separated into hydrogen and oxygen and stored in hydrogen storage tanks (11) and oxygen storage tanks (12) for use as starter fuel to begin the hydrogen thermolysis process or to be used otherwise.

FIG. 11. is cross sectional view of a hydrogen thermolysis reactor (1), fuel cell (5) and electric drive motor (37) vehicle power unit. Aspects of the drawing dealing with components of the hydrogen thermolysis reactor (1) are the same as in FIG. 10. This configuration employs a fuel cell (5) that burns oxygen and hydrogen produced by the reactor (1) to produce electricity (9) that operates an electric drive motor (37). The electric motor (37) uses a transmission (35) to transfer power to the vehicle. The water-jacket coolant pump (14B), fan (34), and hydraulic pump (10A) are all operated by electricity (9) produced by the fuel cell (5). Water from the fuel cell (5) goes to the reservoir (14C) to be recycled into the system. A battery (51) along with a computer control unit (47) are used for start-up to open the oxygen supply valve (128) and hydrogen supply valve (11B) to supply hydrogen and oxygen to the fuel cell (5) to begin the production of electricity (9). The electricity (9) will then drive the other components of the power unit and recharge the battery (51).

FIG. 12. is a cross sectional view of a hydrogen thermolysis reactor (1) combustion engine (4) vehicle power unit. Aspects of the drawing dealing with the hydrogen thermolysis reactor (1) are the same as in FIGS. 10 and 11. This configuration employs a combustion engine (4) that directly burns hydrogen produced by the reactor (1). The combustion engine (4) drives an electric generator (26) that runs the other components of the power unit once the engine (4) is cranked by use of a battery (51) and computer control unit (47).

FIG. 13. is a lighter-than-air airplane (79)/spaceship (80). Hot air is blown into the wing of the airplane (79) by jet propulsion engines (6) of the type detailed in FIG. 15. The jet propulsion engines (6), used as downward thrusters, create a downward thrust creating further lift for the airplane; and, the third form of lift is created by air motion over the air foil (57). Hot air is allowed to build-up in the air foil creating lift and exerting an outward pressure on the surfaces of the air foil (57) which helps to offset the air pressure exerted against the outside of the air foil (57) due to forward motion. The airplane (79)/spaceship (80) of the present invention is designed for vertical lift-off and does not require a runway. Hot air is injected into the wings by the jet propulsion engines (6), thrusters, which are directed in a downward direction causing upward lift. Four jet propulsion engines (6) used as downward thrusters located in the four corners of the wing (57) are controlled by a gyroscope leveling device (88) that keeps the airplane (79) level during lift-off and during flight. Once the airplane (79) is airborne, the jet propulsion engines (6) in the rear of the wing begin to operate thrusting the airplane (79)/spaceship (80) forward.

During take-off the amount of water (14) on board the airplane (79)/spaceship (80) that is the fuel needed by the jet propulsion engines (6) is minimal to conserve weight. Once in flight the airplane (79)/spaceship (80) acquires the water (14) needed for thermolysis from moisture in the atmosphere using an air liquidification (68) and refrigeration (67) process as explained in FIG. 15. Water (14) can be produced at a very great rate under ideal atmospheric conditions and can be stored. Space within the wings (57) that was needed to provide hot air space during lift-off may be filled with stored water (14). The lift provided by the motion of air over the wing (57) can replace the lift lost by filling the wings with water (14).

The airplane (79)/spaceship (80) is designed to be capable of flying beyond the earth's atmosphere and therefore will need a large supply of water as fuel after the airplane can no longer get fuel, water (14), from water vapor in the atmosphere. It is capable of doing so because of the oxygen contained in the water (14) that is transformed into fuel plasma (38) of the present invention allowing the engines to operate in outer space as where conventional jet engines are not capable of doing so. The jet turbine engines (6) are equipped with a hydraulically adjustable rocket nozzle (84) to control the exit velocity (thrust) of the hot exhaust gases (36) created by the jet propulsion engines (6) for more efficient use in space and to steer the airplane (79)/spaceship (80) in space.

The oxygen contained in the water (14) also provides the oxygen life support needed by the crew and passengers of the airplane (79)/spaceship (80). Therefore, the range of the airplane's (79)/spaceship's (80) flight into outer space is largely limited by the amount of water onboard. The majority of the internal area within the wing (57) may be filled with water once the airplane (79)/spaceship (80) is in flight due to the lift provided by motion of air over the air foil (57) creating lift and by use of the downward rocket thrusters that can provide any additional lift required to maintain altitude. The range can be extended by capturing and recycling the water (14) fuel in space by use of an air bag (83) that would be deployed in space to surround the jet propulsion engines (6) to capture the propellant (1C) discharged from the engines (6) which will cool and condense into water ( 4) again for reuse. In such event, the amount of oxygen onboard and the amount of food available become limiting factors to the time allowed in space, which could be considerable. Large quantities of oxygen can be produced by the air liquidification unit (68) and can be stored in liquid form. Oxygen producing life forms such as plants and micro-algae can also be employed to provide both food and oxygen once in space. Sunlight can enter the wing's (57) tanks that are filled with water (14) and micro-algae would flourish within them from the continuous sunlight available in space and large quantities of oxygen would occur. Over eighty-percent of the oxygen in earth's atmosphere is derived from micro-algae in the oceans and it is dark half of the time, stopping micro-algae oxygen production.

Ceramic heat tiles (89) are provided on the underside of the airplane (79)/spaceship (80) for reentry into the earth's atmosphere.

FIG. 14. is a top view, cross sectional side view, and front view of a hydrogen thermolysis reactor (1) powered boat (62) with air-foil (57) heaters (63), creating a lighter-than-air boat (62). The hull consists of two hulls in a catamaran configuration and a large air-foil (57) that spans between and above the hulls. The air-foil (57) is equipped with a heater (63) that is a hydrogen thermolysis reactor (1) emitting hot exhaust gases (36) into the annular space (65)within the air-foil (57) creating lift like a hot-air balloon. Additional lift is created by having the hot exhaust gases exit the air-foil (57) in a downward direction, pushing upwards on the air-foil (57). The air-foil (57) is connected to the boat (62) by support struts (61) extending up from the boat hulls (62A) and (62B) to the air-foil (57) holding the air-foil (57) in place above the boat (62). The boat hulls (62) and the rigid air-foil (57) are constructed of lightweight, strong materials, such as aluminum titanium alloy. A forward walkway (60B) and a rear walkway (60B) are provided to allow access from hull (62A) to hull (62B). The walkways (60) aid in the structural strength of the ship (62).

The boat (62) is powered by four propulsion units; two jet propulsion engines (6) mounted on the rear struts (61) with one engine (6) over each hull and two hydro-jet propulsion engines (8) with one engine in the stern of each hull. All four engines are used during take-off. As the boat (62) moves forward, additional lift will be generated by the motion of air over the air-foil (57), acting like a normal airplane wing. The additional lift will cause the draft of the boat (62) to decrease to such an extent that the hydro-jet propulsion engines (8) can no longer withdraw sufficient water to function and will be shut-off. The jet-propulsion engines (6) have adequate thrust to continue acceleration and to keep the boat (62) on the surface of the water. Additional acceleration of the boat (62) also generates more lift by the air-foil (57). The boat (62) could very easily be designed to fly if desired. However, the boat (62) herein is provided with hydraulically adjustable front support struts (61A) to change the pitch of the nose of the wing (57) downward to prevent the ship (62) from leaving the surface of the water. A hydraulically operated rudder (64) is attached to each rear strut (61B) to help steer the boat (62). The ship can achieve speeds approaching the speeds of jet aircraft and can carry much larger loads of passengers or cargos due to the dual lifts of hot air and the motion of air over the air-foil (57). It is believed by the inventor that there is greater safety by remaining on the water in case of engine malfunction, etc.

The overall design of the ship (62) creates stability in water (14). It is as wide as it is long and covers a very large surface area that causes wave energy to be averaged across the entire vessel. Also, the lift from the wing (57) during forward motion moderates the up and down motion of seas as it prevents the ship (62) from falling rapidly should the crest of a large wave pass. The vessel is partly supported by water via the hulls (62) and partly supported by air by the air-foil (57) and the downward thrust of hot-air from the heater jet turbine (63) inside the wing (62). This dynamic balance creates greater stability of the ship (62).

With the ship (62) standing still and with hot air being blown into the air-foil (57) by the heater turbine (63), which creates a downward thrust that causes further lift, and with no cargo on board, the ship (62) is designed to be capable of lifting-off the water (14) by the lighter-than-air lift created by the hot air and downward thrust. This has the advantage of allowing the ship (62) to float over land for docking and repair purposes and to store it out of water to prevent bio-fouling. The amount of surface area and the thickness of the air-foil (57) are designed to provide adequate square footage to provide sufficient hot-air lift for lighter-than-air operation. The downward thrust by the heater turbine (63) creates further lift and provides power for maneuverability.

FIG. 15. is a cross sectional detail of the hydrogen thermolysis powered jet propulsion unit of FIG. 14. A compressor turbine (54) compresses air into and around the hydrogen thermolysis reactor (1) which is mixed with the extremely hot exhaust gases (36) of the reactor (1), which heats and causes the air to expand. Liquid nitrogen (66) is added to the mixture of hot exhaust gases (36) and expanded air to further cool the mixture and to add propellant (1C). The liquid nitrogen (66) will expand approximately 1000 times to become gaseous and the gas will expand further as hot gas. The nitrogen will cool the mixture so that the metallurgy of the turbine is not harmed and so that a greater quantity of hydrogen and oxygen can be burned in the hydrogen thermolysis reactor; and, the nitrogen will significantly increase the volume of propellant. The propellant (1C) will exit the power turbine (24) causing rotary motion of the power turbine (24) as the propellant (1C) applies force against the vanes of the turbine (24) as the propellant (1C) expands outward.

A refrigeration (67) and air liquidification (68) apparatus as detailed in FIG. 24. creates water (14) and liquid nitrogen (66), liquid oxygen (69), and liquid rare gases (70), such as argon, helium, etc. The atmosphere is compressed by an air compressor (71) and cooled by liquid nitrogen (66) and changes state from a gas to a liquid as the molecules slow down and become closer to together by cooling and compression. Heat is given off by the process. The resulting liquid is super-cold. The liquids are separated in a separation tower (73) as the liquids separate according to their specific gravity and are withdrawn from the tower (73) in the proper area corresponding the liquid desired to be withdrawn. For the present use, however, it is not absolutely necessary to separate the liquids although it may be desirable.

A portion of the nitrogen (66) and oxygen (69) are used in a refrigeration cycle (67) to produce water. The liquid nitrogen (66) accounts for 80% of the liquid produced and is the liquid of greatest quantity, if separated. The liquid nitrogen (66) flows through a heat exchange coil (72) and an electrically operated fan (34) blows air over the coil (72) and water (14) is removed from the air by condensation. The more humid and hot the air, the better the results. Cold, dry air produces the poorest results. Even cold dry air will produce significant water (14) in a refrigeration cycle as proposed.

Rare gases in the atmosphere such as argon and helium are valuable enough to retain for use or to sell.

The remaining liquid nitrogen (66) and liquid oxygen (69) are injected into the jet propulsion engine (6) to cool the hot exhaust gases (36) of the hydrogen thermolysis reactor (1) and to provide additional propellant (1C) to drive the power turbine (24), which allows more hydrogen and oxygen to be burned in the reactor (1). The liquid nitrogen (66) may also be used to cool the thermolysis diffuser nozzles (15) of the reactor (1) and to drive and cool the diffuser nozzle vacuum turbine (15D).

FIG. 16. is a cross sectional detail of the hydrogen thermolysis reactor (1) powered hybrid gas-fired turbine/steam turbine (17) with a hydro-jet propulsion (8) attachment as used in FIG. 14. A standard hydrogen thermolysis reactor (1) and hybrid gas-fired turbine engine/steam turbine engine (17) of FIG. 1. (the preferred embodiment of the invention) is used in this embodiment with the addition of an attached hydro-compressor turbine (54) to create a hydro-jet propulsion unit (8). The hybrid turbine engine (17) and the hydro-jet propulsion unit (8) are connected together by a set of gears: a drive gear (74) that is powered by the hybrid turbine engine (17) and a clutch gear (75) that engages the jet propulsion gear (76). Rotary motion of the drive gear (74) is transferred to the jet propulsion gear (76) by the clutch gear (75), which also allows the drive gear (74) and jet propulsion gear (76) to be disconnected.

Water (14) from the sea is drawn into the compressor turbine (54) and is compressed and passed through a jet nozzle (77) to form a jet of water exiting the hydro-jet propulsion unit (8) The backward jet action of the hydro-jet propulsion unit (8) causes an equal and opposite reaction and drives the boat (62) forward.

Water (14) needed by the hydrogen thermolysis reactor (1) is obtained by a water pick-up tube (78) located below the hull of the boat and is stored in a water reservoir (14C). Water (14) is forced into the pick-up tube (78) by the forward motion of the boat (62) and can be pumped (10A) if the boat (62) is not moving.

FIG. 17. is a hydrogen battery (58A) and a hydrogen and oxygen battery (58) consisting of carbon 60/platinum alloy (104). Carbon 60 molecules, known as “buckyballs” after Buckminster Fuller, are carbon molecules that consist of 60 carbon atoms linked together to form an almost spherical ball with the chemical formula C60. The solid form is known as fullerite, which is transparent yellow with its molecules stacked together like a pile of cannon balls. Atoms of different elements can be placed inside the molecular cage formed by the carbon atoms, producing a “shrink wrapped” version of these elements. Large quantities of hydrogen can readily be forced inside carbon 60 atoms by low heat and pressure, creating a solid-state hydrocarbon material.

An alloy made of fullerite (solid carbon 60) and of platinum (104) creates a material with electrochemical properties not present in carbon 60 alone The platinum acts as a catalyst that helps to convert the hydrogen gas into electrons and photons (hydrogen ions). A portion of the electrons can move across a hydrogen ion permeable membrane (107) to react with oxygen and electrons on the cathode (100) side of the battery (58A) with the aid of a platinum catalyst and water (14) will be formed. Electrons that cannot cross through the membrane can flow from the anode (99) to the cathode (100) through an external circuit having an electrical load such as a motor (37). The hydrogen battery (58A) of the present invention works on the same electrochemical principals in which a fuel cell (5) works. The improvement of the present invention over that of a fuel cell (5) is that substantial hydrogen is stored for use within the battery; and, the battery (58) is ready to deliver electricity (9) immediately without a supply of hydrogen being needed. A small fan run by the battery (58A) is required to blow air containing oxygen across the cathode (100) of the hydrogen battery (58A) for the hydrogen battery (58A) to operate.

An alternate embodiment of the present invention is a hydrogen and oxygen battery (58), which embeds oxygen within the carbon 60/platinum alloy (104) on the cathode (100) side and the oxygen will be stored in the battery (58) along with the hydrogen. An electrical current (9) will occur when a load completes the circuit. This would make the battery (58) almost twice as large as a hydrogen battery (58A) but would eliminate the need for a fan to provide oxygen and the electrical current (9) that the fan consumes. The hydrogen and oxygen battery (58) is still very light as carbon 60 and hydrogen and oxygen are all extremely lightweight elements. Platinum is the only heavy material used in the construction of the battery and it is present in only a very small quantity. The lightweight powerful hydrogen and oxygen battery (58) of the present invention is a vast improvement over prior art heavy batteries.

The battery consists of carbon 60/platinum alloy (104) sheets with thin ion conductive plates (106) embedded at the center of each sheet. The ion conductive plates (106) connect to the anode (99) or cathode (100) corresponding to the side of the hydrogen and oxygen battery (58) on which the ion conductive plates (106) are on. An air space is provided between each layer of carbon 60/platinum alloy (106) to allow hydrogen or oxygen to penetrate between the layers when the hydrogen and oxygen battery (58) is being charged with hot pressurized gases through a hydrogen fill valve (102) or an oxygen fill valve (103). The embodiment of the oxygen side of the battery (58) is identical to the embodiment that is used for hydrogen side of the battery (58). The only difference being that each side of the battery (58) is charged with a different gas. Heat produced during operation of the battery (58) will release additional hydrogen and oxygen from the carbon 60/platinum alloy (104) and greater quantities of heat will be produced by greater electrical loads. The pressure and temperature of charging the battery (58) must remain below the pressures and temperatures that would result in a chemical reaction occurring between the hydrogen and carbon that would form hydrocarbons or a chemical reaction occurring between the oxygen and carbon that would form carbides.

FIG. 18. is a cross section view of a submarine (52) powered by a hydrogen thermolysis reactor (1) using a hydrojet propulsion attachment (8). An end view of both the front end and rear end of the submarine are included. Water (14) is sucked into the submarine at its nose by a compressor turbine (54) and is forced into heat exchange tubes (53) that run longitudinally through the center of the submarine (52). The water (14) passes through the heat exchange tubes (53) and heat (thermal energy) is applied to the tubes (53), which is transfer to the water, (14) by the reactor (1) that directs it burning core onto the heat exchange tubes (53). The water (14) within the tubes transforms into the gaseous state and becomes steam (41). The steam (41) the tubes (53) at the inlet nozzle of a power turbine (24) and causes rotary motion of the power turbine (24) as the steam (41) applies force against the vanes of the power turbine (24) as it expands as it passes through the turbine. The power turbine (24) is connected to a central drive shaft (55) that runs longitudinally through the submarine (52) and connects to a clutch/gear box (56) located forward of the hydrogen thermolysis reactors (1). The shaft (55) continues on the other side of the clutch/gear box (56) and is connected to the gear box (56) and continues to connect to and to drive the compressor turbine (54) at the nose of the submarine. The central shaft (55) runs the entire length of the submarine and connects the power turbine (24), clutch/gear box (56) and compressor turbine (54) together. The nose compressor turbine (54) significantly reduces the resistance to forward motion of the submarine (52) by creating a suction by the intake of water in the present invention instead of having nose compression resistance in a normal prior art submarine.

The clutch/gear box (56) allows power to be taken off from the central shaft (55) to be used within the submarine for other power needs such as the production of electricity (9). The clutch portion of the clutch/gear box (56) allows the compressor turbine (54) to be disconnected from the power turbine (24) for start-up purposes as the compressor turbine (54) will take a great deal of energy to operate. The compressor turbine (54) can be temporary operated by electric motors (37) until the power turbine (24) reaches critical operating momentum. Once the power turbine (24) has reached full power, the compressor turbine (54) can be activated by the clutch/gear box (56). The electric motors (37) with the aide of the clutch/gear box (56) and a fuel cell (5) to provide electricity (9) can drive the power turbine (24) and/or compressor turbine (54) to power the submarine (52) for purposes of slower, silent and cooler (minimal sound and heat signature for detection) running.

Oxygen and hydrogen produced from water (14) by the hydrogen thermolysis reactor (1) are stored for future use, especially start-up of the reactor (1), which requires for oxygen and hydrogen to be burned in the reactor (1) until the critical operating temperature is reached and thermolysis has begun. Oxygen may be used by the crew of the submarine for life support.

FIG. 18A. is a detail of the hydrogen thermolysis diffuser nozzles (15) that heat the heat exchange steam tubes (53) and convert the water into steam (41). The steam tubes (53) and the hydrogen thermolysis nozzles (15) run longitudinally through the center of the submarine (52). The hydrogen thermolysis nozzles (15) convert water into hydrogen and oxygen that are combusted and heat from the combustion is directed onto the steam tubes (53); and, steam is generated. The steam tubes (53) surround the central shaft (55) and prevent the heat of the thermolysis nozzles (15) from reaching the shaft (55). The steam tubes (53) also surround the thermolysis nozzles (15) to remove heat for steam (41) production and to keep the area of the submarine (52) beyond the thermolysis nozzles (15) from becoming heated excessively.

FIG. 19. is an alternate embodiment of a hydrogen thermolysis reactor (1) powered submarine (52) that uses the hydro-jet propulsion attachment (8) detailed in FIG. 16. In this embodiment water (14) is withdrawn from the ocean at the nose of the submarine (52) to break-up the water nose compression that causes resistance to forward motion of the submarine (52). The water (14) travels longitudinally through the center of the submarine (52) until it reaches the hydro-jet compressor turbine (54) and exits as a hydro-jet flow of water (14) through the variable outlet nozzle (81) and then through the hydro-jet nozzle (77) which propels the submarine (52) forward. The hydro-jet nozzle (77) aids in steering the submarine (52) by directing the hydro-jet nozzle (77) in the opposite direction to which a turn is desired.

FIG. 20. is a detail of the two hydrogen thermolysis reactors (1) and the compressor turbine (54) that are used in a configuration in which the two reactors (1) are mirror imaged to each other with one reactor (1) one each side of the hydro-jet compressor turbine (54) which provides twice the power to the turbine (54). The jet propellant from the two hydrogen thermolysis reactors (1) also creates substantial thrust for the submarine (52). The reactors (1) must be equipped with check valves (101) to prevent water from entering the reactors (1).

FIG. 21 is a miniature hydrogen diffuser nozzle (15) using masers (87) and lasers (85) for spark plug replacement to retrofit a combustion engine (4) into a hydrogen and oxygen operated combustion engine (4) using a miniaturized embodiment of the hydrogen diffuser nozzle (15) of FIG. 3. The embodiment herein described has the capability to operate a conventional combustion engine (4) as a hydrogen powered vehicle with the electrical charge (9) coming from a vehicles electronic ignition control unit. The vehicle's spark plugs are replaced with diffuser nozzles (15) of this embodiment of the present invention. The vehicle's carburetor is no longer needed and a high pressure hydraulic (water) pump (10A) is the only other component required to make the conversion of a standard combustion engine (4) into a modified hydrogen vehicle of the present invention. The gasoline tank becomes the water reservoir (14C). This embodiment the diffuser nozzle (15) accomplishes thermolysis as a stand alone unit. Pressure to create pressurized water (14D) comes from the hydraulic pump (10A) and the masers (87) heat the water until it becomes disassociated water (13A). The masers must have a separate electric supply and must keep the temperature of the pressurized water (14D) in the diffuser nozzle (15) at such temperature as to remain disassociated water (13A) ready to be used on demand when the electric ignition of the vehicle opens the solenoid valve (10H) and fires the lasers (85) by sending an electrical charge (9) to the diffuser nozzle (15) in place of the spark plug that would have normally received the electrical charge (9) to fire. The diffuser nozzle (15) as herein described is miniaturized to the approximate size of a spark plug.

FIG. 22. is a thermolysis hydrogen and oxygen production nozzle (18) powered fuel cell (5). The embodiment of the hydrogen and oxygen production nozzle as described in FIG. 6A. is used with masers (87) and/or lasers (85) for heating and an electrically operated solenoid valve to diffuse hydrogen and oxygen plasma (38) into the hydrogen and oxygen production cylinder (20) containing a hydrogen permeable membrane (19) that separates the hydrogen from the oxygen and compressing the hydrogen into the fuel cell (5) under high-pressure with a hydrogen vacuum pump/hydrogen compressor (21) and compresses the oxygen into the fuel cell (5) with low-pressure using an oxygen vacuum pump/oxygen compressor (21A). The fuel cell (5) is operated by the hydrogen and oxygen and can operate an electric motor (37) or provide electricity (9) for any other purpose.

FIG. 23 is a thermolysis hydrogen and oxygen production nozzle (18) powered hydrogen and oxygen battery (58). The embodiment uses the hydrogen and oxygen production nozzle of FIG. 6A. and uses masers (87) and/or lasers (85) form heating and an electrically operated solenoid valve to diffuse hydrogen and oxygen plasma (38) into the hydrogen and oxygen production cylinder (20) containing a hydrogen permeable membrane (19) that separates the hydrogen from the oxygen and compressing the hydrogen into the hydrogen and oxygen battery (58) under high-pressure with a hydrogen vacuum pump/hydrogen compressor (21) and compresses the oxygen into the hydrogen battery (58) with low-pressure using an oxygen vacuum pump/oxygen compressor (21A). The battery (58) stores the hydrogen and oxygen within the fullerite (carbon 60)/platinum alloy (104) for future use and is ready to deliver electricity (9) to operate an electric motor (37) or for any other purpose immediately upon demand and will operate until its supply of hydrogen and oxygen is exhausted, at which time it will need to be recharged with hydrogen and oxygen.

FIG. 24. is a detail of the air liquidification (68) and refrigeration (67) apparatus used in FIGS. 13 , 14, and 25. to compress and cool the air in the earth's atmosphere until it changes state from a gas to a liquid and the liquid is used to create water (14) by condensing moisture in the atmosphere.

The refrigeration (67) and air liquidification (68) apparatus creates water (14) and liquid nitrogen (66), liquid oxygen (69), and liquid rare gases (70), such as argon, helium, etc. The atmosphere is compressed by an air compressor (71) and cooled by liquid nitrogen (66) and changes state from a gas to a liquid as the molecules slow down and become closer to together by cooling and compression. Heat is given off by the process. The resulting liquid is super-cold. The liquids are separated in a separation tower (73) as the liquids separate according to their specific gravity and are withdrawn from the tower (73) in the proper area corresponding the liquid desired to be withdrawn. For the present use, however, it is not absolutely necessary to separate the liquids although it may be desirable.

A portion of the nitrogen (66) and oxygen (69) are used in a refrigeration cycle (67) to produce water. The liquid nitrogen (66) accounts for 80% of the liquid produced and is the liquid of greatest quantity, if separated. The liquid nitrogen (66) flows through a heat exchange coil (72) and an electrically operated fan (34) blows air over the coil (72) and water (14) is removed from the air by condensation. The more humid and hot the air, the better the results. Cold, dry air produces the poorest results. Even cold dry air will produce significant water (14) in a refrigeration cycle as proposed. In the alternative the motion of air over an airfoil (95) may replace the fan (34) and provide a flow of air over the coil (72)

Rare gases in the atmosphere such as argon and helium are valuable enough to retain for use or to sell.

The super-cold liquid nitrogen (66) and liquid oxygen (69) may be injected into a jet propulsion engine (6) to cool the hot exhaust gases (36) of the hydrogen thermolysis reactor (1) and to provide additional propellant (1C) to drive the power turbine (24), which allows more hydrogen and oxygen to be burned in the reactor (1). The liquid nitrogen (66) may also be used to cool the thermolysis diffuser nozzles (15) of the reactor (1) and to drive and cool the diffuser nozzle vacuum turbine (15D).

FIG. 25. is a PTV, personal transport vehicle, (112) that is designed as a small (the size of an SUV) sized vehicle for carrying from one to eight passengers. It is designed to operate on the roadways or in the lower atmosphere. The vehicle (112) contains four downward thrusters, which are jet propulsion engines (6) as detailed in FIG. 15. The thrusters (6) inject hot air into an annular area (115) located at the top (roof) of the vehicle (112) to create hot air lift. The PTV (112) operates off of water (14) as a fuel, which is contained in a water reservoir (14C) located below the floor of the vehicle (112). The hot air contained at the roof of the PTV (112) causes upward lift and the water (14) pulling downward due to the force of gravity aid in keeping the PTV (112) in an upright position. The four jet propulsion engines (6) which act as downward thrusters (6) to provide upward thrust (lift) of the vehicle (112) are controlled by a gyroscope (88) computer (47) mechanism that is designed to keep the vehicle (112) level during lift-off and during flight. A large portion of the hot exhaust gases (36) produced by the thrusters (6) that are located inside an annular area (115) within the vehicle (112) is discharged through a hot air vent (116). The rest of the hot air exhaust gases (36) are allowed to rise to the roof and become a pocket of hot air which is vented (116) out the side of the roof.

The wheels (50) are hydraulically operated and retract during flight and may be lowered for on-road operation. The vehicle (12) is also equipped with a landing gear (113) that may be used instead of the wheels for landing on surfaces other than roads. Shock absorbers (111) are located between the personal transport vehicle's (112) body and the landing gear (113) to cushion the impact of touching-down on the landing gear (113) and to prevent damage to the PTV (112) during landing.

The personal transport vehicle (112) is propelled forward and stopped by forward and rearward thrusters (6), which are small jet propulsion engines (6), that are located on each end of the vehicle (112). The engines (6) are maneuverable. Hydraulic control allows the engines (6) to be swiveled from side-to-side by an electric swivel motor (114) in order to steer the vehicle. The rear thruster (6) can maintain forward momentum and can thrust the rear of the vehicle in a direction while the front (6) can push the nose of the vehicle in the opposite direction, creating a turning mechanism of the vehicle. During forward momentum operation of the forward thruster (6) will apply a braking action, thrusting the vehicle rearward and slowing the vehicle down. While operating on the roadways, conventional braking via the wheels will also be available in addition to the reverse thruster.

The vehicle (112) is made of lightweight space age materials and the thrusters are lightweight, small-sized jet propulsion engines (6) designed for the small size and payload of the personal transport vehicle (112).

The PTV (112) uses the air liquidification (68) and refrigeration (67) apparatus detailed in FIG. 24. to obtain water (14) from the atmosphere as fuel for the jet propulsion engines (6) and to cool the passenger compartment of the vehicle (112). Heat for the passenger compartment is obtained from the hot exhaust gases (36) of the thrusters (6).

### DETAILED DESCRIPTION

The invention is so designed as to fully thermally crack water molecules into atomic hydrogen and oxygen atoms. The applicant believes that for the present invention to achieve complete or near total thermolysis of the process water that a heat/ignition process must be employed. In the first step intense pressure, using hydraulic force, is applied to water within a heat-exchange coil “thermolysis coil” (13) located in the center of a hydrogen thermolysis reactor (1). Heat is applied to the water within the coil by the intense temperature of the hydrogen thermolysis reactor. This process of the present invention pre-heats the water. In the preferred embodiment of the present invention extreme pressure of over 10,000 p.s.i. may be achieved through the use of a hydraulic system (10). The internal temperature of the water inside the thermal cracking coil could approach 2,500 deg. F. Such extreme temperature could be obtained by the continuous heating of the coil within the confided area of the hydrogen thermolysis reactor for such duration as it would take to achieve the target temperature. A rocket's engine burns oxygen and hydrogen at temperatures near 5,400 deg. F. and the heat produced by an oxygen/acetylene blowtorch measures 6,300 deg. F. Likewise, the hydrogen thermolysis reactor would be designed to burn hydrogen and oxygen at near these upper limits. Heat this intense directed on the coil for any length of time could readily achieve the target temperature of 2,500 deg. F. of the water inside the thermolysis coil in the design of the present invention. Further heating of the water is achieved by a resistance (current) heat coil (15A) wrapped around the thermolysis diffuser nozzle (15) or masers and/or lasers in which the water is passed through, raising the water temperature to near 5,000 deg. F, prior to injection into a zone of low-pressure within the thermolysis diffuser nozzle created by a vacuum turbine of the hydrogen thermolysis reactor via a hydraulically controlled needle valve (15B) or an electrically operated solenoid valve. At such extreme temperature and pressure most of the water will have already dissociated into atomic hydrogen (H) and atomic oxygen (O) within the liquid state. The final heat and ignition is accomplished by passing the injected water through an electronic arc (15C) that operates at temperatures of up to 90,000 deg. F. or a series of lasers that are capable of temperatures up to one million deg. F. while the fluid is undergoing change to the gaseous state (hydrogen and oxygen fuel plasma) due to the sudden pressure reduction of injection from the high-pressure coil into the zone of negative-pressure. Passing the hydrogen and oxygen through the electric arc or laser beams ignites the fuel plasma and raises the temperature of the resultant gases (perhaps near 10,000 deg. F.) well above the temperature needed for complete thermolysis of the water into hydrogen and oxygen of less than 6,000 deg. F. The vacuum turbine diffuses the burning hydrogen and oxygen into the burning core of the hydrogen thermolysis reactor.

The electric arc (15C) or laser beams are also used to ignite the starter supply of hydrogen and oxygen during startup. The inside of the hydrogen thermolysis reactor (1) is lined with heat shields (1A) made of ceramic materials to insulate the metal housing (1B) of the hydrogen thermolysis reactor from being harmed or melted by the intense heat therein and to help protect the metal from the corrosive effects of hydrogen and water vapor.

Great pressures can be achieved with the use of hydraulic systems (10). An electrically operated hydraulic pump (10A) can produce pressures of up to 9,800 p.s.i. In hydraulic systems it is very easy to multiply forces by trading force for distance. Additional pressure can be achieved by the transfer of mechanical energy through hydraulic fluids (10B) connecting two hydraulic cylinders. Hydraulic fluid is pumped via a hydraulic pump into a long, small diameter cylinder (10C) having a hydraulic ram, representing distance. A short, large diameter cylinder (10D) and ram is connected to the small cylinder by a hydraulic line filled with hydraulic fluid (10A). Mechanical force is transferred to the large diameter cylinder (10D) from the small diameter cylinder (10C) with a force equal to the multiplication of the area of the two cylinders. In the perfect embodiment of the present invention hydraulic force multiplication can generate pressures (beyond 200,000 p.s.i.) exceeding the limits of the metallurgy to contain the hydraulic fluid and far greater than is believed by the applicant to be needed to keep the super-heated water in the liquid state while it is in the thermolysis coil (13). The primary objective of pressure is to keep the water from becoming steam (gaseous state) in the pre-heat process. Partial or complete thermolysis will occur within the thermolysis coil. A hydraulic pump (10A), capable of delivering 9,800 p.s.i, may provide adequate pressure for this purpose without the of multiplying the force of the hydraulic pressure as described herein.

According to the Second Law of Thermodynamics, the extreme heat and pressure of the present invention will cause the water to thermally crack while it remains in a liquid state. The thermally cracked liquid product will be transformed into fuel plasma via a thermolysis diffuser nozzle (15) located at the upper core of the hydrogen thermolysis reactor (1). The intense bound-up thermal energy contained in the plasma due to the extreme temperatures and pressures applied to it will cause the atomic hydrogen (H) and atomic oxygen (0) to rapidly diffuse apart as the potential energy contained within the atoms of hydrogen and oxygen is transformed into kinetic of motion as the pressure rapidly drops during the injection process of the fuel plasma into a zone of negative-pressure in the thermolysis diffuser nozzle. just prior to injection greater thermal energy is imparted to the water via an electrical resistance current (15A) or masers and/or lasers, and after injection through a hydraulically controlled needle valve (15B) or electrically operated solenoid valve, the fuel plasma while diffusing into low-pressure is passed through an electric arc (15C) or series of lasers, which further adds thermal energy to the fuel plasma as it ignites the fuel plasma, resulting in still further heat (thermal energy) being made available to the process. The burning hydrogen and oxygen is diffused into the hydrogen thermolysis reactor's core where the temperature may be as high as 10,000 deg. F., being near equal to the normal operating temperature of a nuclear reactor.

The apparatus is designed to overcome the “rapid back reaction” by igniting the superheated fluid (hydrogen and oxygen fuel plasma) as it becomes gaseous in a vacuum and as further heat is applied. While the liquid is being transformed into the gaseous state via rapid pressure reduction, it passes through an electronic arc (15C) or laser beams that ignites the atomic hydrogen and atomic oxygen (fuel plasma) simultaneous with its generation into gases and while heat from the arc (15C) or laser beams is added to the fuel plasma. The fuel plasma has no opportunity to reunite into steam as no cooling (the fuel plasma actually becomes hotter due to the intense heat of the arc, 15C, which produces a temperature approaching 90,000 deg. F. or laser heat which is capable of temperatures up to one million deg. F.) or mixing with other gases takes place as it enters the low-pressure, high temperature zone within the hydrogen thermolysis diffuser nozzle and is diffused into the burning core of the hydrogen thermolysis reactor. The thermolysis diffuser nozzle (15) utilizes a hydraulically operated, water-cooled vacuum turbine (15D) to create a vacuum within the end of the nozzle to further enhance the process. Dissociation of water into hydrogen and oxygen is a function of high-temperature and low-pressure. The lower the pressure the greater the dissociation of water into hydrogen and oxygen. However, due to the enormous heat of the superheated, disassociated water injected into the super-hot core of the hydrogen thermolysis reactor, (up to 10,000 deg. F.) as provided herein by the present invention's heat/ignition process, the need for vacuum pressure may not be necessary, but is provided within the present invention as a precautionary step.

The burning fuel plasma is diffused into the core of the hydrogen thermolysis reactor, creating sufficient heat to pre-heat and/or thermally crack additional water within the thermolysis coil, making the apparatus a closed cycle operation. The resultant exhaust of hot gases produced by the burning fuel plasma provides propellant sufficient for mechanical drive and heat sufficient to generate steam.

Further, the present invention provides a method to divert a portion of the preheated and/or thermally cracked water from the thermolysis coil (15) to a hydrogen/oxygen production diffuser nozzle (18) where the fluid is further heated by a resistance (current) heat coil (18A) or maser and/or lasers surrounding the first part of the hydrogen/oxygen production diffuser nozzle (18). The disassociated water is then diffused into the low-pressure, high temperature inner chamber of a cylinder having a hydrogen permeable membrane (19), most likely made of stabilized zirconia, as part of its outer wall with negative-pressure within the hydrogen permeable membrane (19) and lower negative-pressure outside the hydrogen permeable membrane (19) created by a high-negative-pressure hydrogen vacuum pump (21) drawing the hydrogen through the hydrogen permeable membrane (19) and resulting in the separation of the hydrogen and oxygen. Hydrogen diffuses more rapidly than does oxygen, which aids the process of separation. The oxygen and any superheated steam that cannot penetrate the hydrogen permeable membrane are carried away through the center of the membrane (19) by the oxygen vacuum pump (21A). The hydrogen and oxygen produced in this process can be used immediately to power a fuel cell (5) to generate electricity or may be held for future use in separate hydrogen storage canisters (11) and oxygen storage canisters (12). The hydrogen production cylinder is located within the heart (burning core) of the hydrogen thermolysis reactor and the plasma is immediately separated upon injection into the cylinder, therefore, there is limited opportunity for the hydrogen and oxygen to reunite as no cooling or mixing with other gases takes place in the process. However, it is anticipated that the efficiency of the process may be less than complete separation of hydrogen and oxygen due to the many reasons, such as limitations of materials technologies and the reactions of hydrogen and oxygen with the materials used, that prior art patents have found it difficult to accomplish separation without substantial recombination of the hydrogen and oxygen into water vapor. However, the hydrogen and oxygen production cylinder (20) apparatus will definitely provide sufficient hydrogen and oxygen to refill starter fuel tanks even if the overall efficiency is lower than hoped. It hoped however that the efficiency of the production cylinder (20) device is great enough to sustain low-cost commercial production of hydrogen and oxygen, which is most probable considering the production of hydrogen and oxygen as described herein by the present invention as part of a self-sustained energy production process, making any produced hydrogen and oxygen essentially free of cost.

Within the preferred embodiment to the present invention a thermal-dynamicbalance is created. The more cracked water burned, the greater the amount of heat that is produced to crack water at a faster rate and a greater volume of cooling water is cycled through the system to keep the temperature under control; and, a greater quantity of hot exhaust gases, propellant, is produced to create mechanical drive. This is further enhanced by the design of the thermolysis coil (13) in balancing the factors that control the output of pre-heated/dissociated water such as the length of the thermolysis coil, the duration of time in which water remains in the coil being heated and thus receiving thermal energy and the temperature and amount of heat being transferred to the coil. Each of these factors influences the volume of water that is passed through the thermolysis coil and is dissociated into hydrogen and oxygen via passing through the coil.

In the preferred embodiment of the present invention a water-jacket (16) surrounds the hydrogen thermolysis reactor to provide cooling. The water jacket surrounds the hydrogen thermolysis reactor with a double layer and serves numerous purposes: First of which is that the water-jacket serves to cool the outer metal housing (1B) of the hydrogen thermolysis reactor (1) so that the metallurgy is not damaged. Secondly, the circulating water inside the water-jacket (16) absorbs heat from the extreme temperature of reactor's core as it travels over and through the hydrogen thermolysis reactor (1). The heat provides thermal energy to the water, which transforms the water into steam. The resultant steam is added to and mixed with the hot hydrogen and oxygen exhaust gases of the reactor (11) to increase the quantity of propellant expelled from the reactor (1) as energy to perform additional (work) in the form or heat or mechanical drive. Therefore, the more water that flows into the water-jacket (16) and becomes steam, the greater the quantity of propellant generated which produces energy that is provided to the turbine (2) and greater cooling of the outer walls (10B) of the hydrogen thermolysis reactor (1) is obtained. The third improvement of the present invention is that the steam cools the hot exhaust gases so that the heat from the exhaust gases does not harm the metallurgy of the turbine (2). The fourth improvement of the apparatus is that cooling the exhaust gases allows more fuel to be burned in the reactor (1). The fifth improvement of the present invention is that burning more hydrogen and oxygen fuel plasma produces greater heat that can be maintained in the core of the reactor (1) to facilitate thermolysis and to perform work.

The design of the apparatus of the present invention (hydrogen thermolysis reactor, 1) is greatly improved over prior art turbine driving systems such as gas-fired turbine engines in that the reactor (1) can burn larger quantities of fuel allowing the apparatus to maintain a higher internal core temperature to aid thermolysis and it produces far greater force as a result of the ability to burn more fuel. The addition of steam generated from the water-cooling jacket being added to the hot hydrogen and oxygen exhaust gases generates a greater mass of propellant that is denser and cooler. The result is a much more powerful turbine driving system than prior art turbine engines. In addition, prior art turbine engines require the use of a compressor that consumes two-thirds of the force produced by the power turbine. In the present invention's turbine driving system the compressor is eliminated, allowing all of the energy generated by the power turbine to be available for work.

Start-up techniques for the present invention require onboard hydrogen and oxygen supplies as starter fuel. Adequately designed tanks to hold oxygen and hydrogen must be employed to provide oxygen and hydrogen to burn in the hydrogen thermolysis reactor to create the critical heat needed to accomplish dissociation of the water within the thermolysis coil. An electrical ignition arc or laser fired ignition system is required to ignite the starter supply of hydrogen and oxygen within the hydrogen thermolysis reactor. The internal temperature of the hydrogen thermolysis reactor must be optimized to prevent damage to the turbine's metallurgy. This is accomplished by closing a hydraulic (flap) valve (15) located at the throat of the hydrogen thermolysis reactor's discharge and results in reduced output of hot exhaust gases during startup. Once critical operating temperature is obtained by burning the starter fuel, water can begin circulating through the water-jacket and the hydraulic operated flap can open. Caution must be taken not to flood the hydrogen thermolysis reactor due to insufficient heat to transform the water into steam. The unit should run it this manner for a duration such that the thermolysis coil can achieve thermolysis. Once thermolysis is complete, then a hydraulically operated needle-valve or electrically operated solenoid valve that controls the flow of hydrogen and oxygen fuel plasma can begin to supply cracked-water to the hydrogen thermolysis diffuser nozzle and hydrogen thermolysis reactor. The starter supply of fuel is slowly decreased as the amount of the hydrogen and oxygen fuel plasma is increased such that fuel plasma replaces the starter fuel and constant optimal temperature is maintained. The starter fuel tanks can be refilled with hydrogen and oxygen from the apparatus' internal hydrogen and oxygen production unit.

An alternate method of operation of the present invention applies a process of partial thermolysis. In this design the heat and pressure are reduced below that of the heat and pressure needed for complete thermolysis. The embodiment attempts to accomplish the goal of creating sufficient critical mass of hydrogen and oxygen ignition sufficient to cause the hydrogen thermolysis reactor to be self-sustaining (continue burning), but insufficient heat and pressure to fully thermolize all the water in the thermolysis coil. This method of operation of the invention would create a hot exhaust gases combined with steam effluent from the hydrogen thermolysis reactor. In this method of operation, heat and steam propellant are produced in one step by the hydrogen thermolysis reactor itself and the hydrogen thermolysis reactor would operate substantially cooler. This design could be used for the production of steam outright or for a steam engine in a closed cycle. In this embodiment of the present invention, uncracked water becomes steam propellant adding to the total volume of propellant produced by the hydrogen thermolysis reactor. The apparatus would employ lower temperatures at the hydrogen thermolysis reactor's core, less pressurization, and the reactor could be constructed with less expensive construction materials as a result. The use of a water-jacket may not be required and may be eliminated because less heat is generated by this mode of operation and addition propellant (steam) is created by the uncracked water in the thermolysis coil, therefore, steam supplied by the water-jacket may not be needed.

The present invention can be incorporated in many different configurations to meet specific needs, such as speed of propellant, total power produced, amount of heat generated and can be used for many different purposes, such as providing heat for buildings, to heat water for aquaculture and to provide heat to keep agriculture crops such as citrus trees from freezing, without use of a turbine or mechanical drive (free standing hydrogen thermolysis reactor). Additionally, it can be used in association with many different components such as refrigeration cycles, air liquidification cycles, etc. i. e. an aircraft could provide its water fuel by taking water vapor from the air via a refrigeration cycle (condensation of water vapor). The aircraft could supply heat from a hydrogen thermolysis reactor of the present inventions design to the airspace in the wings to become lighter than air. Likewise, a boat could be designed with an overhead airfoil filled with hot air from heat generated by a hydrogen thermolysis reactor of the design of the present invention to become a “lighter than air boat”. Such a vessel when not filled with cargo could lift itself out of the water to dry-dock on land and when filled with cargo would have far less draft in the water due to the lift provided by the hot air. Less draft would result in faster speeds and less energy consumption. By use of the present invention an airplane or boat would not have to carry any fuel and therefore would be much lighter than prior art airplanes and boats. This would aid the take-off of an airplane and allow it to carry much greater cargo and fly much more powerfully and efficiently.

In alternative designs of the present invention using air liquidification components liquid nitrogen could provide coolant and be more efficient than water, especially in certain applications where a closed water cycle is employed and large quantities of water are not readily available. A possible configuration of the present invention would use a water jacket in combination with nitrogen cooling. An additional advantage of using an air liquidification cycle in conjunction with the hydrogen thermolysis reactor and turbine is that valuable air products can be obtained from atmospheric air, such as argon, carbon dioxide, nitrogen, oxygen, etc. This is especially true in relation to manufacturing.

The present invention also provides the basis for a revolutionary submarine design which would employ water jet thrust and have a hull resembling a tube with the water-jet center and the ship space in an annular area surrounding the water jet. Such a submarine could generate speeds approaching that of aircraft due to intake of water at the point of nose compression reducing the resistance to forward motion and the enormous power that could be generated by the water-jet propulsion system. Also, oxygen for use by the crew would be provided by the present invention.

The hydrogen thermolysis reactor's design in the present invention may be used effectively as a “stand alone” process without having a turbine or other form of mechanical drive associated with its use. The continuous thermolysis reaction can produce heat for industrial and manufacturing processes and can provide large quantities of space heat for buildings. Additionally, the heat can be used for agriculture such as providing heat to citrus crops, etc. and can heat water for aquaculture of tropical fish.

Further, the efficiency of work performed according to the Carnot Cycle and Brayton Cycle depends on the difference between the highest operating temperature and the lowest operating temperature. The greater the difference the more efficient the devices that perform work. (McGraw Hill Science and Technology Encyclopedia) Therefore, the present invention with its great difference in operating temperatures is assumed to be extremely efficient.

Although the present invention has been described by reference to only a few embodiments thereof, it is to be understood that many changes and modifications may be readily derived by those skilled in the art, and it is intended by the appended claims that the scope of this invention is intended to cover all changes, modifications, uses and all new embodiments of the present invention that are in the spirit and of the invention.

What is claimed is:

1. The invention of a self-sustaining hydrogen thermolysis reactor (1) that is capable of performing all known forms of work. A hydrogen thermolysis reactor (1) is hereby claimed to dissociate water (H2O) into atomic hydrogen and atomic oxygen, which may be burned as fuel in the hydrogen thermolysis reactor (1) to provide heat for industrial uses, manufacturing, and agriculture/aquaculture purposes, space heating of buildings, lift for lighterthan-air balloons or boats or airplanes/spaceships and can produce heat to generate steam for a piston driven steam engine (3) and provide heat for a heat exchanger and/or, can supply oxygen and hydrogen to be ignited in a combustion engine (4) or to power a hydrogen fuel cell (5) or to charge a hydrogen and oxygen battery (58), use in manufacturing and chemical processes, or for storage; and, oxygen produced may be used for life support in an airplane (79) a spaceship (80) or submarine (52); and, the hydrogen thermolysis reactor (1) can produce propellant to drive turbine engines (2), jet propulsion engines (6), rockets engines (7), or hydro-jet propulsion engines (8) either in the air, over the seas, under water, or in outer space; and, these devices can produce mechanical drive to generate electricity (26), operate hydraulic pumps (10A) and hydraulic engines (10), rotate a crank shaft (42), power a transmission (35), power a compressor (54), rotate a propeller, rotate a wheel (50) or turbine (24), or perform any and all other forms of work as needed.

2. It is claimed that the apparatus of claim 1 can provide sufficient thrust to propel jet airplanes (79) rockets or a spaceship (80), of which the jet propulsion engines (6) or rocket engines (7) will have their own oxygen supply for combustion in outer space from the oxygen contained in the water (14) converted to fuel by the present invention, and can provide the energy needed to power automobiles, trucks, buses, trains, boats, helicopters, submarines, golf carts , jet skis or any and all other types of vehicles or apparatus.

3. A method and apparatus is hereby claimed whereby oxygen and hydrogen are produced from water (14) within the hydrogen thermolysis reactor (1) in claim 1 that has a hydrogen thermolysis diffuser nozzle (15) that produces hydrogen and oxygen that is burned immediately and via the hydrogen and oxygen production nozzle (18) that is capable of producing hydrogen and oxygen to be stored in a separate hydrogen storage tank (11) and in a separate oxygen storage tank (12); and, it is hereby claimed that the hydrogen and oxygen production nozzle (18) and the hydrogen thermolysis diffuser nozzle (15) are capable of performing thermolysis of water into hydrogen and oxygen.

4. It is claimed that the stored hydrogen and oxygen in claim 3 can power a hydrogen fuel cell (5), be fired in a combustion engine (4), be burned in a gas-fired turbine (2), or burned to heat water into steam for a steam engine (3), or may be used in chemical and manufacturing processes or may be sold for profit.

5. A heat/ignition process is hereby claimed to accomplish complete thermolysis and burning of water within the hydrogen thermolysis reactor of claim 1; and,

6. It is claimed that a thermolysis coil (13) is located at the burning core of the hydrogen thermolysis reactor (1) of claim 1. The coil (13) is filled with ambient temperature water from a water source (14) that is forced into the coil (13) under hydraulic pressure by a hydraulic pressure system (10) using multiplication of hydraulic force. As the water travels through the coil (13), it becomes heated (gains thermal energy) from the heat (up to 10,000 deg. F.) of the hydrogen reactor's core (1) and reaches a temperature of approximately 2,500 deg. F. The water remains in a liquid state due to intense pressure, otherwise, it would become gaseous; and,

7. It is claimed that the water is heated by a resistance electrical current (15A) or by (87) masers or in the alternative lasers (85) of the thermolysis diffuser nozzle (15) of claim 3, just before it is ejected from the thermolysis coil (13) and becomes heated to approximately 5,000 deg. F. Most of the water will disassociate into hydrogen and oxygen within the liquid state due to extreme temperature and pressure, according to the Second Rule of Thermodynamics; and,

8. It is claimed that the water of claim 7 is ejected via a hydraulically operated needle valve (15B) or by an electrically operated solenoid valve (10H), located within the thermolysis diffuser nozzle (15) of claim 3, from the high-pressure, high-temperature thermolysis coil (13) into a low-pressure, high temperature area of the thermolysis diffuser nozzle (15) and is transformed into a gaseous fuel plasma containing hydrogen, oxygen and perhaps some superheated steam. A hydraulically operated vacuum turbine (15D) within the thermolysis diffuser nozzle (15) that creates the low pressure zone is hereby claimed. It is claimed that the plasma passes through an electric arc (15C) capable of temperatures up to 90,000 deg. F. or through laser (85) beams capable of temperatures up to a million deg. F. and is further heated (converting any remaining steam into hydrogen and oxygen) and the hydrogen and oxygen is ignited by the electric arc (15C) or by the laser beams (85).

9. It is claimed that additional heat is available to perform work that is generated by the combustion of the hydrogen and oxygen thus ignited in claim 8. It is claimed that the heat/ignition process of the present invention as explained in claims 6 through 8 overcomes the “rapid-back reaction” because the thermally dissociated water is burned immediately, no cooling or mixing with other gases takes place. The hydrogen and oxygen fuel plasma after being ignited by the electric arc or by the lasers (85) is diffused into the superheated core of the hydrogen thermolysis reactor (1) of claim 1 and is fully combusted.

10. It is claimed that the heat/ignition process in claims 6 through 8 create a self-sustained cycle because the hydrogen and oxygen (thermolized water) that is burned in claims 8 and 9 provides the heat/energy to perform work, including the generation of electricity (26) for the resistance electrical current (15A) or masers (87) and electric arc (15C) or lasers (85), and to heat additional water in the thermolysis coil (13).

11. It is claimed that a water-jacket (16) surrounds and cools the hydrogen thermolysis reactor (1); of claim 1 and cools the thermolysis diffuser nozzle (15) consisting of an electrical heat resistance coil (15A) or masers (87) or lasers (85), a hydraulically operated needle valve (15B) or electrically operated solenoid valve (10H) and an electric arc (15C) or lasers (85); and,

12. water within the water-jacket (16) of claim 11 gains thermal energy (heat) from the combustion within the hydrogen thermolysis reactor (1) and turns into steam (41)

13. It is claimed that the steam (41) in claim 12 can drive a piston driven steam engine (3) or may be mixed with hot exhaust gases from the hydrogen thermolysis reactor (1) of claim 1 to provide additional propellant for a gas-fired turbine (2), steam engine (3) or a hybrid gas-fired/steam turbine (17).

14. It is claimed that the steam (41) of claim 12 after being used in claim 13 is cooled and condensed into water (14) that is then recycled back to the hydrogen thermolysis reactor (1) of claim 1 or used as coolant in the water-jacket (16) of claim 11 in a closed cycle.

15. The method and apparatus as used in claim 1 is hereby claimed to produce hydrogen and oxygen for future use:

16. It is claimed that a portion of the water within the high-temperature (2500 deg. F.), high-pressure (in excess of 4000 p.s.i.) thermolysis coil (13) in claim 6 is diverted to be cycled into stored hydrogen and oxygen via the hydrogen/oxygen production nozzle (18) of claim 3 that is wrapped with an electric resistance heat coil (18A) or is heated by masers (87) or lasers (85) and having a hydraulically controlled needle valve (18B) or an electrically operated solenoid valve (10H) that diffuses the disassociated water into a cylinder (20) having low-pressure. The cylinder (20) is located within the core of the hydrogen thermolysis reactor (1) and remains intensely hot. It is claimed that the resistance heat coil (18A) or the masers (87) or the lasers (85) further heat the water in the thermolysis coil (13) to near 5000 deg. F., breaking the water into hydrogen and oxygen just prior to injection into the hydrogen/oxygen production cylinder (20).

17. A hydrogen and oxygen production cylinder (20) in claim 16, having a hydrogen permeable membrane (19) constructed of inert ceramic materials as its inner wall is hereby claimed. It is claimed that there is an annular area (20B) between the outside of the hydrogen permeable membrane (19) and the cylinders' (20) outer-most casing (20B).

18. It is claimed that the annular area of claim 17 has a suction provided by a high-pressure hydrogen vacuum pump (21). It is claimed that the center of the membrane has a suction created by a low-pressure oxygen vacuum pump (21A). And it is claimed that the differential in pressures between the high-pressure hydrogen vacuum pump (21) and the low-pressure oxygen vacuum pump (21A) creates lower pressure outside of the hydrogen permeable membrane (19), which aids the passage of hydrogen from inside the membrane (19) through the membrane (19) to the annular area outside the membrane (19).

19. It is claimed that hydrogen is allowed to pass through the membrane (19) of claim 18 into the annular area (20B) and through the high-pressure vacuum pump (21) and is pressurized into the supply pipes (11A) to a hydrogen storage tank (11) in which compressed hydrogen is stored.

20. It is claimed that oxygen inside the cylinder (20) in claim 17 which cannot pass through the hydrogen permeable membrane (19) is swept through the inside of the cylinder (20) and through the low-pressure oxygen vacuum pump (21A) and passes through pipes (12A) to an oxygen storage container (12) that stores compressed oxygen.

21. A hybrid gas-fired turbine/steam turbine engine (17) of claim 1 that burns hydrogen/oxygen plasma as a fuel being comprised solely of a hydrogen thermolysis reactor (1) in claim 1 and a turbine engine (2) is hereby claimed that operates at near total efficiency by the elimination of the use of a compressor as required by prior art turbine engines

22. It is claimed that water is heated into steam (41) and added to the hot hydrogen and oxygen exhaust gases of the hydrogen thermolysis reactor (1) of claim 1 of the hybrid turbine (17) of claim 21 to cool the exhaust gases to such extent that the heat of the gases does not harm the hybrid turbines metallurgy.

23. It is claimed that the cooling of the hot exhaust gases by mixing cooler steam with the gases in claim 22 allows more fuel to be burned in the hydrogen thermolysis reactor (1) claim 1. It is claimed that the quantity of fuel that can be burned is the most limiting factor in the performance of prior art gas-fired turbine engines. It is claimed that the present invention allows the burning of substantially greater quantities of hydrogen/oxygen fuel plasma in the hydrogen thermolysis reactor (1) than prior art turbine engine combustors are capable of burning.

24. It is claimed that adding steam to the hot gases in claim 22 results in a substantial increase in the amount of propellant created and therefore the amount of energy the apparatus can generate. It is claimed that steam is cooler, more dense and generates more force than is produced by thin hot exhaust gases (36).

25. It is claimed that the hybrid gas-fired/steam turbine engine (17) in claim 21 operates at near complete efficiency because the power turbine does not have to expend two-thirds of its energy running a compressor as in prior art gas-fired turbines engines

26. It is claimed that the product of burning hydrogen/oxygen fuel plasma in the hydrogen thermolysis reactor (1) of claim 1 is water vapor, which cools and condenses into water.

27. It is claimed that in a closed-cycle configuration of the present invention that the water in claim 26 is re-cycled into fuel and steam/propellant again.

28. A thermolysis diffuser nozzle (15) of claim 3 used in the hydrogen thermolysis reactor (1) of claim 1 is hereby claimed that can perform thermolysis of water (14). The thermolysis diffuser nozzle (15) further heats and ignites the water (14) in the thermolysis coil (13); and,

29. It is claimed that the thermolysis diffuser nozzle (15) of claim 3 consists of a resistance heating coil (15A) or masers (87) or lasers (85), a hydraulically operated thermolysis needle valve (15B) or an electrically operated solenoid valve (10H), a hydraulically operated electric arc (15C) or lasers (85), and a hydraulically operated vacuum turbine (15D) or an electrically operated vacuum pump (21).

30. It is claimed that water (14) in the thermolysis coil (13) is pre-heated by the extreme temperature of the hydrogen thermolysis reactor (1) of claim 1 before entering the thermolysis diffuser nozzle (15) in claim 3. When the pre-heated water enters the nozzle (15), a resistance heating coil (15A) surrounding the first part of the nozzle (15) or masers (87) or lasers (85) further heat the water which becomes almost totally disassociated into hydrogen and oxygen just prior to injection from the nozzle (15).

31. It is claimed that a hydraulically operated needle value (15B) or an electrically operated solenoid valve (10H) controls the volume of disassociated water allowed to pass through the nozzle (15) in claim 28; and,

32. it is claimed that the thermally cracked water that is passed through the needle valve (15B) or solenoid valve (10H) in claim 31 transcends from high-pressure to low-pressure and becomes gaseous; and,

33. it is claimed that the hydrogen and oxygen gases of claim 32 pass through an electric arc (15C) or through laser (85) beams located within the nozzle (15) of claim 28. It is claimed that the 90,000 deg. F. temperature of the electric arc (15C) or the million deg. F. temperature of the laser (85) further heats the hydrogen and oxygen gases and ignites the gases.

34. It is claimed that the thermolysis diffuser nozzle (15) of claim 3 utilizes a hydraulically or electrically operated vacuum turbine (15D) of claim 29 located at the end of the diffuser nozzle (15) to create vacuum pressure within the diffuser nozzle (15) to create a zone of extremely low pressure into which the needle valve (15B) or solenoid valve (10H) of claim 31 diffuses dissociated water. It is claimed that low-pressure and high-temperature cause thermolysis of water, and it is claimed that the vacuum turbine aids the thermolysis process of breaking water into hydrogen and oxygen.

35. It is hereby claimed that a stand alone embodiment of the hydrogen thermolysis diffuser nozzle (15) of claim 3 may be constructed using a hydraulic pump (10A), which is a water (14) pump to pressurize water (14D) into the thermolysis diffuser nozzle (15) and the pressurized water (14D) is heated by masers (87) and/or lasers (85) that heat the pressurized water (14D) until it becomes disassociated water (13A). It is claimed that the disassociated water (13A) passes through an electrically operated solenoid valve (10H) and enters a zone of low-pressure created by a hydraulically operated vacuum turbine (15D). It is claimed that within the vacuum zone the disassociated water (13A) transforms into hydrogen and oxygen plasma (38). It is claimed that the hydrogen and oxygen fuel plasma is further heated and is ignited by a series of lasers (85) arranged along a long, narrow opening in the diffuser nozzle (15). It is claimed that the method and process as herein described is thermolysis, the direct breaking down of water into hydrogen and oxygen by direct extreme heat and by low-pressure.

36. It is further claimed that the embodiment of the invention of the diffuser nozzle (15) of claim 3 as described in claim 35 may be miniaturized to the size of a spark plug and may be used to convert a conventional combustion engine into a vehicle burning disassociated water (13A) as a combustion fuel.

37. It is claimed that the gas tank of the conventional vehicle may be filled with water to be burned as fuel in the hydrogen thermolysis diffuser nozzle (15) of claim 35.

38. It is claimed that the hydrogen thermolysis diffuser nozzles (15) of claim 3 using either the resistance heat coil (15A) and electric arc (15C) embodiment or the masers (87) and lasers (85) embodiment of claim 35, as sources of heat and ignition, can accomplish thermolysis, the direct splitting of water into hydrogen and oxygen by extreme heat and low-pressure.

39. It is claimed that the hydrogen thermolysis diffuser nozzle (15) of claim 3 and claim 35 is capable of performing thermolysis; and,

40. it is claimed that the thermolysis diffuser nozzle (15) of claim 35 may be substituted for other heat producing devices, such as for providing heat for a boiler, heat exchanger, gas fired turbine (2) as in a commercial power plant producing electricity (9), or a steam engine (3), etc.

41. It is claimed that the hydrogen thermolysis diffuser nozzles (15) of claim 3 of both embodiments may be used as a stand alone beneficial apparatus without the use of the hydrogen thermolysis reactor (1) of claim 1 that creates a continuous self-sustaining reaction and produces hydrogen and oxygen.

42. It is claimed that the hydrogen thermolysis diffuser nozzle (15) of claim 3 can retrofit any convention heating or combustion unit to operate via burning water (14) as a fuel in a thermolysis diffuser nozzle (15).

43. It is claimed that the hydrogen thermolysis reactor (1) can be used as a beneficial apparatus as a stand alone unit to produce heat for such applications as manufacturing, space heating of buildings, agriculture crop protection from freeze, the heating of water for aquaculture, etc., without the use of a turbine (2) or other mechanical drive device associated with the reactor (1) to perform work other than heating.

44. It is claimed that a hydrogen/oxygen production nozzle (18) of claim 3, along with a hydrogen and oxygen production cylinder (20) and a high-pressure hydrogen vacuum pump (21) and a low-pressure oxygen vacuum pump (21A) can accomplish thermolysis of water into hydrogen and oxygen and can directly power a fuel cell (5) or a hydrogen and oxygen battery (58) with hydrogen and oxygen produced from the water (14).

45. It is claimed that the hydrogen/oxygen production nozzle (18) of claim 3 can be beneficially used along with the hydrogen/oxygen cylinder (20) having a hydrogen permeable membrane (19) as a stand alone unit for the production of hydrogen and oxygen.

46. It is claimed that the hydrogen and oxygen production nozzle (18) of claim 3 may be constructed in a stand alone, all electric, embodiment using an electrically operated high-pressure water pump (10A) to pressurize water into the hydrogen and oxygen production nozzle and masers (87) and/or lasers (85) to heat the water (14) until it becomes disassociated water and with an electrically operated solenoid valve (10H) to diffuse the disassociated water into a zone of low-pressure created by electrically operated vacuum pumps, which create the extreme heat and low-pressure required for thermolysis. It is claimed that the hydrogen and oxygen can be separated by a hydrogen and oxygen production cylinder (18) of claim 3 and as described in claims 16 through 18.

47. A hydrogen and oxygen storage battery (58) constructed of carbon 60 alloyed with platinum to act as a catalyst to break the hydrogen into protons and electrons is hereby claimed.

48. It is claimed that the carbon 60 of claim 47 has a molecular structure forming a sphere which surrounds elements embedded into it by heat and pressure. Further, it is claimed that hydrogen atoms can be stored in carbon 60 and that oxygen atoms can be stored in carbon 60 molecules.

49. It is claimed that the carbon 60 of claim 47 can be alloyed with platinum to create a new material having additional electrochemical properties not available in carbon 60 alone.

50. It is claimed that the platinum of claim 49 acts a as catalyst to break hydrogen into electron and protons (hydrogen ions); and,

51. it is claimed that a hydrogen and oxygen battery (58) of claim 47 capable of storing hydrogen and oxygen and of producing electricity can be constructed of the carbon 60/platinum alloy (104).

52. The invention of a hydrogen and/or oxygen storage battery (58) of claim 47 is hereby claimed and the battery may be constructed of materials other than carbon 60/platinum alloy (104) and such other embodiments and the storage of gases other than hydrogen and oxygen are considered to be within the scope of the present invention of the battery.

53. It is claimed that the hydrogen and oxygen battery (58) of claim 47 is capable of powering a vehicle and/or of producing electrical power for any other purpose such as to operate equipment, supply electricity (9) for a home or business or for the commercial generation of electricity (9).

54. It is claimed that the hydrogen and oxygen battery (58) of claim 47 is an improvement to the prior art of a fuel cell because the hydrogen and oxygen battery (58) stores hydrogen and oxygen for future use; and, it is claimed that a charged hydrogen and oxygen battery (58) is capable of the immediate delivery of electricity (9), without having a supply of hydrogen and oxygen as is needed by a prior art fuel cell. It is claimed that hydrogen and oxygen required to produce electricity (9) is stored in the carbon 60/platinum alloy (104) of the hydrogen and oxygen battery (58).

55. It is claimed that the hydrogen and oxygen battery (58) of claim 47 of the present invention is more lightweight and is more powerful than batteries of the prior art. It is claimed that the hydrogen and oxygen battery (58) can supply more power faster than a fuel cell or a battery of the prior art because there are more hydrogen ions available for the production of electricity in the hydrogen battery than are made available be a fuel cell (5) or by a prior art battery.

56. It is claimed that a hydrogen and oxygen battery (58) of claim 47 in association with a hydrogen and oxygen production nozzle (18) of claim 46 is capable of producing electricity (9) on a continuous basis. It is claimed that the hydrogen and oxygen battery (58) can power the hydrogen and oxygen production nozzle (18) of claim 46; and, it is claimed that the hydrogen and oxygen produced can be separated into by the hydrogen production cylinder (20); and, it is claimed that the hydrogen vacuum pump (21) and the oxygen vacuum pump (21A) can pressurize hydrogen and oxygen into the hydrogen and oxygen battery (58); and, it is claimed that the hot hydrogen gas and hot oxygen gas pressurized into the battery will charge the battery with hydrogen and oxygen. It is claimed that all of the components needed to produce hydrogen and oxygen are operated by electricity (9) obtained from the hydrogen and oxygen battery. It is claimed that the charged hydrogen and oxygen battery (58) can produce electricity (9); and, it is claimed that the hydrogen and oxygen battery (58) can continuously produce electricity (9) with the hydrogen and oxygen production nozzle (18) available to re-charge the hydrogen and oxygen battery (58) with hydrogen and oxygen when it needs additional hydrogen and oxygen.

57. It is hereby claimed that hydrogen and oxygen battery (58) of claim 47 along with the hydrogen and oxygen production nozzle (18) and hydrogen and oxygen production cylinder (20) as described in claim 53 can produce electricity (9) on a continuous basis; and, therefore, it is claimed that the apparatus may be used as an electric generator (26).

58. The invention of an apparatus for the multiplication of hydraulic force as used in the hydrogen thermolysis reactor of claim 1 is hereby claimed.

59. A unique mirrored cylinder and piston arrangement to continuously pump high pressure water for multiplication of hydraulic force of claim 58 is hereby claimed. Two sets of pistons and two sets of cylinders are claimed that consists of two small diameter cylinders and pistons and two large diameter cylinders and pistons. One set of pistons and cylinders form an end-to-end mirror image of the other pair of cylinders and pistons. A rod connects the two small diameter pistons and a rod connects the two large diameter pistons. As one small diameter piston moves back and its cylinder is refilled with water, the other small diameter piston moves forward. One large diameter piston moves back and its cylinder is refilled with water as the other large diameter piston moves forward.

60. A hydraulic pump (10A) used in the hydrogen thermolysis reactor (1) of claim 1 is hereby claimed that pumps hydraulic fluid (water) to the small diameter pistons of claim 59.

61. Electrically operated solenoid valves (10H) are claimed that switch the flow of hydraulic fluid (water) of claim 60 back and forth between the two small diameter cylinders; and, it is hereby claimed that the large diameter cylinders continuously pump high pressure water as the hydraulic fluid is switched back and forth because the small diameter cylinders force the large diameter cylinders forward to pump pressurized water. It is claimed that when one large diameter cylinder stops pumping water, the other large diameter cylinder starts pumping water. The large diameter cylinder that stops pumping water is drawn back by the connecting rod and is refilled with water while the other large diameter piston is pumping, then the process reverses again.

62. A unit to test the principal of thermolysis of water by a heat/ignition process as is claimed in claim 1 is hereby claimed. A pressure vessel constructed of pressure rated material that can withstand a pressure of 10,000 p.s.i. is claimed. The vessel is half filled with water. A blowtorch to heat the water is claimed. Material weaker than the material of the vessel is claimed. The blowtorch heats the water until steam forms above the water and builds pressure until the weaker material ruptures.

63. A hydrogen thermolysis nozzle (15) directed back at the pressure vessel is claimed. The nozzle consists of a heat resistance coil wrapped around it to further heat the steam until it becomes hydrogen and oxygen fuel plasma. An electric arc that further heats and ignites the fuel plasma is hereby claimed.

64. A piston driven hydraulic engine that uses multiplication of hydraulic force as described in claim 58 is hereby claimed. Rods are hereby claimed that connect the large pistons of claim 59 to cams mounted on a crankshaft to generate rotary motion.

65. It is claimed that multiplication of hydraulic force of claim 58 allows the hydraulic engine of the present invention to develop greater force than prior art hydraulic engines.

66. It is claimed that the hydraulic engine described in claim 59 has two crankshafts that may be connected to wheels at each end, creating a four-wheel drive vehicle, of greater power and traction.

67. A hybrid steam engine/hydraulic engine using multiplication of hydraulic force of claim 58 is hereby claimed. It is claimed that small pistons drive larger pistons with multiplication of hydraulic force as described in claim 58. The small pistons are driven by steam and the force exerted on the steam is transferred to the large pistons by hydraulic fluid connecting the two pistons; and, the force of the steam exerted on the small piston is multiplied by the force exerted by the large piston.

68. It is claimed that the steam of claim 67 travels at a faster speed than does hydraulic fluid. The force of the steam is multiplied by the hydraulic multiplication of force of claim 58; therefore, the engine is faster than a hydraulic engine and is more powerful than a steam engine. It is claimed that the hybrid steam/hydraulic engine of the present invention is faster and more powerful than prior art engines.

69. It is claimed that the hydrogen thermolysis reactor (1) in claim 1. can provide hydrogen and oxygen to power a hydrogen fuel cell.

70. Further it is claimed that the hydrogen thermolysis reactor of claim 1. can power a vehicle whose engine consists of a hydrogen thermolysis reactor (1), a hydrogen fuel cell (5), an electric motor and a transmission with accessory components.

71. It is claimed that a hydrogen thermolysis reactor (1) of claim 1 can produce hydrogen and oxygen that is used by the fuel cell to electrochemically produce electricity that runs an electric motor that drives a transmission to propel vehicles, boats or other apparatus.

72. It is claimed that the hydrogen thermolysis reactor of claim 1 can produce hydrogen and oxygen that can be burned in a combustion engine; and, it is claimed that the hydrogen thermolysis diffuser nozzle (15) and the hydrogen and oxygen production nozzle (18) of claim 3 can also produce hydrogen and oxygen that can be burned in a combustion engine.

73. It is claimed that the hydrogen thermolysis reactor of claim 1 can power a vehicle whose engine consists of the hydrogen thermolysis reactor, a conventional combustion engine, and a transmission and the normal accessory components of a vehicle such as an alternator, battery, etc.

74. It is claimed that the product of burning hydrogen and oxygen in the combustion engine of claim 72 is water vapor that condenses into water.

75. It is claimed that the hydrogen thermolysis reactor of claim 1. can power a jet propulsion engine (6). It is claimed that jet propulsion engines powered by hydrogen thermolysis reactors can fly into outer space because the oxygen for combustion within the jet engines is contained in the fuel (water) that is converted into hydrogen and oxygen.

76. An airplane/spaceship powered by jet propulsion engines using hydrogen thermolysis reactors of claim 75 consisting of one large wing is hereby claimed.

77. It is claimed that a hydrogen thermolysis reactor of claim 1. can produce heat that can be placed in the annular space of the wing of the airplane of claim 76 to cause the airplane/spaceship to be lighter-than-air in the earth's atmosphere.

78. It is claimed that the airplane/spaceship of claim 76 is powered by jet propulsion engines (6) operating off of hydrogen and oxygen and that hot air is injected into the wings of the airplane creating lift and that jet propulsion engines thrust downward causing upward lift of the airplane; and, it is claimed that a lighter-than-air airplane is created.

79. It is claimed that the airplane/spaceship in claim 76 can take-off without the use of a runway. It is claimed that the airplane can lift-off the ground vertically and remain level with the aid of a gyroscope leveling device controlling four vertical-lift jet propulsion engines located at the four corners of the wing.

80. A hydraulically operated landing gear of the airplane/spaceship in claim 76 is hereby claimed that has a hydraulic ram within a cylinder capable of lowering a landing gear. It is claimed that the airplane lands vertically and lowers a hydraulically controlled landing gear in order to land.

81. It is claimed that the airplane/spaceship in claim 76 uses water as fuel; and, it is claimed that the water is obtained from water vapor in the atmosphere.

82. It is claimed that the water of claim 81 is created by an air liquidification and refrigeration cycle. It is claimed that the gaseous air in the earth's atmosphere is compressed and is cooled and is transformed into a liquid by a change of state. It is claimed that the super cold liquid is passed through a heat exchange coil and that condensation forms on the coil. It is claimed that air from outside the airplane passes over the coil to cause condensation. It is claimed that the condensation is water, which is collected to operate the airplane's engines.

83. It is claimed that once the airplane/spaceship of claim 76 is in flight that additional lift is created by the motion of air over the wing. It is claimed that the airplane with the aid of the additional lift can support the additional weight of water produced from water vapor in the air. It is claimed that the water is stored in cells in the wing. It is claimed that when the wing contains sufficient water (fuel), the airplane/spaceship can fly into space using the water as fuel, burning the hydrogen and oxygen produced from the water by the hydrogen thermolysis reactor in the jet propulsion engines to create thrust in space without the need for oxygen from the atmosphere.

84. A hydraulically operated adjustable rocket nozzle is claimed to control the exit velocity of the hot gases created by the jet propulsion engines of the airplane/spaceship of claim 76. It is claimed that in space, the greater the exit velocity, the greater the forward thrust.

85. It is claimed that the hydrogen thermolysis reactor of claim 1 can produce oxygen to be used by the crew and passengers of the airplane/spaceship of claim 76 for life support.

86. An air bag that can be installed in space is claimed to capture the propellant of the jet propulsion engines of the airplane/spaceship of claim 76. It is claimed that the propellant of the jet propulsion engine is water vapor that will into water that can be captured by the air bag for recycle as fuel or as oxygen for life support.

87. It is claimed that glass panels are located in the wing of the airplane/spaceship of claim 76 to allow light into the wing and that the light will allow micro-algae or other plant life to grow in the water contained in the wing. It is claimed that oxygen and protein used for life support during long stays in space may be produced by the micro-algae or the other plants growing in water in the wing of the airplane/spaceship.

88. It is claimed that the airplane of claim 76 is also a space ship. The airplane/space ship can fly through the atmosphere into space with oxygen for life support and oxygen to combust hydrogen in the jet propulsion engines being produced by the hydrogen thermolysis reactor from water that is transformed into hydrogen and oxygen.

89. Heat shields made of ceramic tiles located on the underside of the airplane/spaceship of claim 76 are claimed to control the heat of re-entry into the atmosphere.

90. It is claimed that the airplane/spaceship of the present invention of claim 76 can fly into the upper reaches of the atmosphere and into outer space with no damage caused to the ozone layer as in prior art conventional upper atmosphere jet propulsion engines emitting damaging effluents.

91. It is claimed that the jet propulsion engines of claim 78 of the present invention can fly into the upper atmosphere with their own oxygen supply; and, it is claimed that the air is less dense in the upper atmosphere and gravitational pull is reduced, creating the ability for the airplane/spaceship to fly at faster speeds in the upper atmosphere and in outer space.

92. It is claimed that the airplane/spaceship of claim 76 of the present invention can carry greater volumes of passengers and cargo due to the lift provided by the hot-air lift in the air-foil and the downward thrust of the jet propulsion engines inside the air-foil, providing the capability to carry greater loads than prior art airplanes and/or spaceships.

93. It is claimed that the airplane/spaceship of claim 76 of the present invention beneficially combines the lift characteristics of a hot-air balloon, a conventional airplane, and a Harrier jet's downward thrust for vertical lift-off and vertical landing.

94. A hydrogen thermolysis reactor (1) of claim 1 powered boat is hereby claimed that is a lighter-than-air boat consisting of two hulls with a large airfoil overhead and with crosswalks between the two hulls. Jet propulsion engines operating off of hydrogen and oxygen produced by the hydrogen thermolysis reactor are claimed that create thrust to propel the boat and that inject heat into the air foil and create lift by downward thrust.

95. It is claimed that the boat of claim 94 is very stable in water because it is as wide as it is long, creating wave averaging over the hull cross-section in water and because the air-foil moderates wave action because it provides lift from the air moving steadily across it that does not allow the boat of the present invention to pound up and down as a conventional ship does.

96. It is claimed that the boat of claim 94 is partly supported by water by its hulls and partly supported by air with hot-air lift from the airfoil and downward thrust lift from the jet propulsion engines in the airfoil.

97. It is claimed that the boat of claim 94 of the present invention has less draft than prior art boats because the boat is provided with several mechanisms for lift. Therefore, it is claimed that the boat of the present invention can carry passengers and cargo over waters too shallow for prior art boats; and, it is claimed that the boat of the present invention can carry greater volumes of passengers and cargo.

98. Three forms of lift are claimed in the boat of claim 94: hot-air lift inside the airfoil, downward thrust of the jet propulsion engines creating upward lift, and motion of air over the air-foil creating lift. It is claimed that the boat is constructed of strong, lightweight materials such as aluminum and titanium alloy. It is claimed that the boat can be lifted out of the water by hot air in the airfoil so long as there is no load of cargo or passengers aboard. It is claimed that the boat can lift itself from the water for purposes of repair and docking and to prevent bio fouling of the hulls, so long as loads of cargo and passengers are not present.

99. It is claimed that the boat of claim 94 loaded with cargo and passengers can travel on the surface of the water on skis mounted on the underside of the boat. It is claimed that as the boat moves forward and gains sufficient speed that additional lift will be generated by the motion of air over the airfoil and that the boat will raise to the surface of the water on skis mounted underneath it.

100. It is claimed that the hydrogen thermolysis reactors of claim I of the boat of claim 94 operate hydro-jet attachments below the water line of the boat to create hydro-jet propulsion underneath the boat to thrust the boat forward.

101. It is claimed that jet propulsion engines operate in the air to create forward thrust and that hydro-jet propulsion turbines operate under the water to thrust the boat of claim 94 forward and that jet propulsion engines located within the wing inject heat into the airfoil in order to create hot-air lift for the boat, as the jet propulsion engines thrust downward causing upward lift.

102. It is claimed that the hydro-jet propulsion turbines rise out of the water when the boat of claim 94 lifts up on the skis and that having the turbines out of the water creates less drag for high-speed travel.

103. A hydraulically operated airfoil pitch adjustment is claimed to control the pitch of the airfoil to maximize lift when needed and to prevent the boat of claim 94 from going air-borne at high speeds.

104. It is claimed that the boat of claim 94 can achieve speeds on water approaching that of jet aircraft in the air.

105. A hydraulically operated water pick-up tube is claimed to retrieve water from the ocean for use by the boat of claim 94. It is claimed that the water pick-up tube can be lowered below the water line to obtain seawater when seawater is needed.

106. An air liquidification and refrigeration process to remove water vapor from the air for use on the boat in claim 94 is claimed. It is claimed that the boat in claim 94 uses water as fuel and that a portion of the water is obtained from moisture in the atmosphere.

107. An air liquidification and refrigeration cycle is claimed to produce water for use on the boat in claim 94. It is claimed that the gaseous air is compressed and is cooled and is transformed into a liquid by a change of state. It is claimed that the liquid is passed through a heat exchange coil and that condensation forms on the coil. It is claimed that air from outside the boat passes over the coil to cause condensation. It is claimed that the condensation forms fresh potable water, which is collected to operate the boat's engines and for other uses.

108. A jet propulsion engine of claim 78 powered by a hydrogen thermolysis reactor is hereby claimed consisting of a compressor turbine, a hydrogen thermolysis reactor, and a power turbine. It is claimed that air is compressed into the hydrogen thermolysis reactor by the compressor turbine, and the air is combusted along with hydrogen and oxygen produced by the reactor. It is claimed that the hot exhaust gases are expanded in the power turbine to create mechanical drive. It is claimed that the rearward thrust of the jet propulsion engine can create forward thrust that can propel an airplane, spaceship, boat, personal transport vehicle, rocket, or submarine, etc.

109. It is claimed that air from the compressor turbine of claim 108 is allowed to go around the outside of the hydrogen thermolysis reactor and the power turbine for cooling purposes.

110. It is claimed that the jet propulsion engine of claims 78 and 108 works in conjunction with an air liquidification and refrigeration cycle that produces water and super-cold liquid atmosphere products, such as liquid nitrogen, liquid oxygen, and liquid rare gases found in the atmosphere

111. It is claimed that the liquid nitrogen of claim 110 and other super-cold liquids from the atmosphere are injected into the inlet of the power turbine to create further cooling of the turbine and to increase the volume of propellant discharged. It is claimed that by making the power turbine operate cooler that more hydrogen and oxygen fuel may be burned in the reactor; and, more fuel increases the volume of propellant available to the power turbine, making the jet propulsion engine more powerful than prior art jet propulsion engines.

112. It is claimed that the jet propulsion engine of claims 78 and 108 of the present invention can operate, provide thrust, under water and can operate, provide thrust, beyond the earth's atmosphere because combustion can occur with hydrogen and oxygen obtained from water, which is the fuel of the jet propulsion engine of the present invention.

113. It is claimed that the jet propulsion engine of claims 78 and 108 can power a boat, submarine, jet airplane, personal transport vehicle, rocket, or spaceship and can operate in air, on water, under water, or in space because it has its own supply of oxygen contained in its fuel, water.

114. A hydro-jet propulsion turbine is hereby claimed that is driven be the power turbine of a hydrogen thermolysis reactor of claim 1. It is claimed that the hydro-jet propulsion turbine is a hydro-compressor turbine that compresses water that exits the hydro-compressor turbine as a focused water-jet stream capable of creating substantial thrust.

115. A hydraulically operated hydro-jet nozzle is claimed to control the velocity of the water jet stream exiting the hydro-jet turbine of claim 114 and to provide steering. It is claimed that the backward jet action of the water causes forward thrust on the boat to propel it forward.

116. A submarine powered by hydrogen thermolysis diffuser nozzles of claim 3 is hereby claimed that heats water that is withdrawn from the sea at the nose of a submarine to reduce nose compression until the water becomes steam. It is claimed that the steam is expanded through a power turbine and creates rotary motion of the power turbine. It is claimed that the exiting steam creates backward thrust that causes forward motion of the submarine.

117. It is claimed that the submarine of claim 116 of the present invention has less nose resistance than prior art submarines because a large volume of water to create steam to drive the power turbine is withdrawn at the nose of the submarine reducing nose compression of water and resulting in reduced resistance of forward motion of the submarine.

118. A compressor turbine located at the nose of the submarine of claim 116 is hereby claimed that compresses water, withdrawn at the nose of the submarine to reduce resistance to forward motion by the submarine, into steam tubes running longitudinally through the submarine. It is claimed that the water in the steam tubes receives heat from the combustion of hydrogen and oxygen by the hydrogen thermolysis diffuser nozzles and that the water changes state from liquid to gaseous and becomes steam.

119. It is claimed that the steam of claim 118 drives a power turbine and provides rearward thrust to the submarine of claim 16. It is claimed that the steam exists the steam tubes and at the inlet to the power turbine and expands across the power turbine exerting force against the vanes of the power turbine creating rotary motion; and, it is claimed that the rotary motion is transferred to a central shaft connected to the power turbine.

120. A central shaft and a clutch/gear box are hereby claimed that transfer mechanical drive from the power turbine to the compressor turbine along the central shaft of claim 119. It is claimed that the clutch/gear box allows the compressor turbine to be disconnected during start-up of the power turbine and allows mechanical drive to be obtained from the power turbine for use aboard the submarine to operate electrical generators, etc.

121. An alternate design of a submarine powered by hydrogen thermolysis reactors of claim 1 with attached hydro-jet propulsion turbines of claim 114 is hereby claimed.

122. It is claimed that water is withdrawn from the ocean at the nose of the submarine of claim 121 to reduce nose compression of the water and to reduce resistance to forward motion of the submarine; and, it is claimed that the water is allowed to travel longitudinally the entire length of the submarine and passes through a hydro-jet compressor turbine that compresses the water into a water-jet stream that exits the hydro-jet propulsion turbine through a hydro-jet nozzle.

123. It is claimed that the submarine of claim 121 is powered by two hydrogen thermolysis reactors of claim 1 that drive the hydro-jet propulsion turbine with the use of gears. A drive gear is claimed that transfers rotary motion from the power turbine of the thermolysis reactor to a jet-propulsion gear that turns the hydro-jet propulsion turbine. A clutch gear is claimed that is located between the drive gear and jet-propulsion gear that engages or disengages the drive gear and jet propulsion gear. It is claimed that the two hydrogen thermolysis reactors are located on each side of the jet propulsion turbine and that the reactors apply force to each side of the jet propulsion gear to drive the jet propulsion turbine.

124. A hydraulically controlled hydro-jet nozzle is hereby claimed that controls the exit velocity of the water-jet stream that exits the hydro-jet propulsion turbine of claim 123. It is claimed that the hydraulically operated hydro-jet nozzle is capable of maneuvering from side-to-side and aids in steering the submarine.

125. It is claimed that the submarine of claim 121 is propelled forward by the thrust of the hydro-jet propulsion turbine with the hydro-jet nozzle directing the backwards thrust of the water-jet; and, the thrust of the two hydrogen thermolysis reactors that thrusts propellant backwards through jet propulsion nozzles.

126. A check valve is hereby claimed that prevents water from entering the hydrogen thermolysis reactor of claim 1 in the undersea environment of the submarine of claim 121. It is claimed that the check valve allows flow in only one direction to allow hot exhaust gases to exit from the reactor. It is claimed that the check valve prevents water from entering the reactor.

127. A hydraulically operated jet propulsion nozzle is claimed to control the exit velocity of the exhaust hot gases of the hydrogen thermolysis reactor of claim 1 and to steer the submarine of claim 121.

128. It is claimed that a hydrogen and oxygen production nozzle (18) of claim 3 using a hydrogen and oxygen production cylinder to separate the hydrogen and oxygen produced by the hydrogen and oxygen production nozzle can power a fuel cell and can provide hydrogen and oxygen to charge a hydrogen battery or a hydrogen and oxygen battery

129. It is claimed that the fuel cell and the hydrogen and oxygen battery (58) of claim 47 can produce electricity that can operate an electric motor or any other electric apparatus.

130. It is claimed that thermolysis of water is accomplished by high-temperature and low-pressure; and, it is claimed that the hydrogen and oxygen production nozzle (18) of claim 3 can accomplish thermolysis of water to disassociate water into hydrogen and oxygen. It is claimed that masers and/or lasers heat the water until it is disassociated into hydrogen and oxygen.

131. A high-pressure water pump is hereby claimed to pressurize the water into the hydrogen and oxygen production nozzle (18) of claim 3.

132. A hydrogen and oxygen production cylinder is hereby claimed to separate hydrogen and oxygen produced by the hydrogen and oxygen production nozzle (18) of claim 3.

133. It is claimed that an electrically operated solenoid valve diffuses disassociated water being hydrogen and oxygen into a hydrogen and oxygen production cylinder of claim 132.

134. It is claimed that an oxygen molecule of claim 133 is many times larger than a hydrogen molecule and that a hydrogen molecule can pass through an opening (membrane) that an oxygen molecule cannot pass through. Further, it is claimed that the lighter hydrogen molecule diffuses at a faster rate than the heavier, slower oxygen molecule.

135. A hydrogen permeable membrane that is located inside the hydrogen and oxygen production cylinder of claim 132 is hereby claimed that allows hydrogen to be separated from oxygen. It is claimed that an annular area is created outside of the membrane between the membrane and the outer-most casing of the hydrogen and oxygen production cylinder of claim 133.

136. A hydrogen vacuum pump is hereby claimed to create a vacuum in the annular area outside the membrane of claim 135 that aids by sucking/drawing through the hydrogen permeable membrane to the outside of the membrane and to compress the hydrogen into the fuel cell or the hydrogen battery. It is claimed that the hydrogen vacuum pump operates at high pressure and creates a substantial vacuum to aid the hydrogen in passing through the hydrogen permeable membrane and that the hydrogen vacuum pump compresses hydrogen into a fuel cell or hydrogen battery with high-pressure.

137. An oxygen vacuum pump is hereby claimed that creates a vacuum in the center of the hydrogen permeable membrane of claim 136 that helps thermolysis take place by lowering the pressure within the membrane. Oxygen, which cannot pass through the hydrogen permeable membrane, is compressed into a fuel cell to operate the fuel cell or is compressed into a hydrogen and oxygen battery to charge the battery with oxygen.

138. It is claimed that the oxygen vacuum pump of claim 137 operates at lower vacuum pressure than the vacuum pressure of the hydrogen vacuum pump of claim 136. The differential pressure, with lower pressure being outside of the hydrogen permeable membrane of claim 136 than inside the membrane, aids in the passage of hydrogen through the membrane.

139. It is claimed that the hydrogen production cylinder of claim 133 and the hydrogen and oxygen production nozzle of claims 3 and 128 are located within a highly insulated container to maintain the heat that is produced by the masers and/or lasers, which is necessary for thermolysis to take place.

140. A personal transport vehicle (PTV) designed to carry from one to eight passengers using hydrogen thermolysis reactors of claim 1 that power jet propulsion engines of claim 108 is hereby claimed. It is claimed that the personal transport vehicle has lift provided by hot air contained in an annular area at its roof and lift is also created by downward thrusters located in the four corners of the PTV. It is claimed that the personal transport vehicle is capable of vertical lift-off via the lift provided by the hot air and the downward thrusters creating upward lift. It is claimed that the PTV has forward and rearward thrusters located at each end of the vehicle, which are jet propulsion engines, to propel it forward and rearward and to create a braking action to stop momentum in a given direction. It is claimed that the jet propulsion engines of the PTV operate off of water as a fuel via hydrogen thermolysis reactors of claim 1; and, it is claimed that a water reservior stores water below the floor of the passenger compartment. A swivel motor is claimed to allow the jet propulsion engines to swivel from side-to-side to steer the PTV. A computer controlled gyroscope device is hereby claimed to keep the PTV level during lift-off and during flight above the ground by controlling the downward thrust of the four thrusters located on the four corners of the vehicle.

141. It is claimed that the personal transport vehicle of claim 140 uses hydraulically lowered wheels for traveling on conventional roadways and the wheels have convention brakes used during land operation. It is claimed that the PTV is equipped with a landing gear for landing in open fields or other sites, including roadways. It is claimed that the landing gear has shock absorbers to cushion landing on the landing gear and to prevent damage to the PTV.

142. It is claimed that the PTV of claim 140 uses an air liquidification and refrigeration cycle in order to provide water to operate the hydrogen thermolysis reactors of the jet propulsion engines and to cool the jet propulsion engines and to provide cooling for the passenger compartment of the PTV. It is claimed that heating is provided by the hot exhaust gases of the jet propulsion engines used in a heat exchanger in the passenger compartment.

143. It is claimed that the personal transport vehicle of claim 140 is capable of traveling above the ground in the lower atmosphere and that the building of roadways is not necessary for its use, which lessens the environmental impact of habitat destruction for roadways, the death of millions of animals killed on roadways, and eliminates the need for costly road construction and road maintenance.
